(19) United States
(12) Patent Application Publication
(10) Pub. No.: US 2025/0021901 A1
(43) Pub. Date: Jan. 16, 2025

(54) Supply Chain Management System and Method

(71) Applicant: Overall Parts Solutions, LLC, Grand Prairie, TX (US)

(72) Inventor: Nick (nmn) Bossinakis, Keller, TX (US)

(21) Appl. No.: 18/668,467

(22) Filed: May 20, 2024

Related U.S. Application Data
(63) Continuation of application No. 13/678,819, filed on Nov. 16, 2012, now abandoned.
(60) Provisional application No. 61/671,209, filed on Jul. 13, 2012.

(51) Int. Cl. G06Q 10/0631; G06Q 30/0601

(52) U.S. Cl. CPC G06Q 10/06315; G06Q 30/0635

(57) ABSTRACT

A supply chain management system/method that incorporates a Customer Order Entry/Status Console (COESC), part/product quoting, vendor order fulfillment, manufacturer claims processing, transportation tracking, and integrated product advertising is disclosed. The disclosed system/method uses a COESC that permits decentralized deployment of customer orders to a plethora of potential vendors for potential fulfillment. Participating vendors may provide feedback pertaining to product pricing, availability, manufacturer incentives, and delivery timing to the COESC. Vendor product shipments to the customer may be tracked on the COESC utilizing a transportation tracking subsystem incorporating vendor delivery optimizations and mobile tracking of parts/products deliveries. A context-sensitive advertising subsystem integrating manufacturer claims processing may be implemented to permit promotion of vendor/manufacturer products and/or services to customers via the COESC. The system/method may incorporate/interface to customer scheduling/process flow software such as body shop management systems and the like.

### CROSS REFERENCE TO RELATED APPLICATIONS

This application claims benefit under 35 U.S.C. § 119 and incorporates by reference U.S. patent application Ser. No. 13/678,819, filed on Nov. 16, 2012, which claims priority to United States Provisional Patent Application for LOGISTICS MANAGEMENT SYSTEM AND METHOD by inventor Nick Bossinakis, filed electronically with the USPTO on Jul. 13, 2012, with Ser. No. 61/671,209, EFS ID 13245832, confirmation number 4567.

### PARTIAL WAIVER OF COPYRIGHT

All of the material in this patent application is subject to copyright protection under the copyright laws of the United States and of other countries. As of the first effective filing date of the present application, this material is protected as unpublished material.

However, permission to copy this material is hereby granted to the extent that the copyright owner has no objection to the facsimile reproduction by anyone of the patent documentation or patent disclosure, as it appears in the United States Patent and Trademark Office patent file or records, but otherwise reserves all copyright rights whatsoever.

### STATEMENT REGARDING FEDERALLY SPONSORED RESEARCH OR DEVELOPMENT

Not Applicable

### REFERENCE TO A MICROFICHE APPENDIX

Not Applicable

### FIELD OF THE INVENTION

The present invention generally relates to supply chain management systems and methods. While not limitive of the invention teachings, the present invention may in some circumstances be advantageously applied to situations where automotive/truck repair establishments and the like transact with a wide variety of parts/products vendors/manufacturers to procure replacement parts for automotive/truck repairs.

### PRIOR ART AND BACKGROUND OF THE INVENTION

### Overview (0100)

The prior art may be best understood by application to a scenario where auto/truck parts are to be acquired by a customer from one or more auto parts vendors as in the context of the automotive/truck repair/maintenance industry. An example of this prior art system can be seen by inspecting the system data flow diagram generally illustrated in FIG. 1 (0100). Within this context, the prior art teaches that the auto/truck customer (0101) identifies parts/products (0102) that are needed for a given repair task and individually places an order for the part/product by using telephone, fax, or conventional mail/e-mail (0103) to a variety of vendors (0111, 0191) who may include such entities as automobile dealerships, original equipment manufacturers (OEMs), aftermarket parts suppliers, salvage yards, and the like. These vendors (0111, 0191) individually inspect their inventory (0112, 0192) to determine if the requested parts are available and then generate a pick list and/or invoice (0113, 0193) for identification and loading of the parts on trucks (0114, 0194) for delivery and billing to the customer (0101). Once parts are delivered to the customer (0101), manual order receiving processes (0115, 0195) are typically utilized by the vendors (0111, 0191) to ensure the parts are delivered to the customer (0101). The customer (0101) must also ensure that the part/product has arrived and is properly dispatched to the appropriate repair task(s).

This current state of the art relies heavily on telephone/fax communication (0103) between the customer (0101) and the vendors (0111, 0191) to locate parts, order parts, request delivery status updates for parts, and to verify that parts have in fact been shipped. Furthermore, once parts are delivered (0114, 0194), internal receiving processes (0115, 0195) within both the vendors (0111, 0191) and customer (0101) require that substantial manual verification of parts delivery/reception must take place for proper movement of the part to its ultimate destination within a given auto/truck repair task. It should be noted that since the ordering customer (0101) in this instance often represents a large number of repair technicians in an auto/truck repair facility, coordinating the communication (0103) through traditional telephone/fax networks is highly inefficient and often results in significant parts delivery delays and customer/vendor confusion that result in damage to customer/insurance, and lost profits for the customer auto/truck repair facility.

Furthermore, the system as depicted provides no parts transportation (0114, 0194) optimization to guarantee quality-of-service delivery between the vendors (0111, 0191) and the customer (0101). Within this context, the customer (0101) may be able to query the vendors (0111, 0191) as to when the delivery transportation truck (0114, 0194) left the vendor's (0111, 0191) facility, but has little information on exactly WHEN the delivery transportation truck (0114, 0194) will arrive at the customer's (0101) facility. Finally, the existing manual nature of the order receiving process (0115, 0195) results in significant delays and clerical errors in the receiving process, resulting in lost shop time and revenue.

This system also suffers from inefficiencies in the matching of identified products (0102) with the resulting product inventories (0112, 0192) of the potential vendors (0111, 0191). Since the customer (0101) must actively solicit vendors (0111, 0191) for availability/pricing for a given part, there is an inherent delay in the response to this inquiry that introduces an overall delay in the eventual delivery of the ordered part.

### Manufacturer Claims Processing (0200)

An additional complexity often present in the prior art involves processing of manufacturer/OEM (and similarly structured) claims processing. Often a manufacturer or other party may authorize an incentive or promotion for the sale of a particular part/product. Associated with this incentive/promotion are generally a specific list of rules/criterion under which the incentive/promotion is to be operated and specific criterion for which payment of a rebate or reduction of a sale price is to occur. These criterion often involve submission of specific documentation in support of a claim for reimbursement or credit for the incentive/promotion.

This incentive/promotion structure often appears in the context of an overall parts/products procurement cycle for a given shop or other customer. As generally illustrated in FIG. 2 (0200), this scenario is typically encountered when a customer (0210) needs to generate a parts/products order (0220) that is generally distributed to a number of vendors (0231, 0232, 0233, 0234, 0239) in order to price match parts/products and obtain the optimal combination of price and delivery. Within this context a dealer (or dealership) (0239) may have an association with a manufacturer (or other entity) (0240) within the overall parts/products supply chain.

This manufacturer (0240) may engage the vendor (0239) in a series of transactions (0249) that may promote incentives/promotions for the sale of parts/products that require the vendor (0239) to submit a claim for reimbursement after which a payment or credit is provided to the vendor (0239). This process may incorporate integration of a computing device (0241) and associated software (0242) to document the incentive/promotion and claims payment. However, the process generally requires that the claim be reviewed/authorized/audited via a manual process (0243) that is often time consuming and prone to error. Often both the dealership vendor (0239) and the manufacturer (0240) have limited access to information regarding the status of claims and historical data regarding the effectiveness of individual incentives/promotions. In some cases, audits are performed infrequently, or not at all, due to an inefficient audit process or lack thereof.

### Deficiencies in the Prior Art

The prior art as detailed above suffers from the following deficiencies:
The part/product ordering cycle between customers and vendors currently incorporates a communication barrier that must be bridged by a number of human interventions that make the overall part/product delivery mechanism inefficient and costly.
The systems and methods of the prior art generally rely on human-to-human communication between customers and vendors, resulting in an inefficient interface between these two entities.
Customers often find it difficult or impossible to obtain real-time status information on a part/product order.
Vendors typically do not have the infrastructure necessary to support tracking of individual part/products for any particular customer.
Customer part/product orders are often delayed as customers weigh various part/product delivery/pricing options from a number of vendors, especially when these decisions are delayed because of communication callback delays with the vendors.
Customers often do not know when a part/product is ordered whether the part/product is available from a given vendor and which vendor(s) may be the most suitable source for the given part/product.
Vendor transportation infrastructures are typically not optimized with respect to customer delivery priorities and lack intelligent route management capabilities.
The manual procedures associated with part/product ordering, vendor order fulfillment, and transportation prohibit information associated with these functions to be integrated within conventional shop management software that may operate an optimal process flow within a given customer establishment.
Vendors currently have no method of promoting their products in a context-sensitive manner to customers, as in the current vendor business model the vendors only verbally (or via fax) acknowledge orders from a customer and cannot engage in active marketing to their customer base.
The processing of manufacturer claims and associated transactions involving incentives/promotions for parts/products is generally not integrated into the customer parts/products purchasing supply chain and generally results in significant overhead for vendors to take advantage of manufacturer incentives/promotions to increase parts/products sales.

While some of the prior art may teach some solutions to several of these problems, the core issues of integrating part/product ordering, vendor order fulfillment, transportation tracking, and integrated vendor advertising has not been addressed by the prior art.

### OBJECTIVES OF THE INVENTION

Accordingly, the objectives of the present invention are (among others) to circumvent the deficiencies in the prior art and affect the following objectives:
(1) Provide for a supply chain management system and method that integrates customer order entry/status, vendor order fulfillment, manufacturer claims processing, and transportation tracking functions.
(2) Provide for a supply chain management system and method that permits vendor advertising to be integrated within a customer ordering system to streamline the part/product ordering cycle.
(3) Provide for a supply chain management system and method that permits customers to view on a single status console the real-time order/delivery status of all part/products associated with a given customer shop task.
(4) Provide for a supply chain management system and method that permits vendors to target specific customer part/product requirements with advertising integrated within the customer part/product ordering infrastructure.
(5) Provide for a supply chain management system and method that permits integration of part/product status information into existing shop management software systems.
(6) Provide for a supply chain management system and method that permits an integrated shop management software system to be constructed that incorporates part/product order entry, vendor order fulfillment, manufacturer claims processing, transportation management, and context-sensitive vendor advertising.
(7) Provide for a supply chain management system and method that permits vendors to streamline the processing of manufacturer incentive/promotion claims based on information obtained from customer parts/products orders.

While these objectives should not be understood to limit the teachings of the present invention, in general these objectives are achieved in part or in whole by the disclosed invention that is discussed in the following sections. One skilled in the art will no doubt be able to select aspects of the present invention as disclosed to affect any combination of the objectives described above.

### BRIEF SUMMARY OF THE INVENTION

A supply chain management system and method that incorporates customer order entry, vendor order fulfillment, vendor shipment tracking, transportation tracking, customer receipt tracking, and integrated product advertising is disclosed. The disclosed system/method provides a central customer order status console that permits decentralized deployment of customer orders to a plethora of potential vendors for potential fulfillment. Participating vendors can then quote product availability, pricing, and delivery to the customer order status console.

Vendor product shipments to the customer can then be tracked on the customer order status console utilizing an integrated transportation tracking subsystem that may include vendor delivery optimizations. Within this supply chain management system/method a context-sensitive advertising subsystem may be implemented to permit promotion of vendor products and/or services to customers via the customer order status console.

The disclosed system/method may provide interfaces to or incorporate customer scheduling/process flow software such as body shop management systems and the like. In this capacity the present invention eliminates a number of human-to-human communication flows that result in inefficient use of shop resources and overall delays in the execution of repair functions within a typical auto/truck repair facility or the like.

### BRIEF DESCRIPTION OF THE DRAWINGS

For a fuller understanding of the advantages provided by the invention, reference should be made to the following detailed description together with the accompanying drawings wherein:

FIG. 1 illustrates an exemplary system block diagram of the prior art as it applies generally to customer part/product ordering and vendor order fulfillment in an auto/truck repair shop environment;

FIG. 2 illustrates an exemplary system block diagram of the prior art as it applies generally to vendor processing of manufacturer claims associated with manufacturer parts/products incentives/promotions;

FIG. 3 illustrates an exemplary architectural schematic diagram of a preferred embodiment of the present invention illustrating exemplary invention subsystems;

FIG. 4 illustrates an exemplary system block diagram of a preferred embodiment of the present invention as applied to a distributed supply chain management architecture;

FIG. 5 illustrates an exemplary method flowchart of a preferred embodiment of the present invention;

FIG. 6 illustrates an exemplary alternative method flowchart of a preferred embodiment of the present invention;

FIG. 7 illustrates an exemplary system block diagram of a preferred embodiment of the present invention as applied to a distributed supply chain management architecture that incorporates a cross-platform body shop management API;

FIG. 8 illustrates an exemplary system block diagram of a preferred embodiment of the present invention as applied to a distributed supply chain management architecture that incorporates an integrated body shop management software application;

FIG. 9 illustrates an exemplary system block diagram detail of a preferred embodiment of the present invention depicting customer forwarding of part/product requests;

FIG. 10 illustrates an exemplary system block diagram detail of a preferred embodiment of the present invention depicting vendor forwarding of part/product requests;

FIG. 11 illustrates an exemplary system block diagram detail of a preferred embodiment of the present invention depicting nested vendor forwarding of part/product requests;

FIG. 12 illustrates an exemplary system block diagram detail of a preferred embodiment of the present invention depicting the use of vendor groups;

FIG. 13 illustrates an exemplary status screen layout associated with some preferred embodiments of the present invention;

FIG. 14 illustrates a exemplary part/product order entry screen;

FIG. 15 illustrates an exemplary method flowchart detail of a preferred embodiment of the present invention implementing embedded vendor part/product advertising;

FIG. 16 illustrates a system block diagram of a preferred exemplary embodiment of the present invention depicting integration of a manufacturer claims processing subsystem;

FIG. 17 illustrates a system block diagram of a preferred exemplary embodiment of the present invention depicting various invention subsystems;

FIG. 18-FIG. 40 illustrate system block diagrams and exemplary dialog interface screen shots of a preferred exemplary embodiment of the present invention implementation of a quote management subsystem;

FIG. 41-FIG. 54 illustrate system block diagrams and exemplary dialog interface screen shots of a preferred exemplary embodiment of the present invention implementation of an advertising and claims processing subsystem;

FIG. 55-FIG. 84 illustrate system block diagrams and exemplary dialog interface screen shots of a preferred exemplary embodiment of the present invention implementation of a delivery management subsystem;

FIG. 85-FIG. 112 illustrate system block diagrams and exemplary dialog interface screen shots of a preferred exemplary embodiment of the present invention implementation of a delivery tracking subsystem.

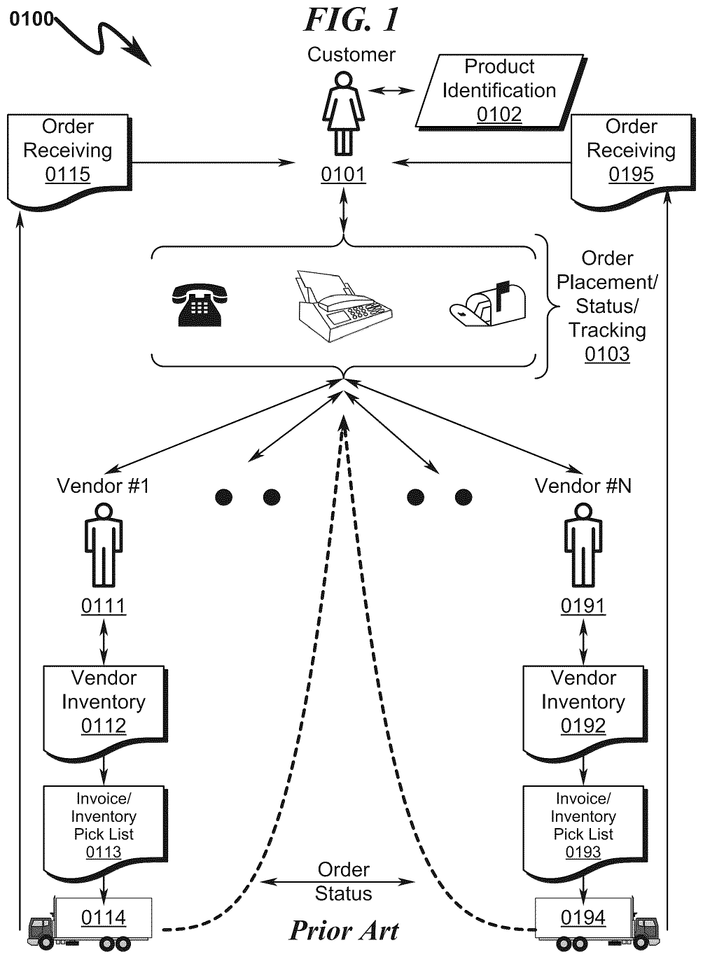

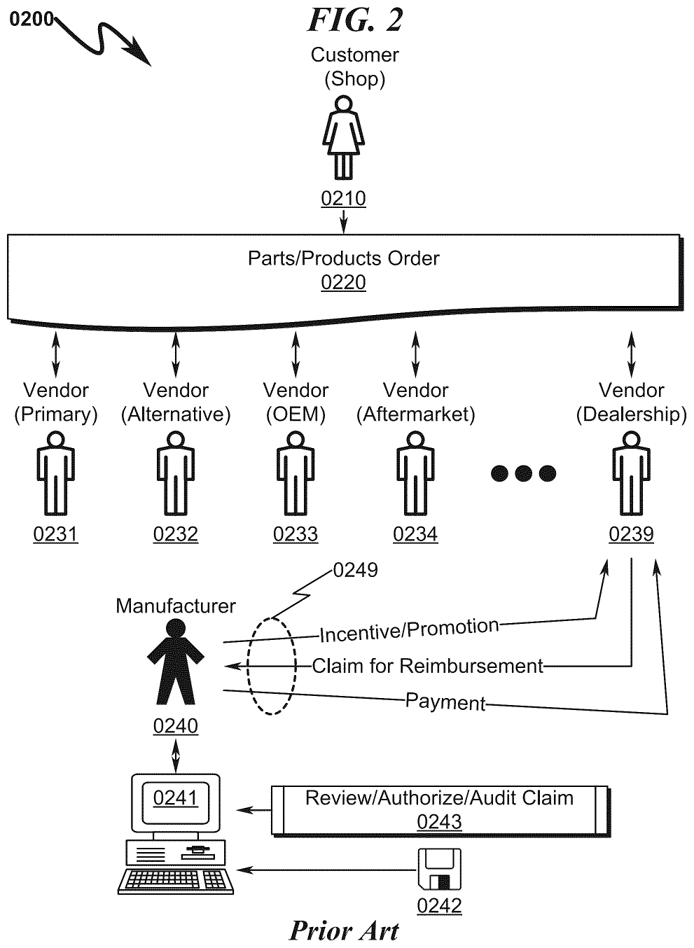

### DESCRIPTION OF THE PRESENTLY PREFERRED EXEMPLARY EMBODIMENTS

While this invention is susceptible of embodiment in many different forms, there is shown in the drawings and will herein be described in detailed preferred embodiment of the invention with the understanding that the present disclosure is to be considered as an exemplification of the principles of the invention and is not intended to limit the broad aspect of the invention to the embodiment illustrated.

The numerous teachings innovative of the present application will be described with particular reference to the presently preferred embodiment, wherein these innovative teachings are advantageously applied to the particular problems of a SUPPLY CHAIN MANAGEMENT SYSTEM AND METHOD. However, it should be understood that this embodiment is only one example of the many advantageous uses of the innovative teachings herein. In general, statements made in the specification of the present application do not necessarily limit any of the various claimed inventions. Moreover, some statements may apply to some inventive features but not to others.

### Auto/Truck Repair Environment Not Limitive

The present invention anticipates a wide variety of application environments in which the disclosed system/method may operate. In many preferred embodiments the system/method is applied within the context of an auto/truck repair shop environment. However, the present invention is not necessarily limited to this application environment.

### Invention Architecture Overview (0300)

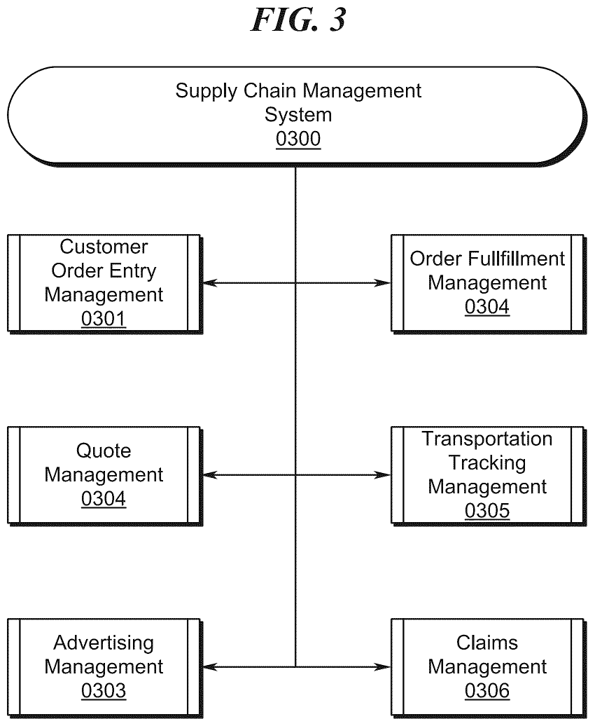

A typical architecture associated with the many preferred embodiments of the present invention is generally illustrated in FIG. 3 (0300). This architecture comprises the following elements:
Customer order entry management (0301). This subsystem interfaces with the customer (typically a shop or other repair facility) and serves to provide a common status display interface and a method of coordinating other elements of the system.
Quote management (0302). This subsystem coordinates vendor quotes, and availability for parts/products that are requested to be quoted by the shop user.
Advertising management (0303). This subsystem serves as an interface between parts/products orders that are requested by the shop user and vendors that may advertise parts/products in a context-sensitive manner when given the parts/products order. Thus, vendors may opt to display advertising linked to shop user parts/products orders.
Vendor order fulfillment management (0304). This subsystem coordinates fulfillment, and scheduling of parts/products from the vendor to the shop user.
Transportation tracking management (0304). This subsystem coordinates delivery of parts/products from the vendor to the shop user, and manages real-time parts location tracking.
Claims management (0306). This subsystem coordinates the fulfillment of incentives/promotions between vendors and manufacturers to permit seamless processing of vendor reimbursement/credit claims between the manufacturer and the vendor in response to parts/products orders from the shop user.
   The present invention anticipates that these subsystems may be combined in a wide variety of ways, with some embodiments utilizing some but not all of the subsystem components listed above. Some preferred embodiments may integrate the functionality of one or more subsystems into a single functional unit. It is anticipated that these subsystems may be optimally implemented on a computing device executing machine instructions read from a computer readable medium.

### System Overview (0400)

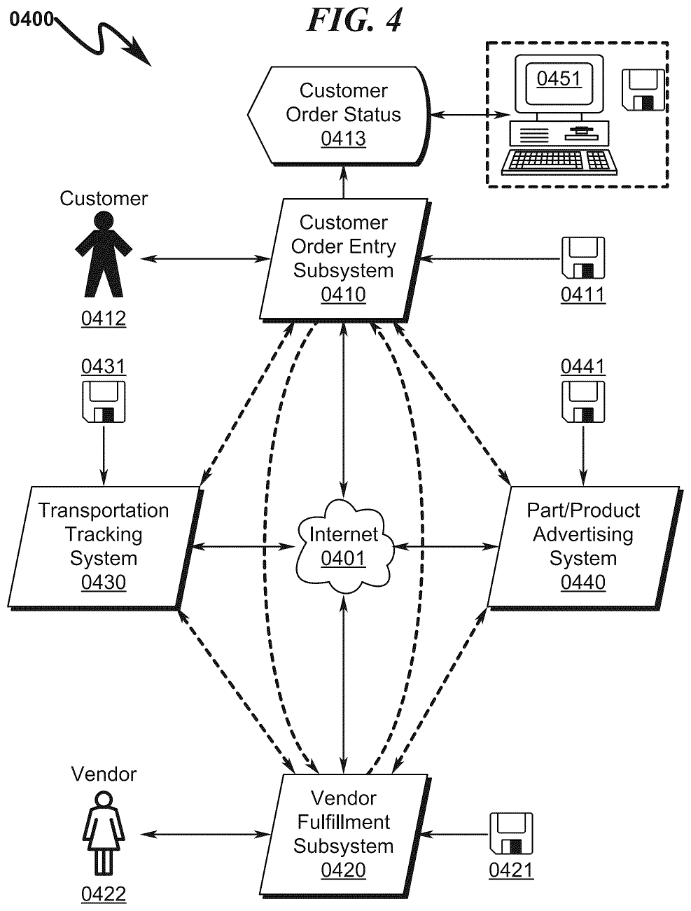

The present invention system may be broadly described as depicted in FIG. 4 (0400). In this context, a customer (0412) interacts with a customer order status subsystem (0413) that communicates via the Internet (0401) (or some other communications network) with a vendor order fulfillment subsystem (0420) to place orders for parts/products. The vendor (0422) interacts with a vendor order fulfillment system (0420) ships the ordered parts/products to the customer (0412) using a transportation tracking system (0430) that notifies the customer order entry subsystem (0410) of the status of the vendor order during all the transportation phases of shipment. Associated with the customer order entry subsystem (0410) is the ability for specific vendor parts/products to be advertised (0440) to targeted customers based on the parts/products that the customer (0412) may wish to order via the customer order entry subsystem.

The customer is provided with a status screen (0413) that displays the current status of the customer's order, including details associated with the part/product order entry (0410), vendor information (0420), part/product transportation (0430) details/status, and targeted advertising (0440) that is context-based and keyed to the part/product that the customer (0412) is attempting to procure.

Within this system context, each of the major system components (0410, 0420, 0430, 0440) may have associated with it computer control systems (0451) running a variety of computer application programs and/or software that is retrieved from a computer usable medium (0411, 0421, 0431, 0441, 0451) having computer-readable program code means. The present invention does not limit the type of physical media on which this software may reside.

### Method Overview (0500)

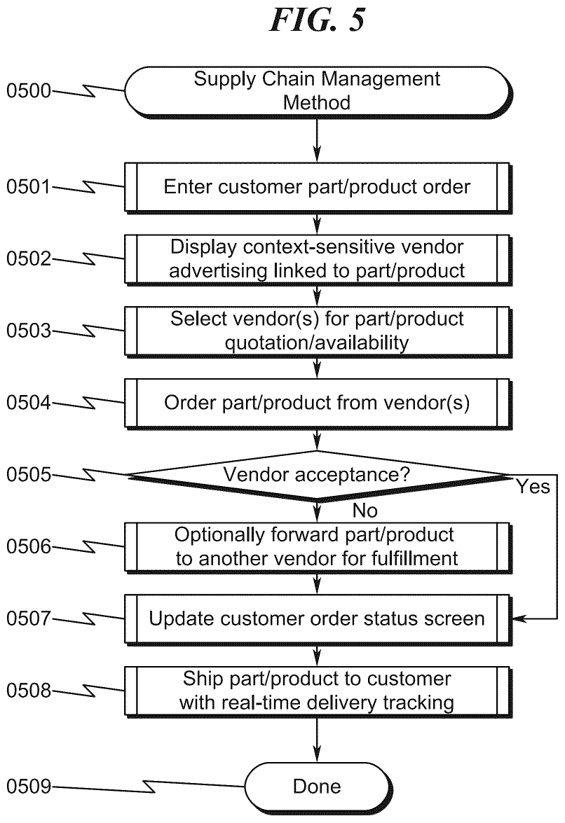

The present invention system described above may be utilized in conjunction with a method as generally described in the flowchart illustrated in FIG. 5 (0500). The steps in this supply chain management method generally comprise:
(1) entering a customer part/product order (0501);
(2) displaying context-sensitive vendor advertising linked to the part/product and allowing the customer to select the advertised vendor for part/product fulfillment (0502);
(3) selecting a vendor for part/product quotation/availability (0503);
(4) ordering the part/product from the selected vendor (0504);
(5) if the vendor accepts the part/product order, proceeding to step (7) (0505);
(6) otherwise, optionally forwarding the part/product order request to another vendor for fulfillment (0506);
(7) updating the customer order status screen (0507); and
(8) shipping the part/product to the customer with real-time delivery tracking (0508).

This general method may be modified heavily depending on a number with a of factors, rearrangement and/or addition/deletion of steps anticipated by the scope of the present invention. Integration of this and other preferred exemplary embodiment methods in conjunction with a variety of preferred exemplary embodiment systems described herein is anticipated by the overall scope of the present invention.

### Alternate Method Overview (0600)

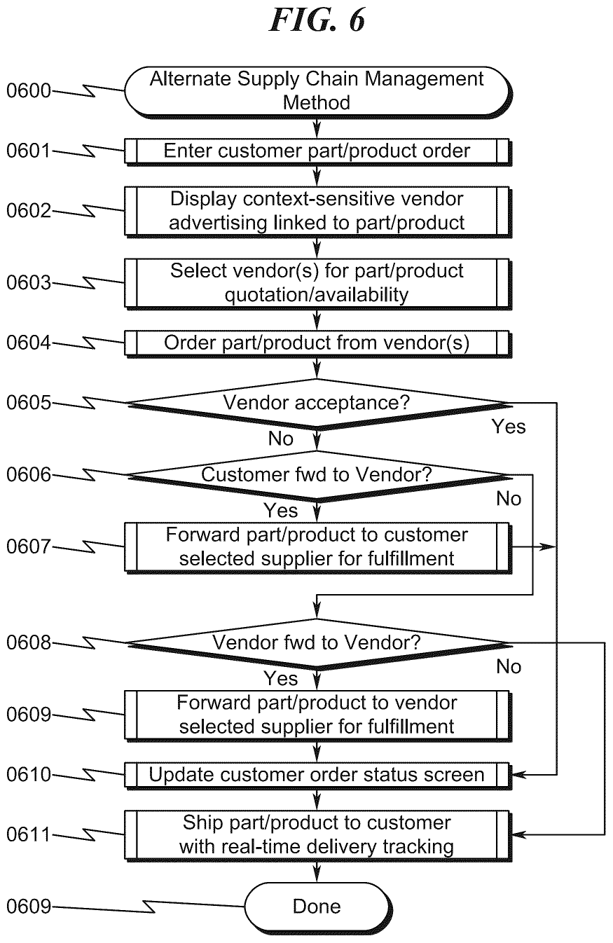

The present invention system described above may be utilized in conjunction with an alternate method as generally described in the flowchart illustrated in FIG. 6 (0600). The steps in this supply chain management method generally comprise:
(1) accepting a customer part/product order or request for vendor quote via a user interface in the customer order entry subsystem (0601);
(2) displaying context-sensitive vendor advertising linked to a part/product on the customer order entry subsystem and allowing the customer to select the advertised vendor for delivery of the part/product (0602);
(3) selecting a vendor for part/product quotation/availability (0603);
(4) ordering the part/product from the selected vendor (0604);
(5) if the selected vendor accepts the part/product order, proceeding to step (10) (0605);
(6) if the customer has not selected customer forwarding of the part/product order request, proceeding to step (8) (0606);
(7) activating customer forwarding of the part/product order request to another vendor and proceeding to step (10) (0607);
(8) if the customer has not selected vendor forwarding of the part/product order request, proceeding to step (11) (0608);
(9) activating vendor forwarding of the part/product order request to another vendor (0609);
(10) updating the customer order status screen (0610); and
(11) shipping the part/product to the customer with real-time delivery tracking (0611).
   This alternative methodology permits optional redirection of the part/product order request to one or more alternative suppliers that are selected either by the customer and/or an intermediate vendor who is presented with a part/product order that cannot be satisfied by the intermediate vendor.

This general method may be modified heavily depending on a number of factors, with rearrangement and/or addition/deletion of steps anticipated by the scope of the present invention. Integration of this and other preferred exemplary embodiment methods in conjunction with a variety of preferred exemplary embodiment systems described herein is anticipated by the overall scope of the present invention.

### Body Shop Management API (0700)

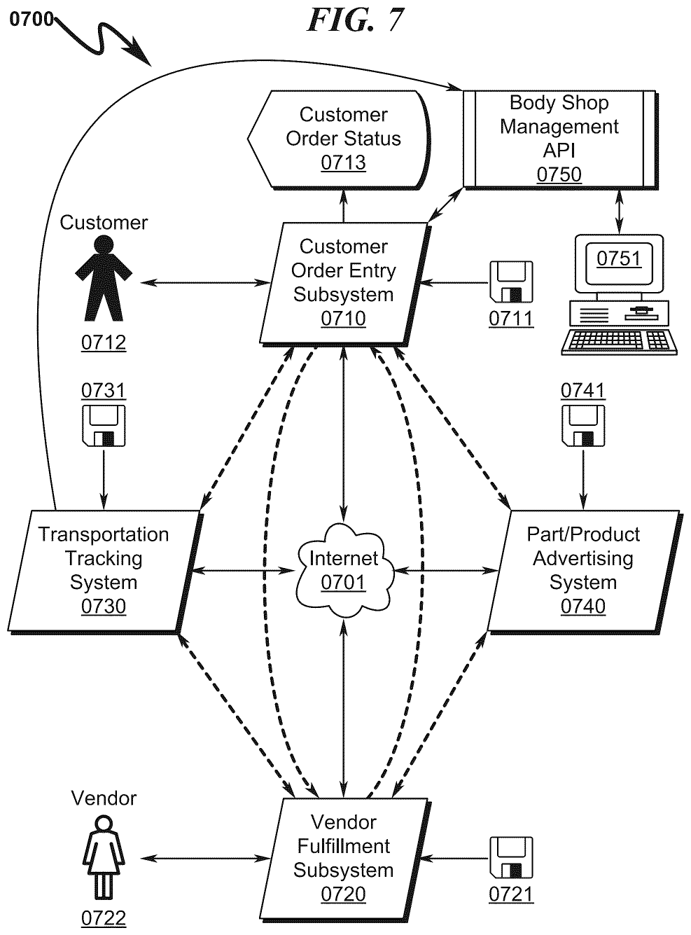

The present invention as generally depicted in FIG. 4 (0400) may also incorporate an interface to a body shop management software application as generally illustrated in FIG. 7 (0700). As generally depicted in FIG. 7 (0700), the Body Shop Management API (0750) software application permits communication with one or more computer systems (0751) that operate a separate scheduling system that coordinates the personnel and resources associated with a body shop. This API bridge (0750) permits software running on the body shop management computer (0751) to optimally schedule personnel and resources within the body shop application environment so that efficiencies within this application context are maximized.

### Integrated Body Shop Management (0800)

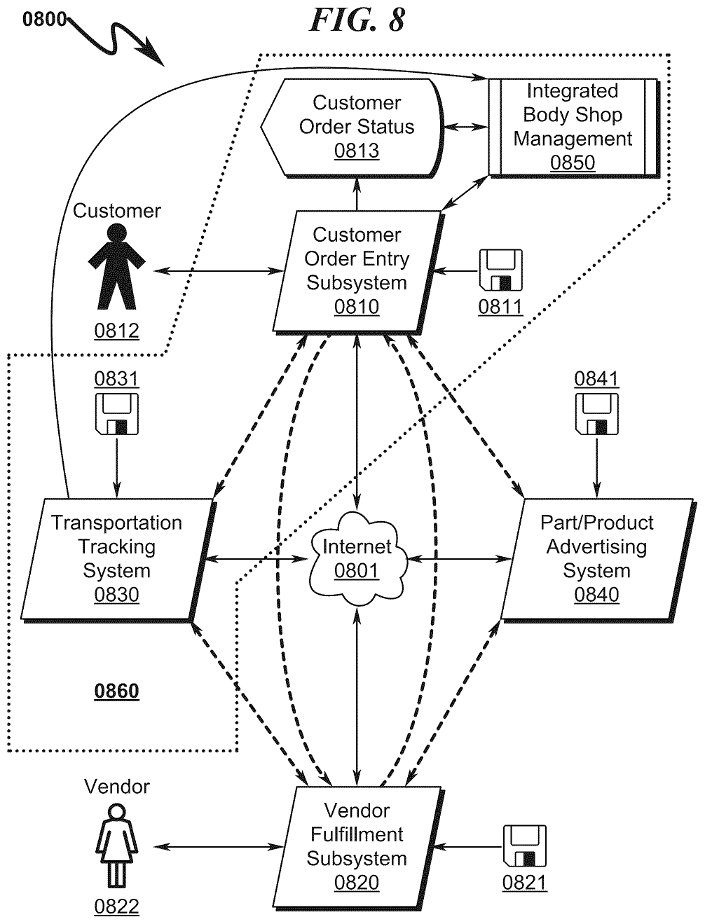

The present invention as generally depicted in FIG. 4 (0400) may also incorporate an integrated body shop management software application as generally illustrated in FIG. 8 (0800). This preferred embodiment differs from that of FIG. 7 (0700), in that the preferred embodiment as generally depicted in FIG. 8 (0800) integrates the Body Shop Management application (0850) software application within the part/product procurement logistics system/method (0860) as taught herein to fully integrate the operations of the body shop. This integrated software application (0850) permits global optimization of both part/product delivery as well as scheduling of body shop resources to optimize technician/equipment/resource allocation and improve overall body shop throughput.

### Customer Forwarding of Part/Product Requests (0900)

In some circumstances a customer request for a given part/product is outside the scope of the vendor's current inventory, or the lead-time for part/product delivery exceeds specifications set by the customer. In these circumstances rather than simply ignoring the customer's part/product request or indicating that the order cannot be accommodated, the customer has the option of forwarding the part/product request to another vendor (or group of vendors). This scenario permits the customer part/product request to “crawl” through a network of vendors in search of appropriate fulfillment. Note in these circumstances the forwarded part/product request may be directed to vendors that the customer has direct no knowledge of but which are financially related to the forwarding vendor. In this manner, the forwarding vendor may reap a “finder's fee” for forwarding business to third party vendors not directly connected to the requesting customer.

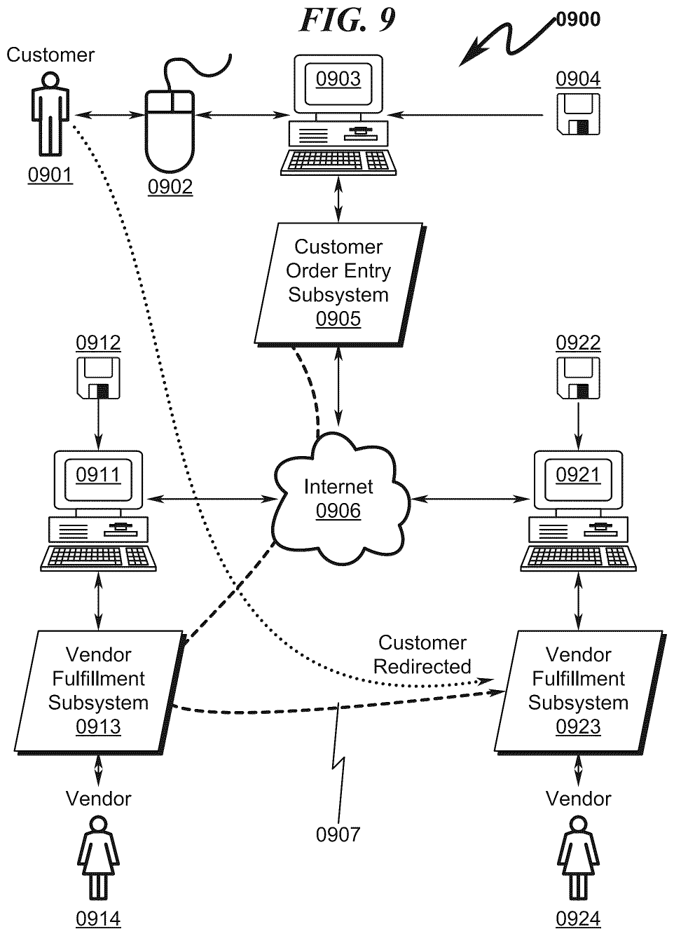

An example of this invention embodiment is generally illustrated in FIG. 9 (0900), wherein the customer (0901) interacts with a graphical user interface (GUI) (0902) operating under control of a computer system (0903) running software read from a computer readable medium (0904). Within this context the customer order entry subsystem (0905) operates and communicates via the Internet (0906) to one or more remote computer systems (0911, 0921) running local and/or web-based application software (0912, 0922). Within each of these remote computer systems (0911, 0921) the vendor order fulfillment subsystem(s) (0913, 0923) operate and communicate with remote vendor agents (0914, 0924). When a particular vendor (0914) interacting with a remote vendor order fulfillment system (0913) is given a part/product order request (0908) and can't fulfill this order request, the customer (0901) may direct that the order request be forwarded (0907) to another vendor order fulfillment subsystem (0923) (typically via the Internet (0905)) for acceptance/refusal by the alternate vendor (0924). Note that this order forwarding process can be chained to any depth, and as described below, the forwarding process (0907) may include “vendor nesting” which can involve “branching” the part/product order request and simultaneously “fanning-out” the request to multiple sub-vendors in an attempt to satisfy the customer's (0901) part/product order request.

### Vendor Forwarding of Part/Product Requests (1000)

In some circumstances a customer request for a given part/product is outside the scope of the vendor's current inventory, or the lead-time for part/product delivery exceeds specifications set by the customer. In these circumstances rather than simply ignoring the customer's part/product request or indicating that the order cannot be accommodated, the vendor has the option of forwarding the part/product request to another vendor (or group of vendors). This scenario permits the customer part/product request to “crawl” through a network of vendors in search of appropriate fulfillment. Note in these circumstances the forwarded part/product request may be directed to vendors that the customer has no knowledge of but which are financially related to the forwarding vendor. In this manner, the forwarding vendor may reap a “finder's fee” for forwarding business to third party vendors not directly connected to the requesting customer.

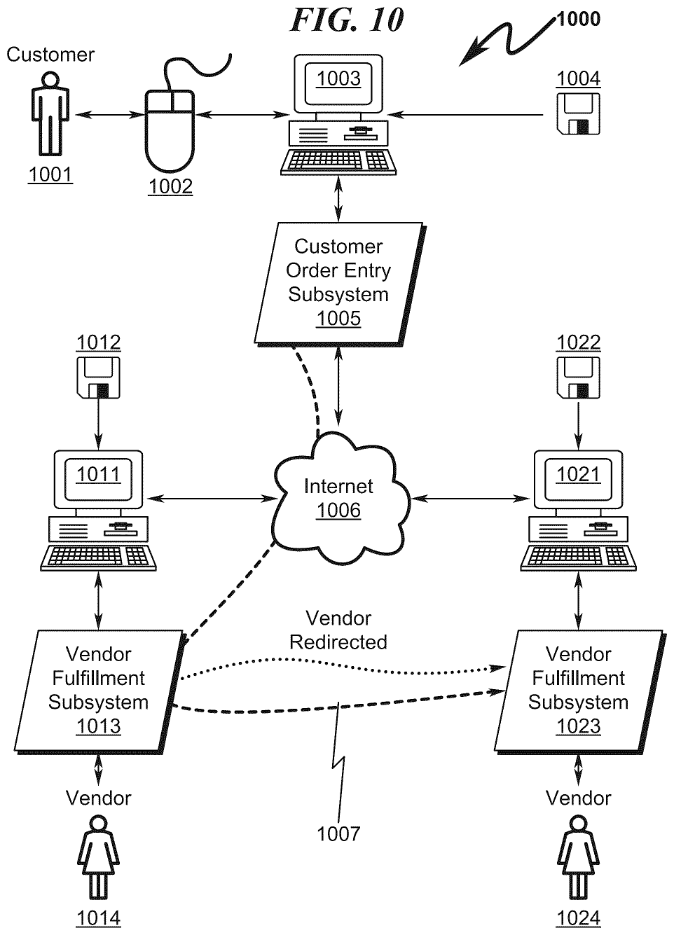

An example of this invention embodiment is generally illustrated in FIG. 10 (1000), wherein the customer (1001) interacts with a graphical user interface (GUI) (1002) operating under control of a computer system (1003) running software read from a computer readable medium (1004). Within this context the customer order entry subsystem (1005) operates and communicates via the Internet (1006) to one or more remote computer systems (1011, 1021) running local and/or web-based application software (1012, 1022). Within each of these remote computer systems (1011, 1021) the vendor order fulfillment subsystem(s) (1013, 1023) operate and communicate with remote vendor agents (1014, 1024). When a particular vendor (1014) interacting with a remote vendor order fulfillment system (1013) is given a part/product order request (1008) and can't fulfill this order request, the vendor (1014) may direct that the order request be forwarded (1007) to another vendor order fulfillment subsystem (1023) (typically via the Internet (1005)) for acceptance/refusal by the alternate vendor (1024). Note that this order forwarding process can be chained to any depth, and as described below, the forwarding process (1007) may include “vendor nesting” which can involve “branching” the part/product order request and simultaneously “fanning-out” the request to multiple sub-vendors in an attempt to satisfy the customer's (1001) part/product order request.

### Vendor Nested Forwarding (1100)

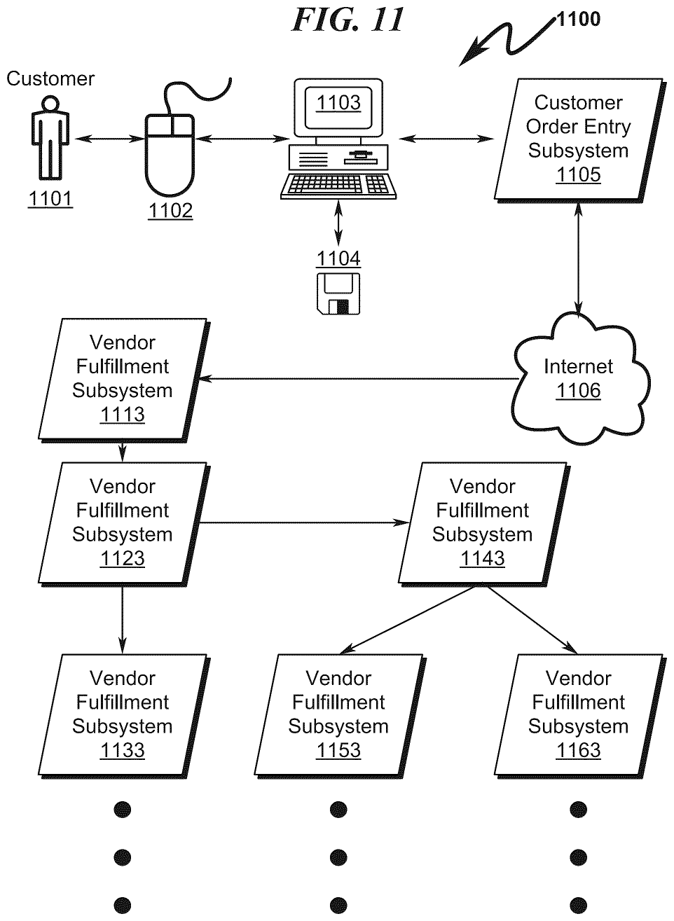

As generally depicted in FIG. 11 (1100), vendor forwarding as described above may incorporate a networked “chain” of vendor fulfillment subsystems (1113, 1123, 1133, 1143, 1153, 1163) that form a directed search graph of vendors to which the part/product order request may be submitted in hopes of obtaining an acceptable vendor response as to part/product price/availability. The present invention anticipates that this nested forwarding capability may be configurable by the customer and/or the vendors to permit both customers and vendors to tailor their search paths as well as optimize the potential for obtaining the desired part/product at an acceptable price/delivery schedule.

### Vendor Groups (1200)

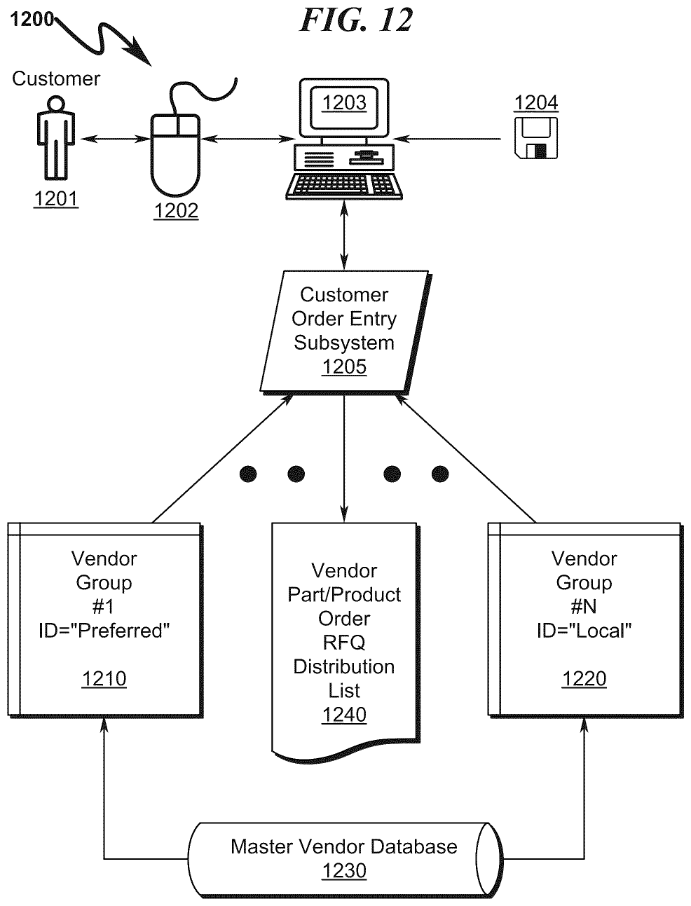

The present invention anticipates that in some preferred embodiments the customer may submit a part/product order to multiple vendors in an attempt to obtain optimal part/product price and/or delivery characteristics. As generally illustrated in FIG. 12 (1200), this vendor “broadcast” capability may incorporate the concept of “vendor groups” that act as shorthand for lists of vendors that can be interrogated as to the availability/delivery of a part/product.

Referencing FIG. 12 (1200), this exemplary invention embodiment permits the customer (1201) to interact with a graphical user interface (1202) running under control of a computer system (1203) under direction of software read from a computer readable media (1204). The customer order entry subsystem (1205) operating under this hardware/software environment permits one or more vendor groups (1210, 1220) to be extracted from a master vendor database (1230). These vendor groups (1210, 1220) can then be given customer-defined identifiers (“Preferred”, “Local”, etc.) as shorthand to represent the actual list of associated group vendors. These vendor groups (1210, 1220) can then be used to broadcast request-for-quote (1240) messages to the associated vendors requesting price/availability/delivery information on a given part/product.

### Exemplary Status Screen (1300)

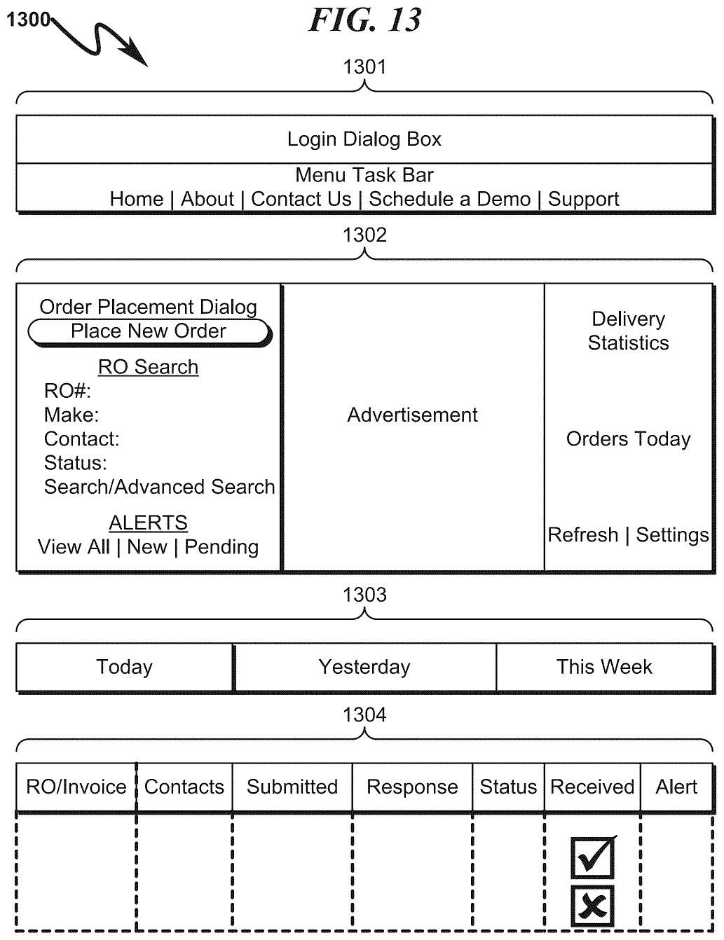

The present invention may in many preferred embodiments incorporate an integrated status display screen as generally illustrated in FIG. 13 (1300) that may incorporate a login/menu dialog (1301), order/advertisement/status dialog (1302), calendar dialog (1303), and sorted procurement list (1304). The login/menu dialog (1301) provides general system login interactions and menu task selection. The order/advertisement/status dialog permits a particular part/product order to be initiated and provides context sensitive advertisement information associated with advertising sponsors as well as providing current delivery statistics and pending orders for a given day (1302). The calendar dialog (1303) permits alternate displays of different days/weeks for the purposes of parts delivery scheduling. The sorted procurement list (1304) provides information regarding the RO/Invoice, contacts, order submission date, vendor response, current part/product delivery status, information regarding part/product reception, and any alert status messages associated with a given parts order.

### Exemplary Embedded Advertising (1400, 1500)

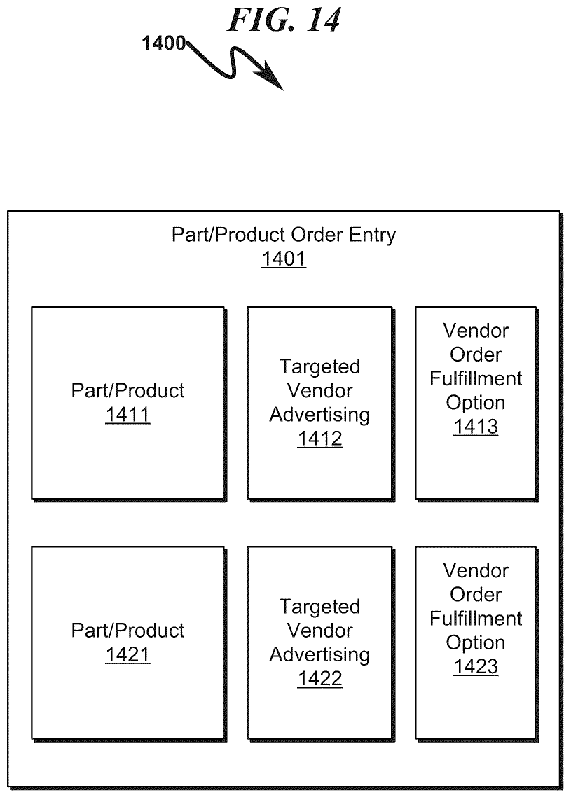

A useful component of many preferred invention embodiments is the integration of targeted vendor advertising that is keyed to specific part/product orders placed by a customer. As generally illustrated in FIG. 14 (1400), a general part/product ordering screen (1401) may incorporate one or more part/product order specification lines (1411, 1421) that are filled in by customers wishing to order a particular part/product from either a specific vendor or a selected group of vendors. These part/product order specification lines (1411, 1421) may trigger the display of associated vendor advertising (1412, 1422) that is keyed to the customer's part/product order. Additionally, the customer may opt to fulfill the part/product order request by selecting the vendor's order fulfillment option (1413, 1423).

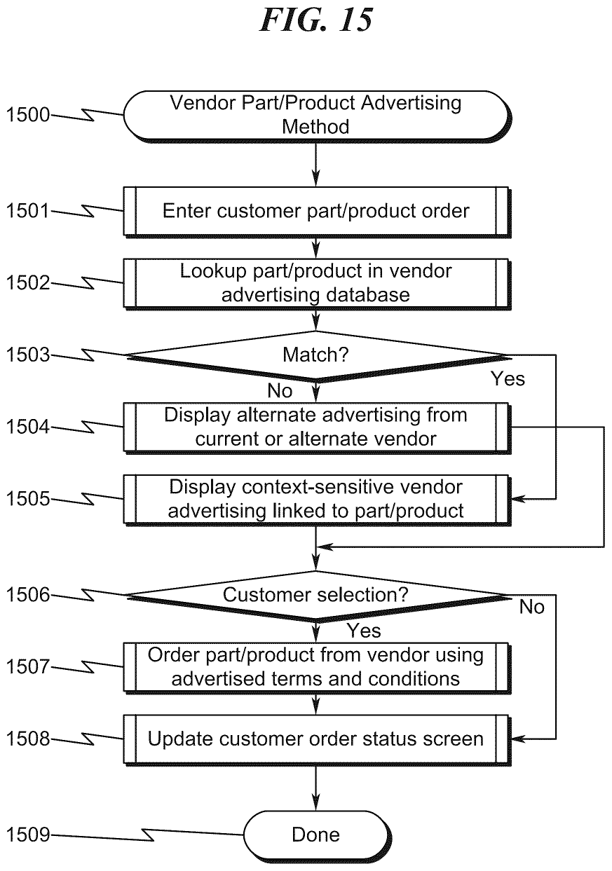

The exemplary system described above may be utilized in conjunction with a method as generally described in the flowchart illustrated in FIG. 15 (1500). The steps in this part/product vendor advertising method generally comprise:
(1) entering a customer part/product order (1501);
(2) looking up the part/product in a vendor advertising database (1502);
(3) determining if there is a database match, and if not, proceeding to step (5) (1503);
(4) displaying alternate advertising from the current vendor or selecting another vendor's advertising for display (1504);
(5) displaying context-sensitive vendor advertising linked to the part/product, or general vendor advertising (1505);
(6) determining if the customer has selected any of the vendor's part/product offerings for delivery, and if not, proceeding to step (8) or choose another vendor (1506);
(7) ordering the part/product from the selected vendor under the advertised terms and conditions (1507);
(8) updating the customer order status screen (1508); and
(9) terminating the part/product vendor advertising method (1509).

This general method may be modified heavily depending on number of factors, a with rearrangement and/or addition/deletion of steps anticipated by the scope of the present invention. Integration of this and other preferred exemplary embodiment methods in conjunction with a variety of preferred exemplary embodiment systems described herein is anticipated by the overall scope of the present invention.

Within the context of the part/product order entry functions, the present invention may incorporate embedded advertising for specific part/product items and/or combinations.

### Manufacturer Incentive/Promotion Claims Integration (1600)

The business relationship between a shop/customer and a dealer/dealership/vendor is often complicated by the fact that OEM and other manufacturers who source parts to individual dealer/dealership/vendors often provide for a wide variety of sales incentives/promotions associated with their parts/products. These incentives/promotions generally require some documentation to be provided by the dealer/dealership/vendor that is linked to the ultimate sale of the part/product to the shop/customer. Traditionally this sales architecture has been plagued by issues associated with collecting and organizing the required sales documentation for the manufacturer to allow the dealer/dealership/vendor to satisfy the manufacturer's sales criterion. in order to qualify for the incentive/promotion and obtain the rebate/credit from the manufacturer for the ultimate sale to the shop/customer. Additionally, since this paper-driven architecture often services numerous dealer/dealership/vendors, consolidating the sales associated with the incentive/promotion and generating meaningful sales statistics and trends for the manufacturer has not been practical using these manual techniques.

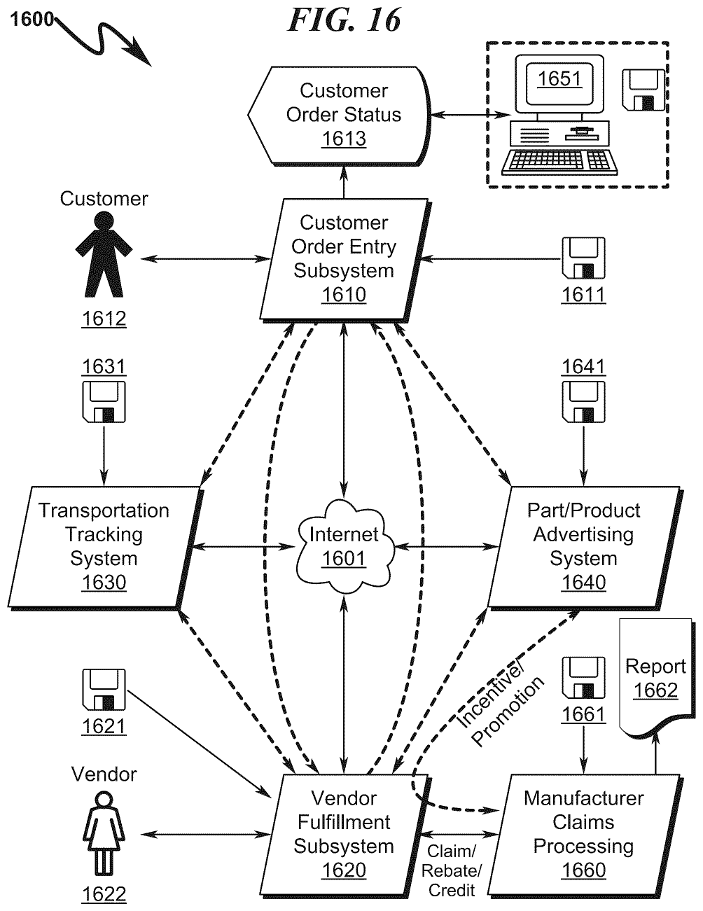

The present invention as generally illustrated in FIG. 16 (1600) may be augmented in some preferred embodiments with a manufacturer claims processing subsystem (1660) operating on a computer system under control of machine instructions retrieved from a computer readable medium (1661) that interfaces with the vendor fulfillment system (1620) and/or part/product advertising subsystem (1640) to allow manufacturer incentive/promotions to be promoted by a vendor (1622) to a shop/customer (1612). This manufacturer claims processing subsystem (1660) may in some embodiments be integrated into other subsystems within the overall invention system context. This permits information related to the ultimate sale of manufacturer parts/products to the shop/customer (1612) to be logged and for the required documentation regarding the sale in support of the manufacturer incentive/promotion to be gathered and automatically forwarded to the manufacturer for review, approval, and/or audit. Sales reports (1622) generated from this logged data permit the manufacturer to monitor the success of the incentive/promotion as well as monitor sales for abuses and other abnormalities. This integration of manufacturer claims processing into the overall part/product sales cycle permits manufacturers to streamline sales of their products into the vendor network while simultaneously maintaining control of their incentive/promotion programs with real-time sales reporting capabilities.

### Exemplary Invention System Architecture (1700)

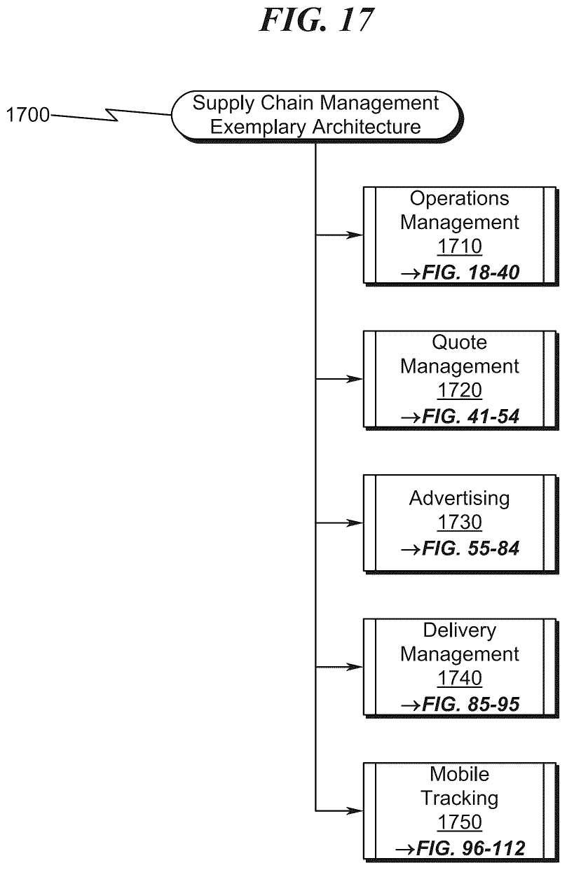

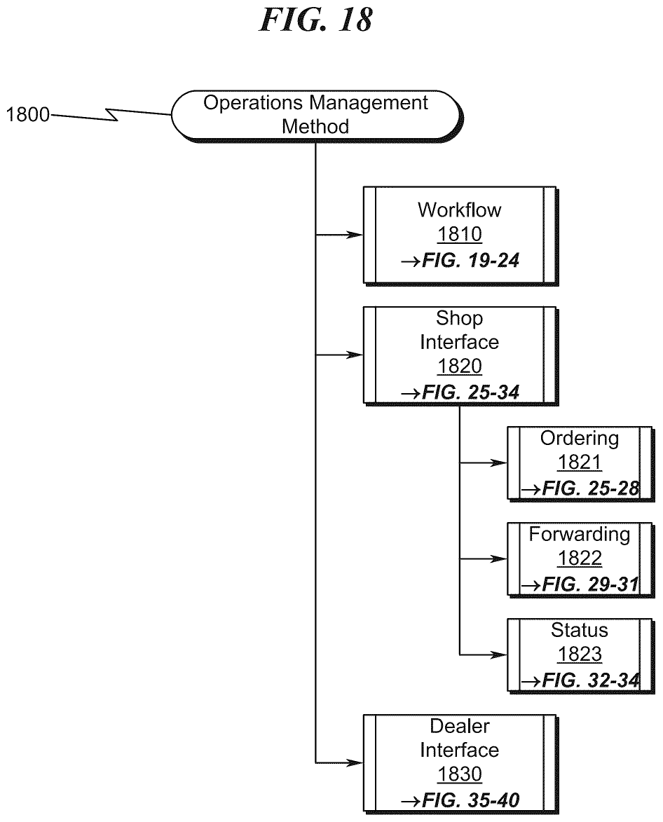

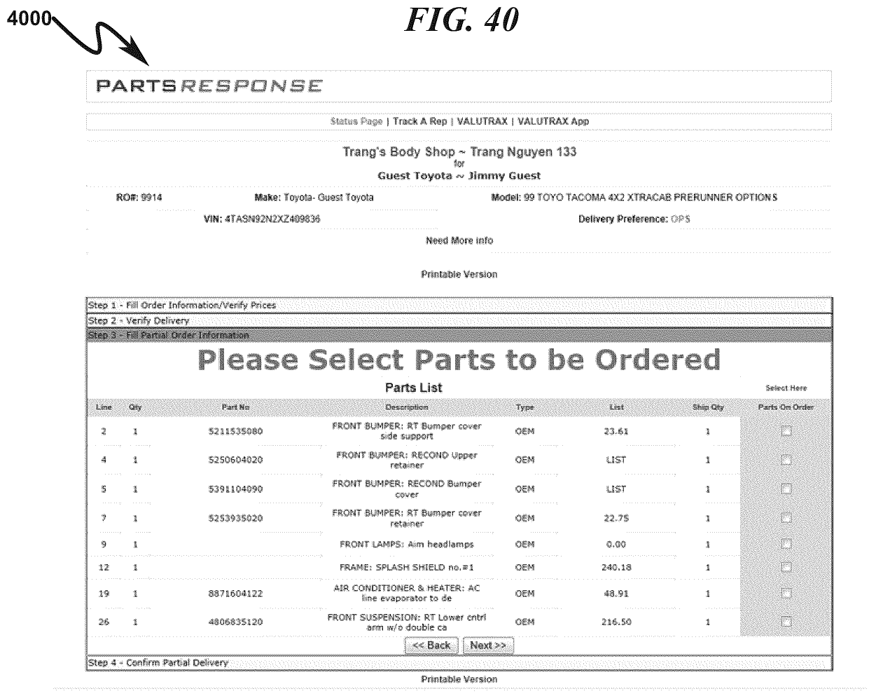

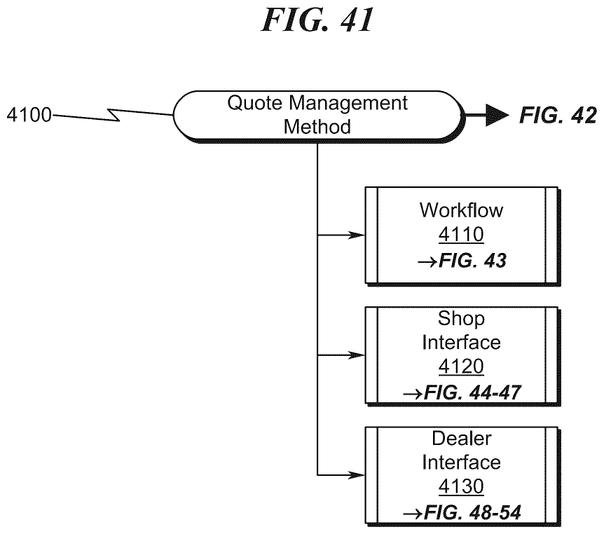

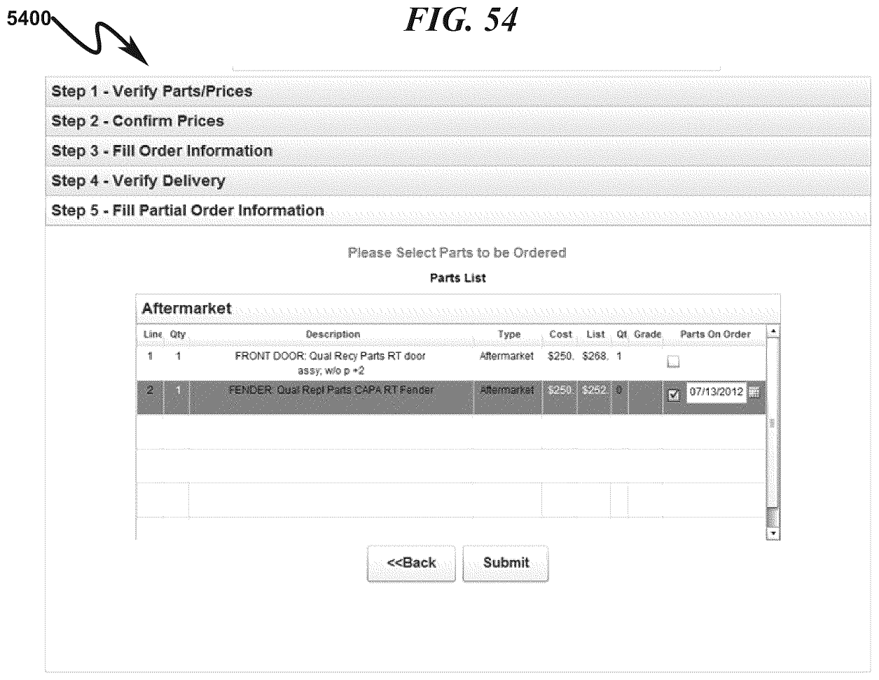

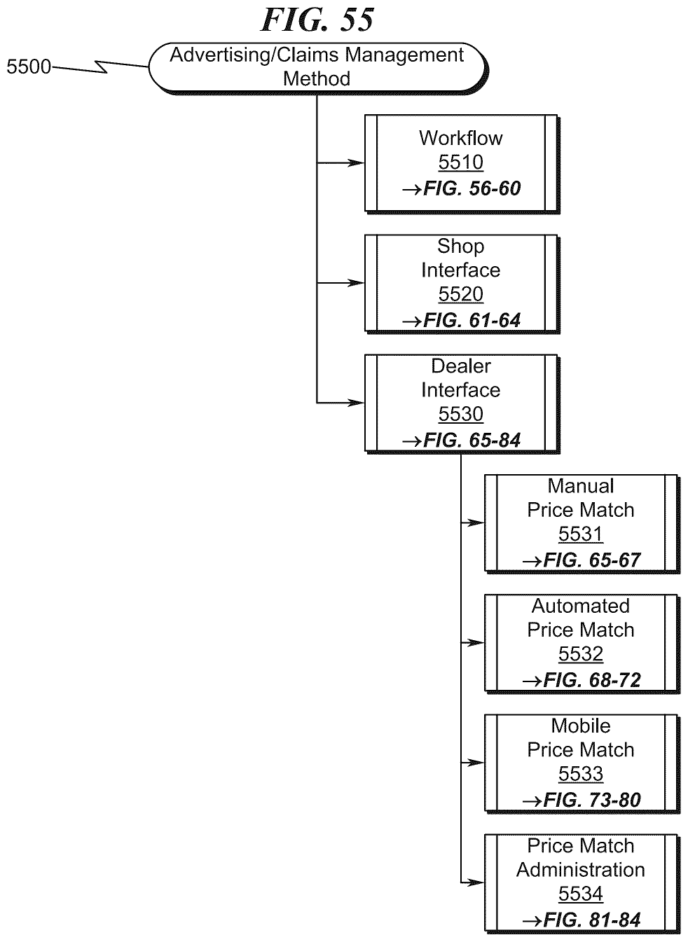

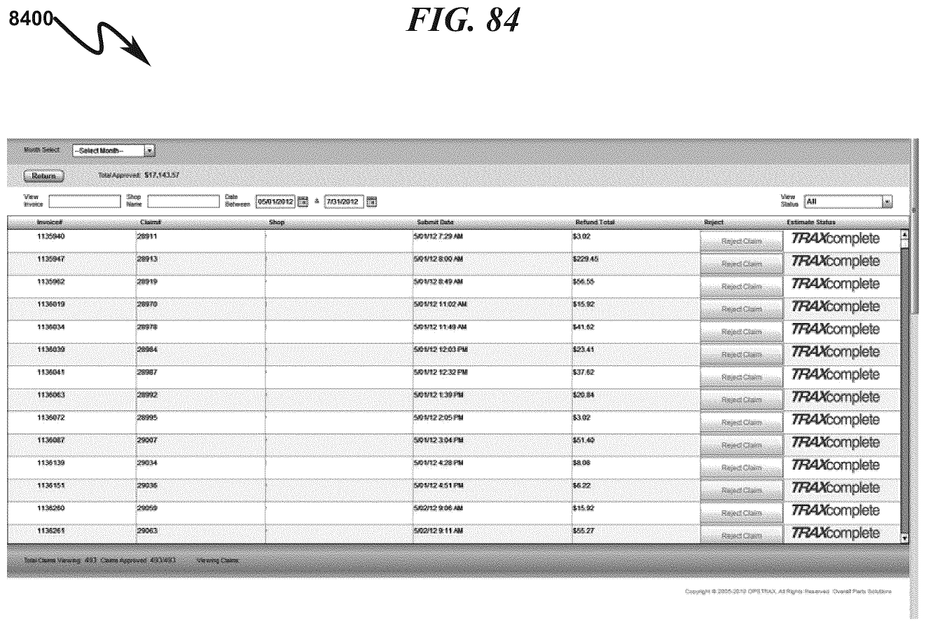

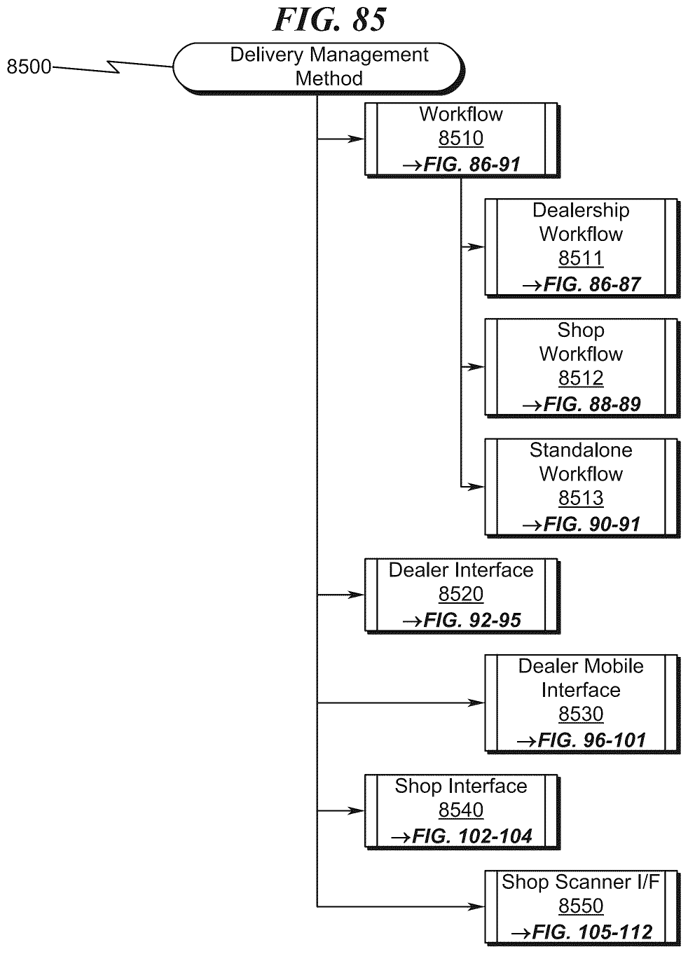

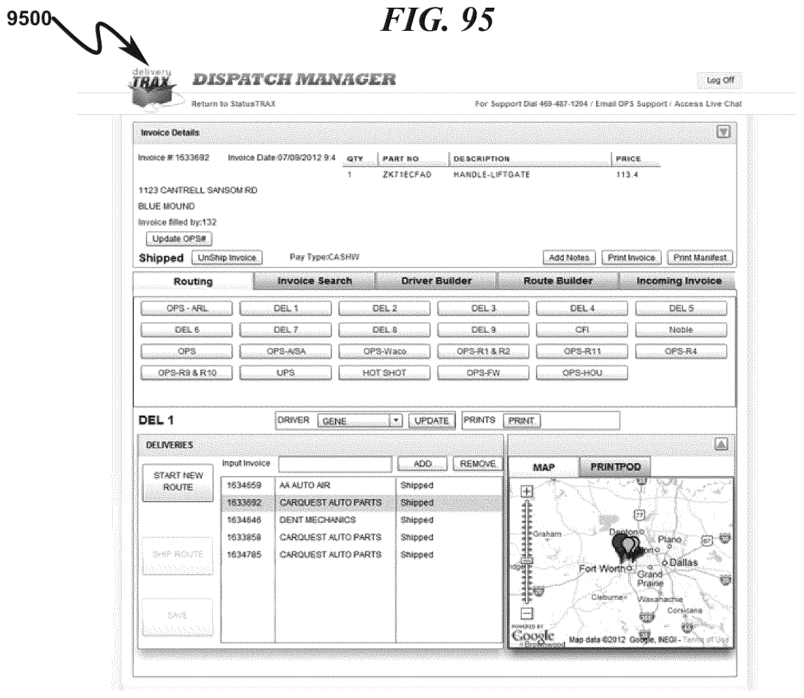

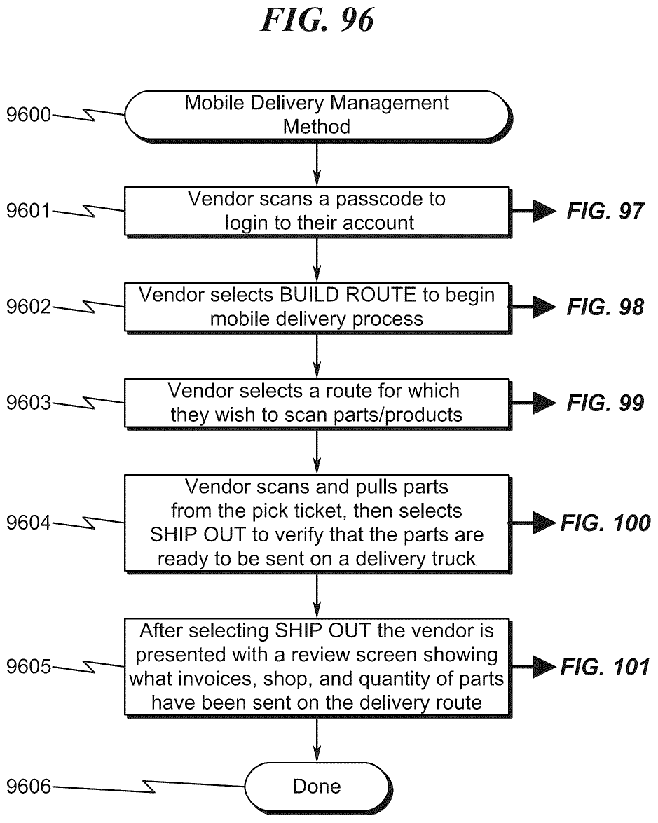

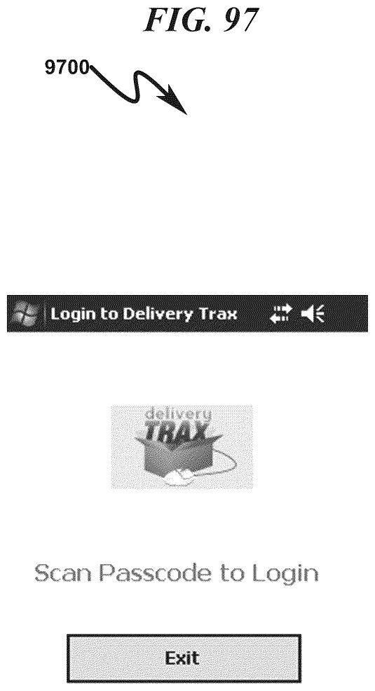

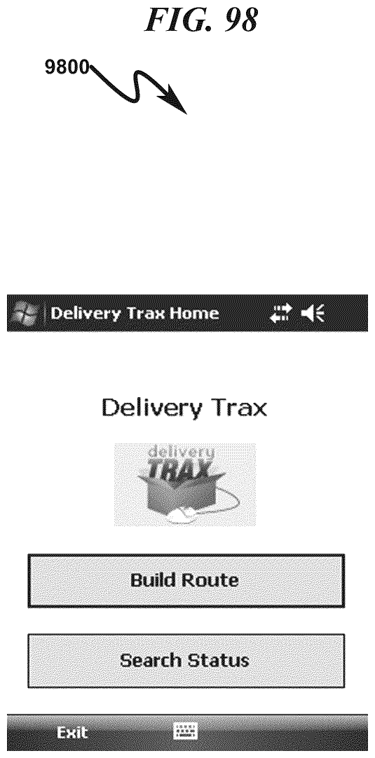

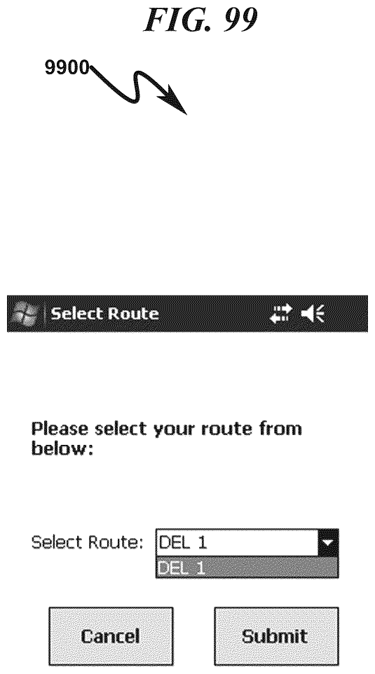

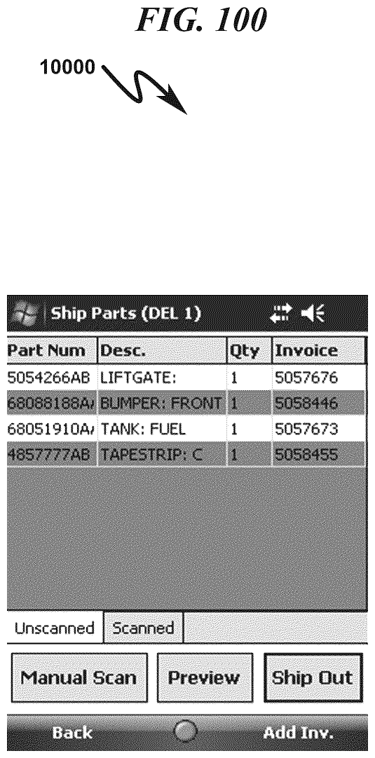

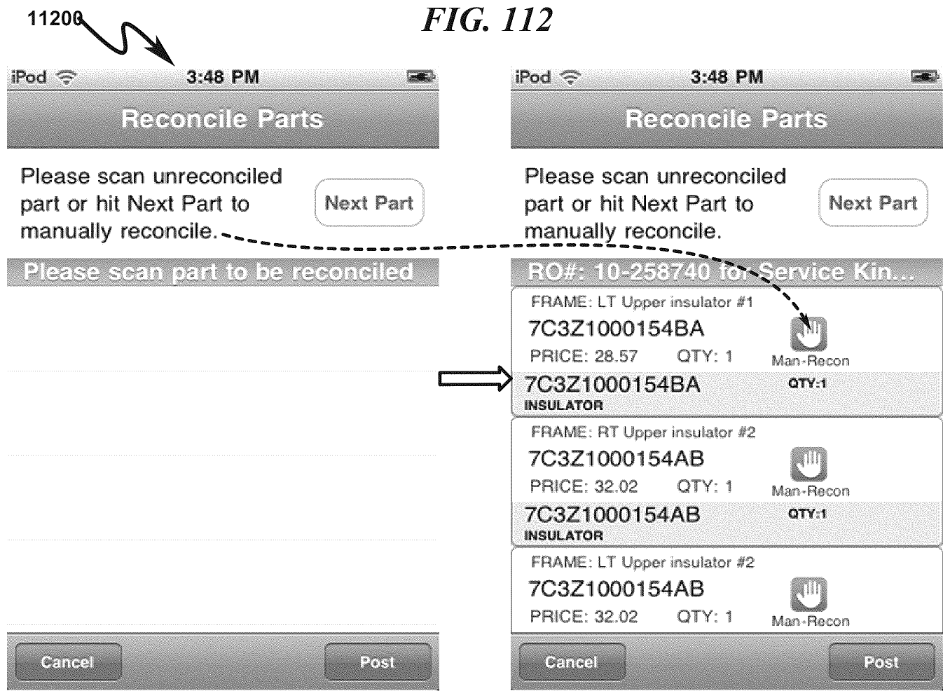

While the present invention may be embodied in a wide variety of configurations, an exemplary system architecture is generally illustrated in FIG. 17 (1700), wherein a typical system incorporates the following components:
operations management (1710), responsible for the customer interface, ordering, and status screens (FIG. 18 (1800)-FIG. 40 (4000));
quote management (1720), responsible for the solicitation and coordination of part/product quotes between customers and vendors (FIG. 41 (4100)-FIG. 54 (5400));
advertising and claims management (1730), responsible for part/product advertising and manufacturer claims management (FIG. 55 (5500)-FIG. 84 (8400));
delivery management (1740), responsible for part/product delivery by the vendor (FIG. 85 (8500)-FIG. 95 (9500)); and
mobile tracking (1750), responsible for real-time tracking of vendor deliveries to the customer (FIG. 96 (9600)-FIG. 112 (11200)).
   Discussions of these major r subsystem blocks and their subfunctions follow. While this depicted embodiment is exemplary, it does provide sufficient information for one of ordinary skill to implement a wide variety of other configurations consistent with the teachings of the present invention. The figure ranges described above incorporate both the functional flowcharts associated with the subsystems as well as referenced exemplary user interface screen shots depicting an exemplary implementation of the methodology described in the individual flowchart. Within these general categories, there may exist some functional overlap within subsystems in this exemplary embodiment description.

Generally speaking, the discussions of each of the major subsystems identified above will include a WORKFLOW diagram depicting how information is relayed within the various subsystem components as well as a SHOP interface describing how the customer interfaces to that particular portion of the system and a DEALER interface describing how a vendor interfaces to that particular portion of the system. Within this context the terms SHOP and DEALER are arbitrary and may vary based on application context.

### Operations Management Method (1800)-(4000)

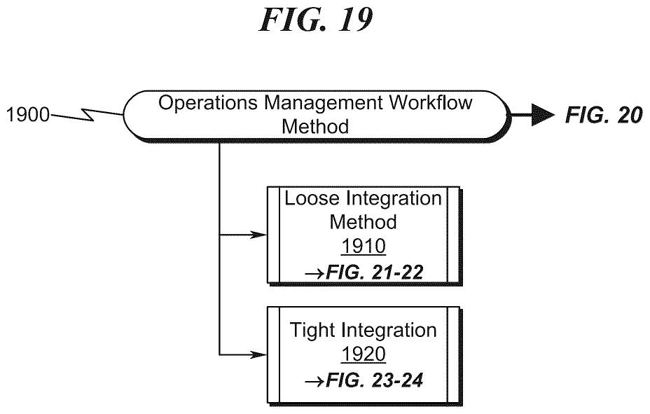

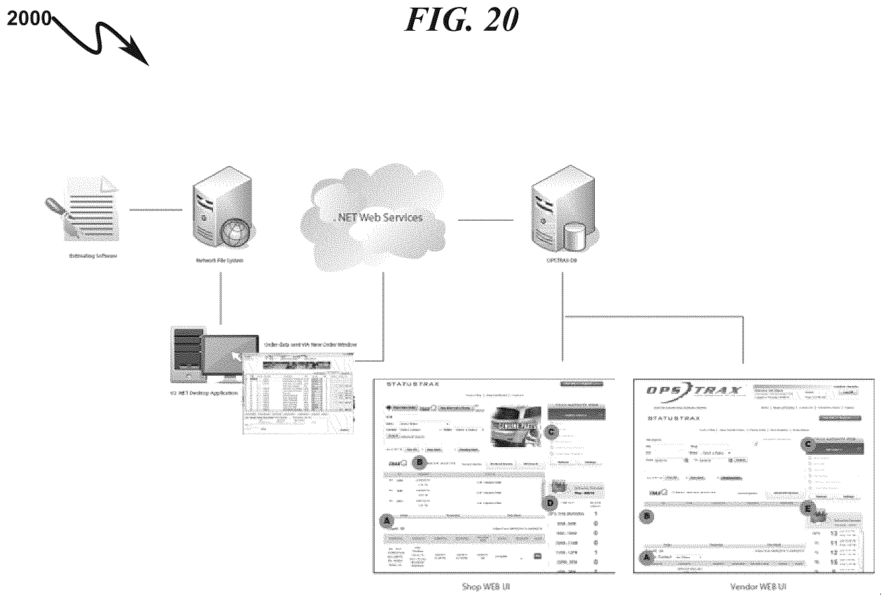

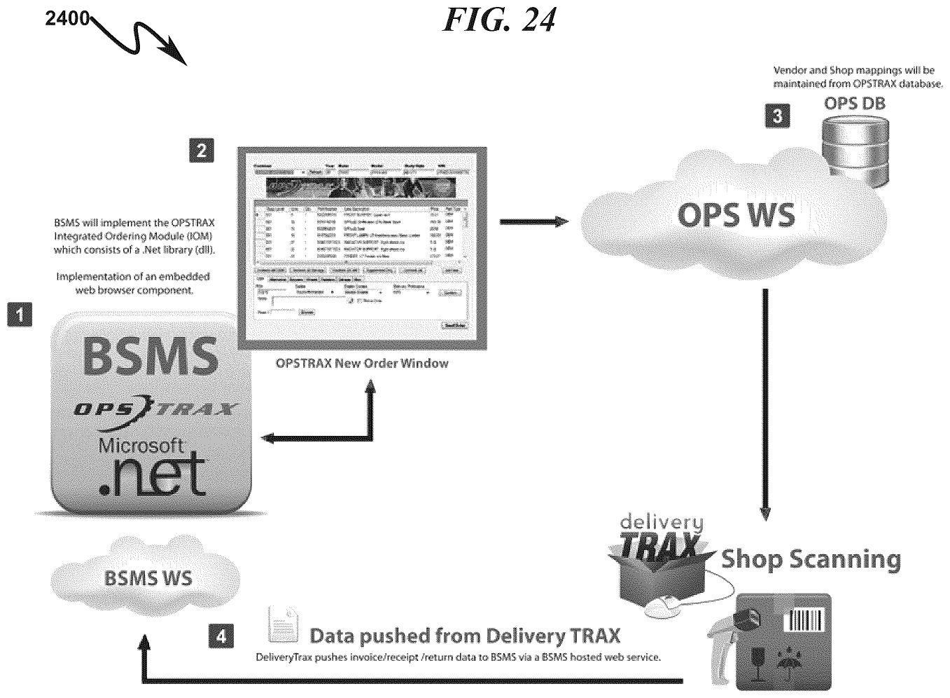

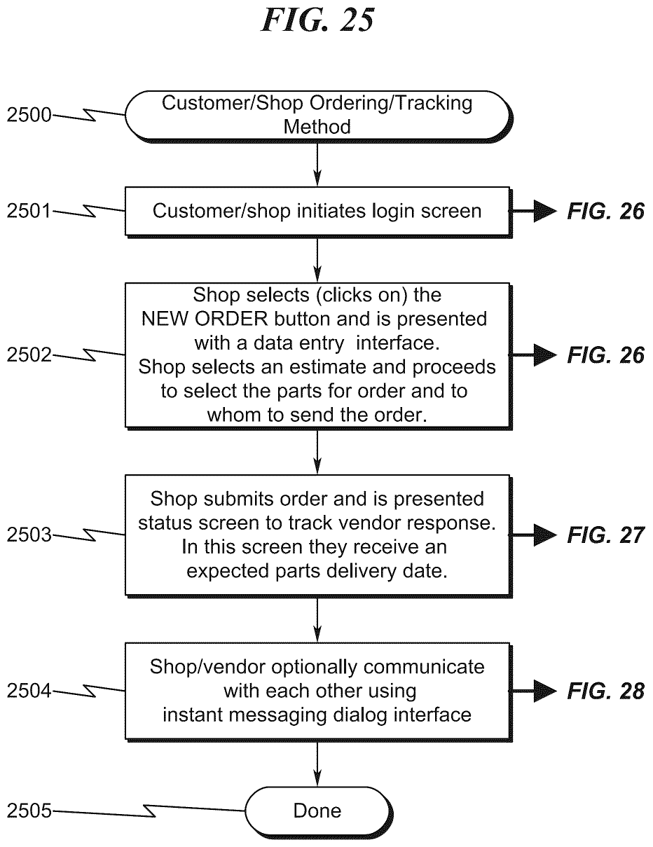

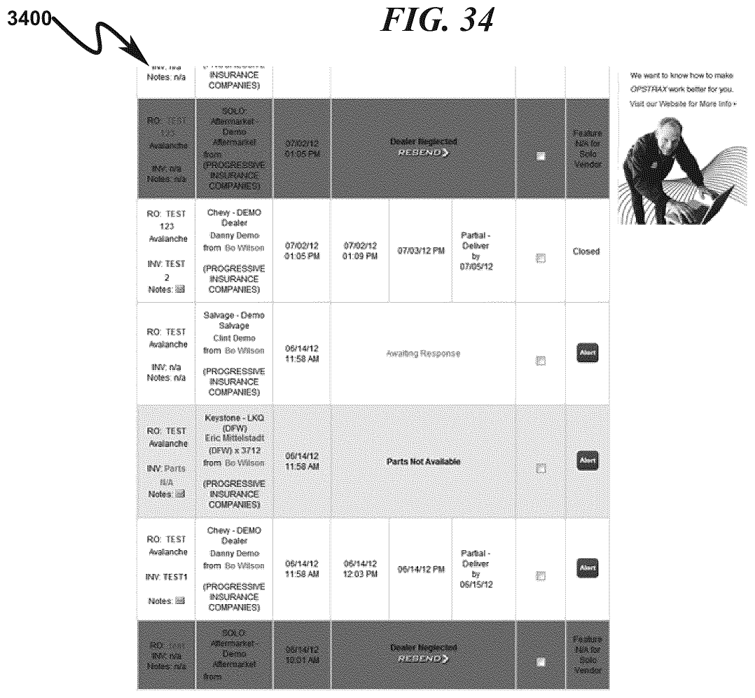

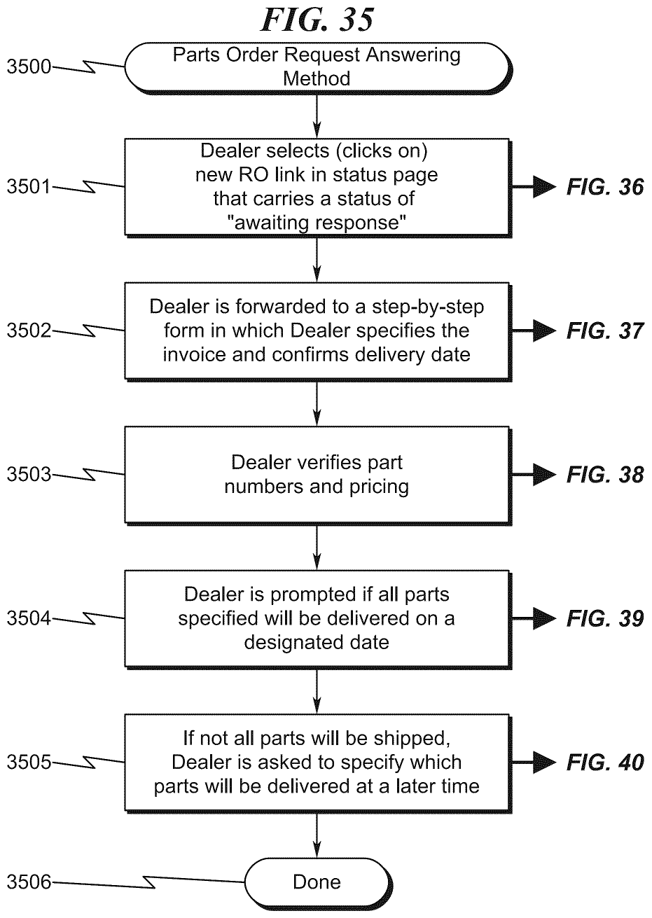

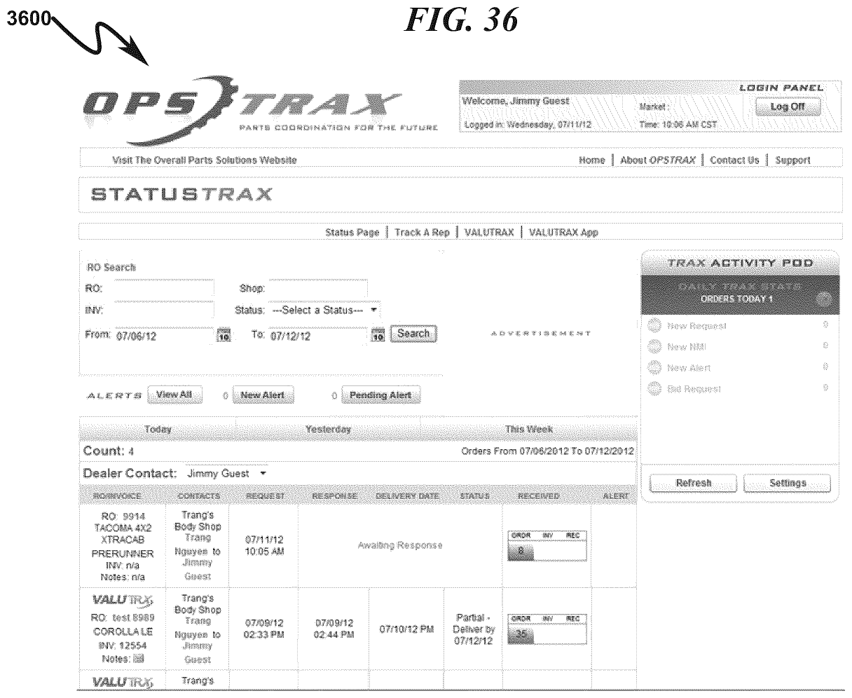

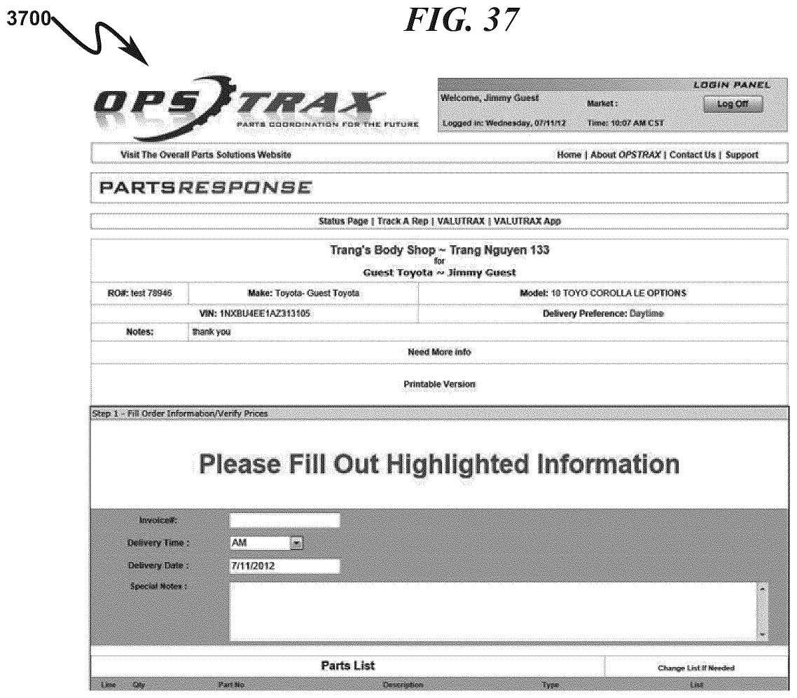

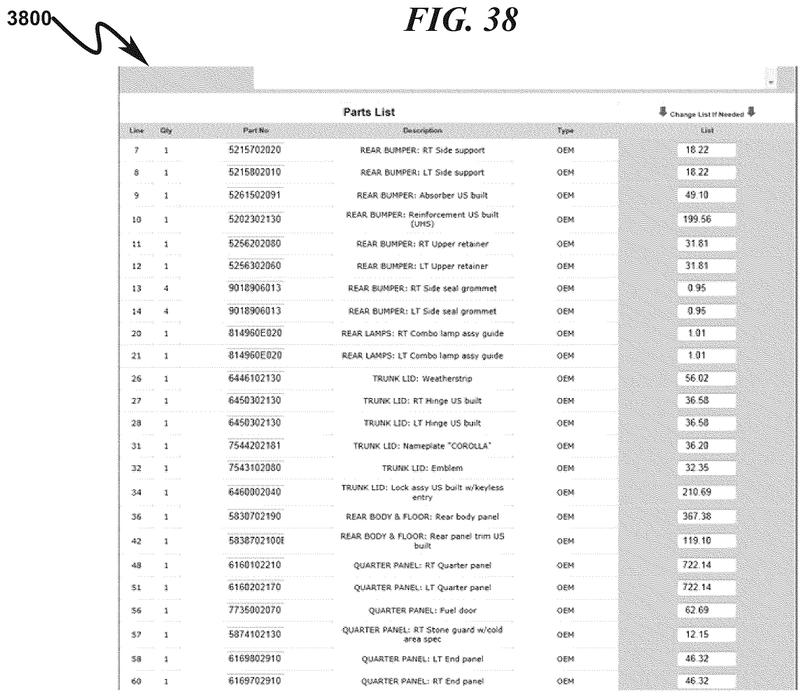

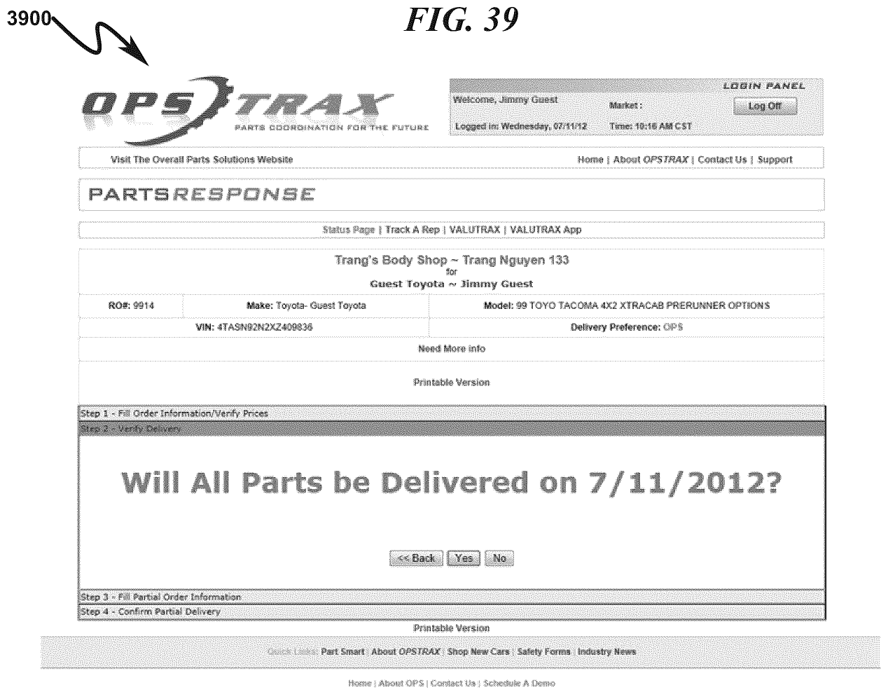

As generally illustrated in FIG. 18 (1800), the operations management method may be described in terms of a workflow (1810) (FIG. 19 (1900)-FIG. 24 (2400)), shop interface (1820) (FIG. 25 (2500)-FIG. 34 (3400)), and dealer interface (1830) (FIG. 35 (3500)-FIG. 40 (4000)).

### Workflow (1900)-(2400)

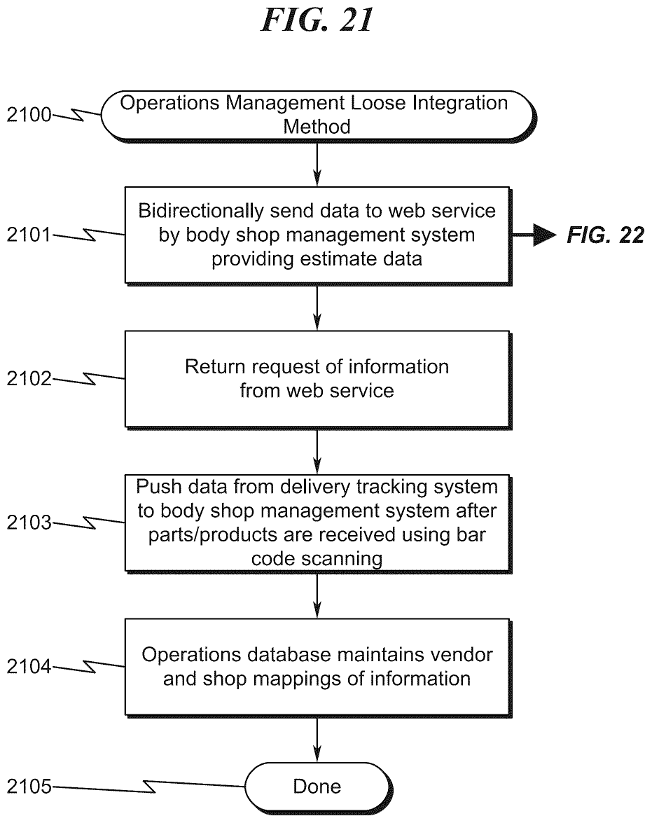

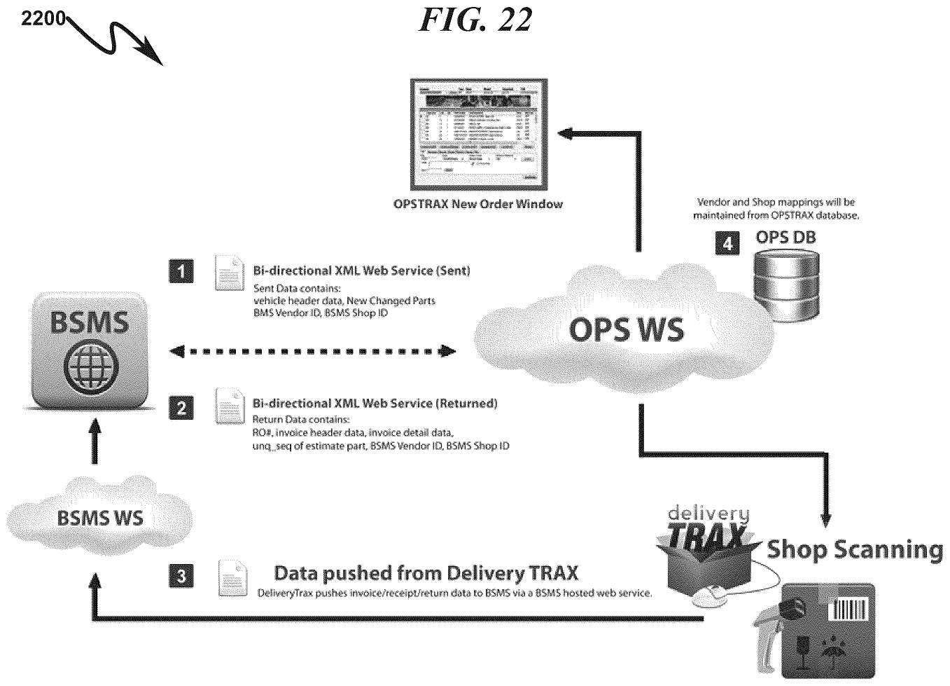

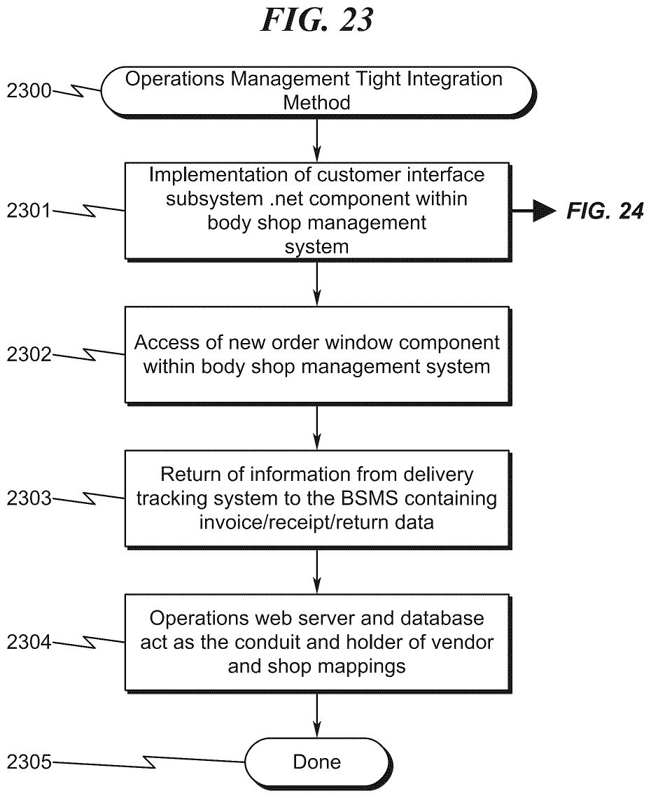

Generally speaking, the present invention permits two types of integration with traditional body shop management systems:
Loose integration (FIG. 21 (2100)-FIG. 22 (2200)) wherein data is extracted from the body shop management system and sent to a separate database for processing; and
Tight integration (FIG. 23 (2300)-FIG. 24 (2400)) wherein the operational management components of the present invention are tightly integrated into the body shop management system using a BSMS API.

### Shop Interface Order Entry (2500)-(2800)

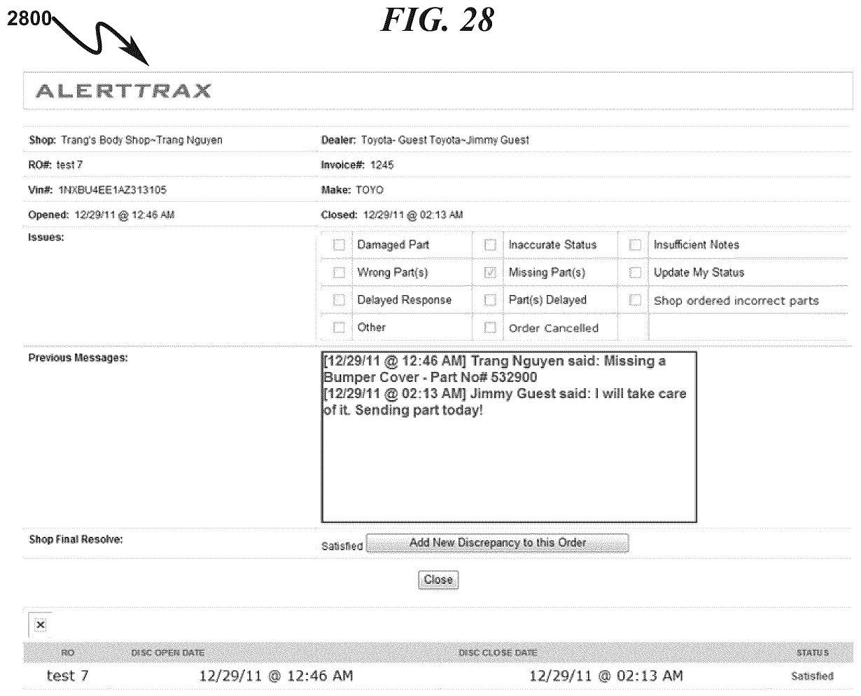

Functionality associated with customer/shop part/product order entry is generally illustrated in FIG. 25 (2500)-FIG. 28 (2800).

### Exemplary Order/Status Display (2600, 2700, 2800)

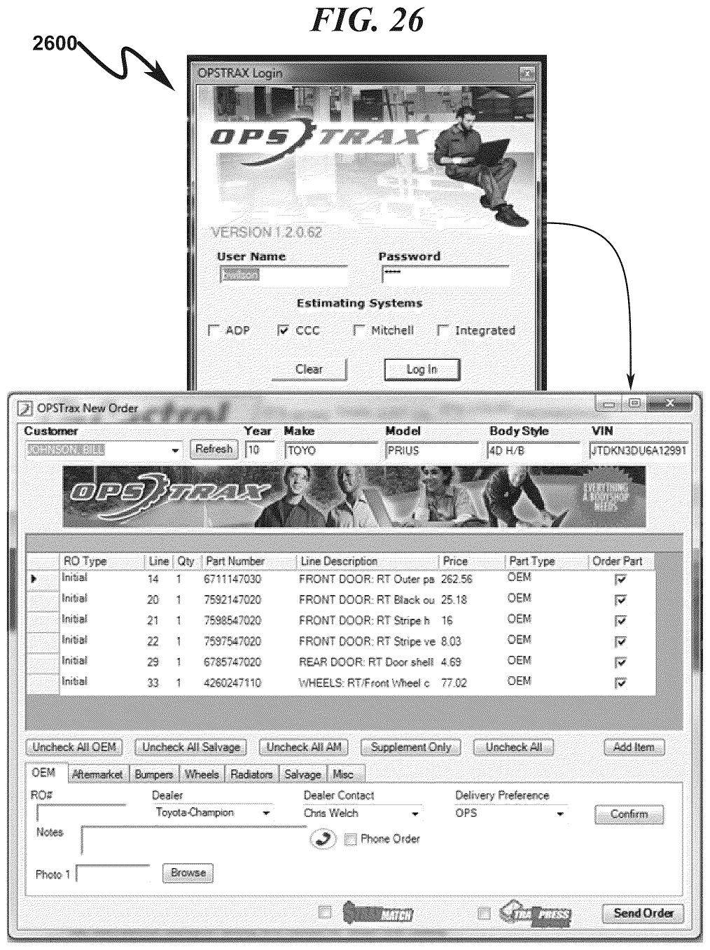

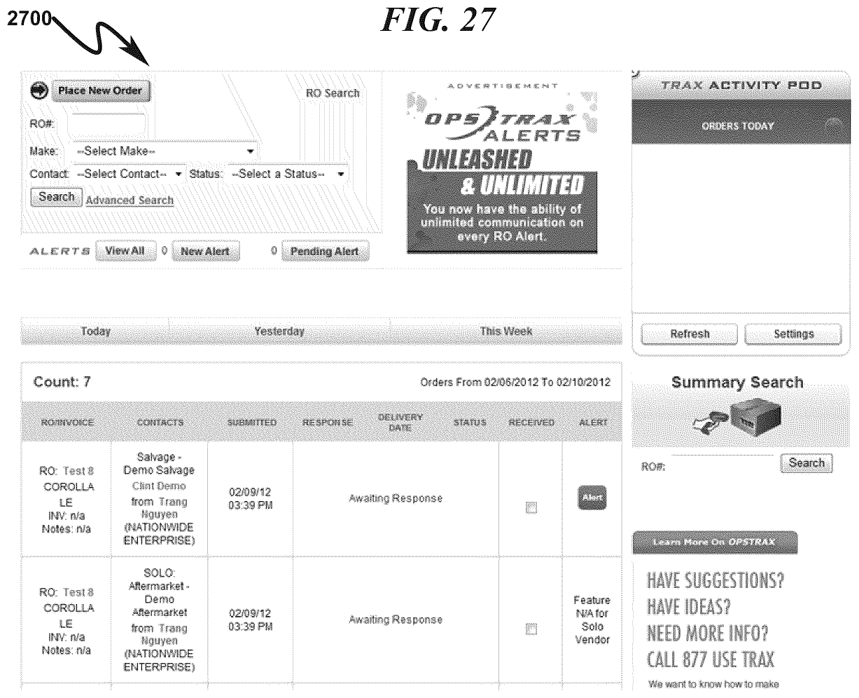

While the present invention may be implemented in a wide variety of configurations, some exemplary order/status displays associated with some preferred invention embodiments are generally illustrated in FIG. 26 (2600), FIG. 27 (2700), and FIG. 28 (2800).

FIG. 26 (2600) illustrates a general part/product ordering screen. This screen may be used to process order requests for a given part/product from a variety of vendors.

FIG. 27 (2700) illustrates a general part/product status display screen. This permits an integrated and sorted display of all pending and fulfilled part/product order requests such that the customer may have instant access to the pendency of order fulfillment requests and the estimated arrival time of the pending part/product.

FIG. 28 (2800) illustrates an alert message screen that may be utilized to send messages between a customer and vendor regarding specific details about a given part/product order request. This integrated instant messaging facility permits rapid communication between the customer and vendor to ensure that any issues surrounding parts delivery are solved in a rapid fashion.

### Shop Interface Order Forwarding (2900)-(3100)

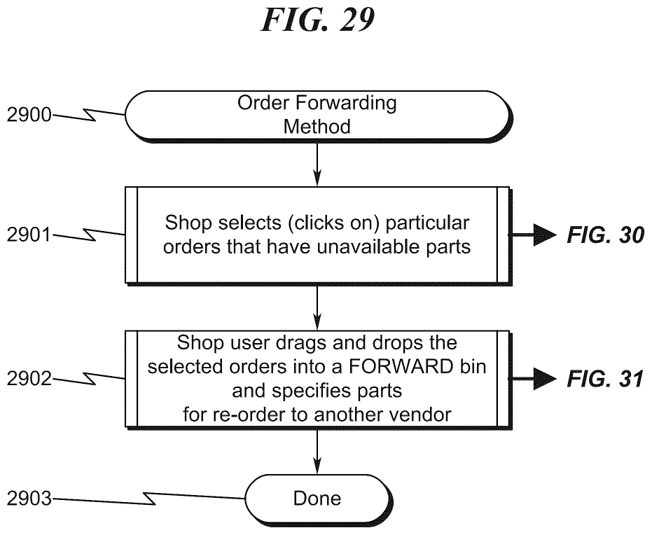

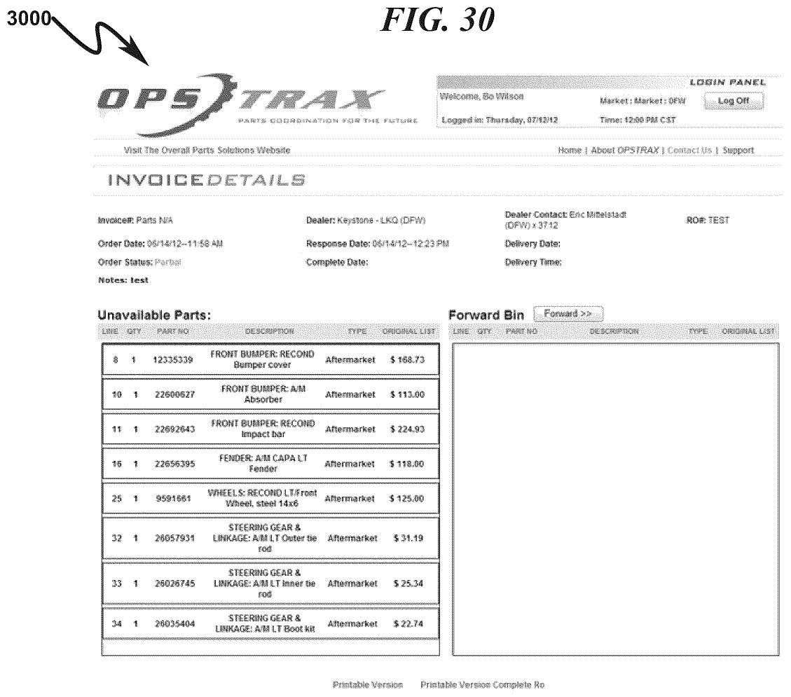

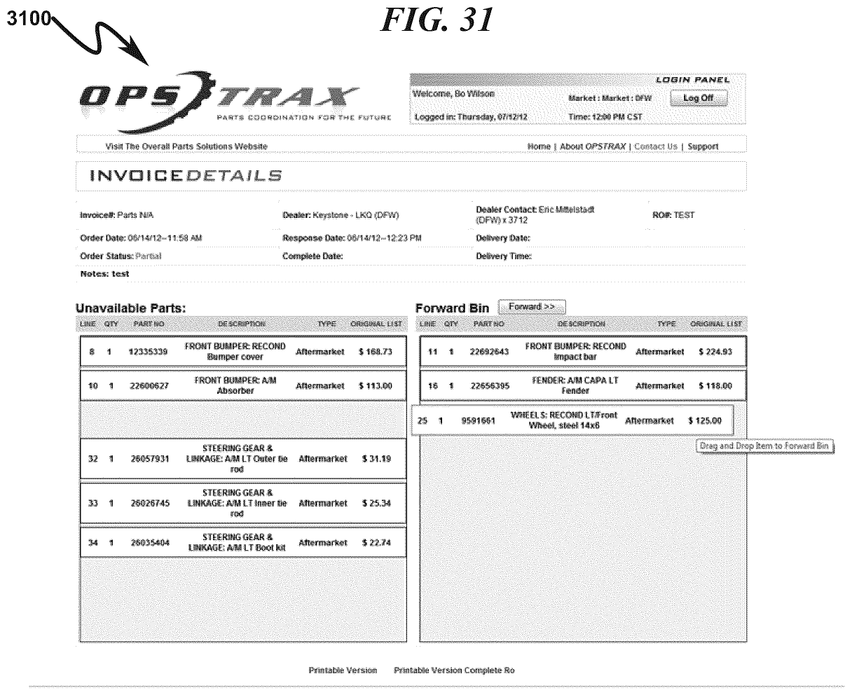

Functionality associated with customer/shop part/product order forwarding is generally illustrated in FIG. 29 (2900)-FIG. 31 (3100). This capability permits a customer/shop to forward a particular order to an alternate vendor in an attempt to fulfill an order that cannot be accommodated by a primary parts/products vendor supplier.

### Shop Interface Status Display (3200)-(3400)

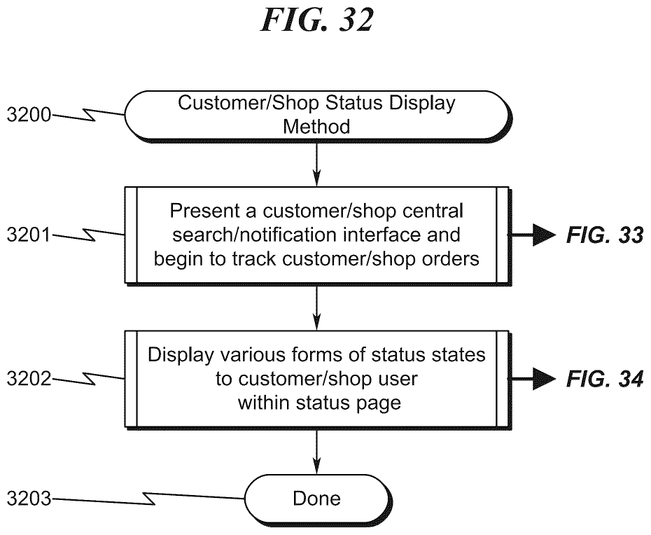

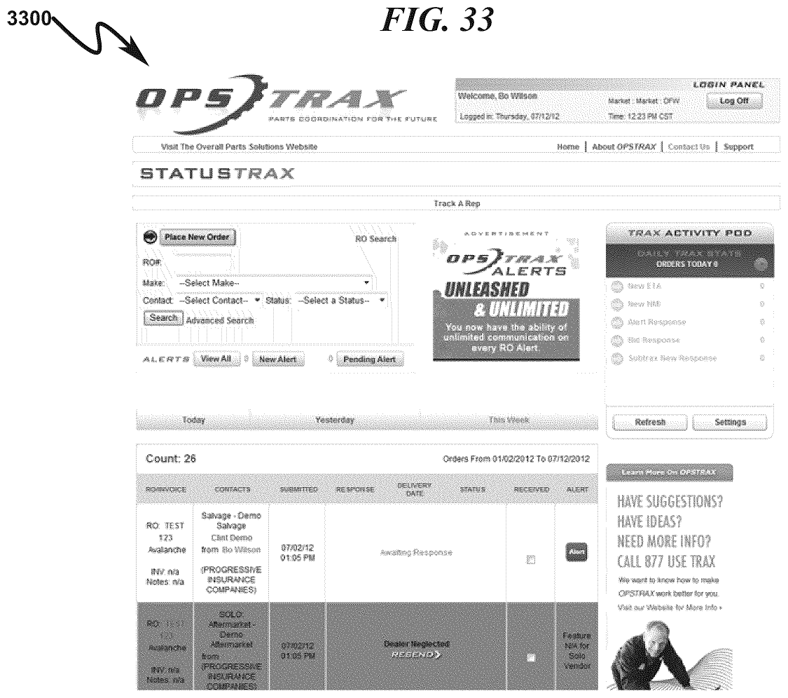

Functionality associated with customer/shop part/product status display is generally illustrated in FIG. 32 (3200)-FIG. 34 (3400). Generally speaking, these status displays permit real-time display of all part/product orders, vendor quotes, and scheduled delivery times.

### Dealer Interface Order Request Answering (3500)-(4000)

Functionality associated with dealer part/product order request answering is generally illustrated in FIG. 35 (3500)-FIG. 40 (4000).

### Quote Management Method (4100)-(5400)

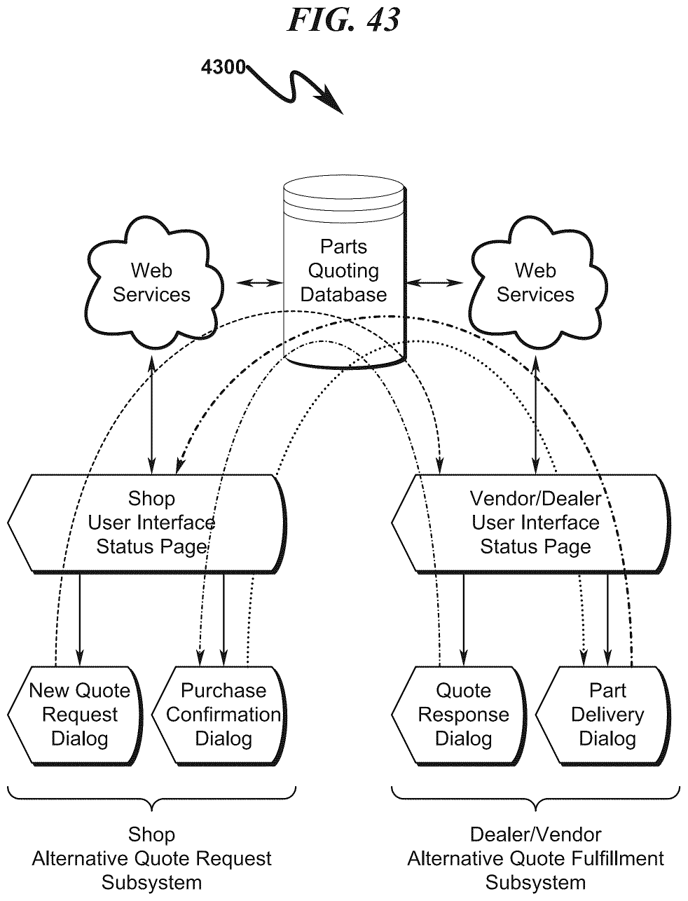

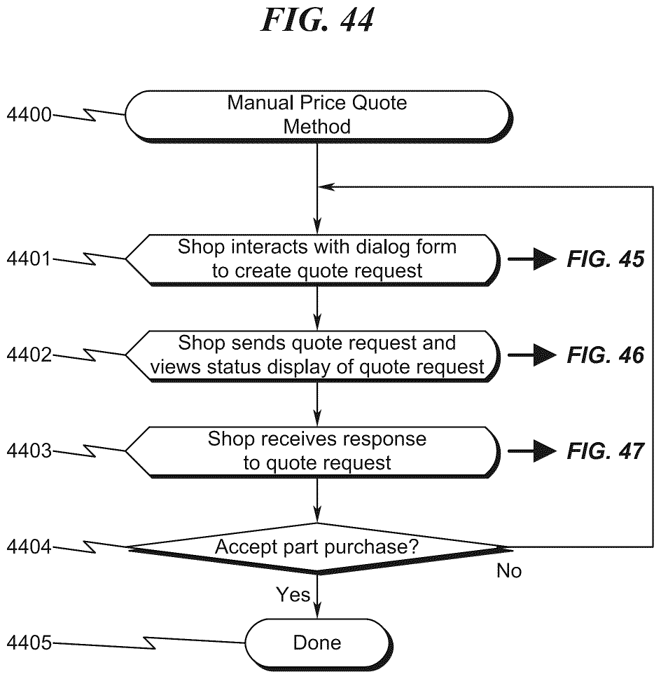

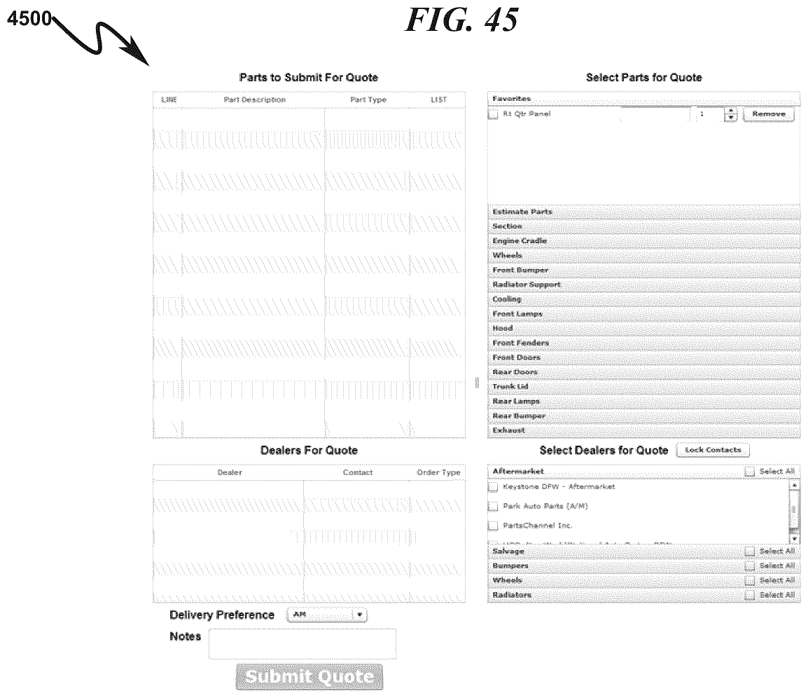

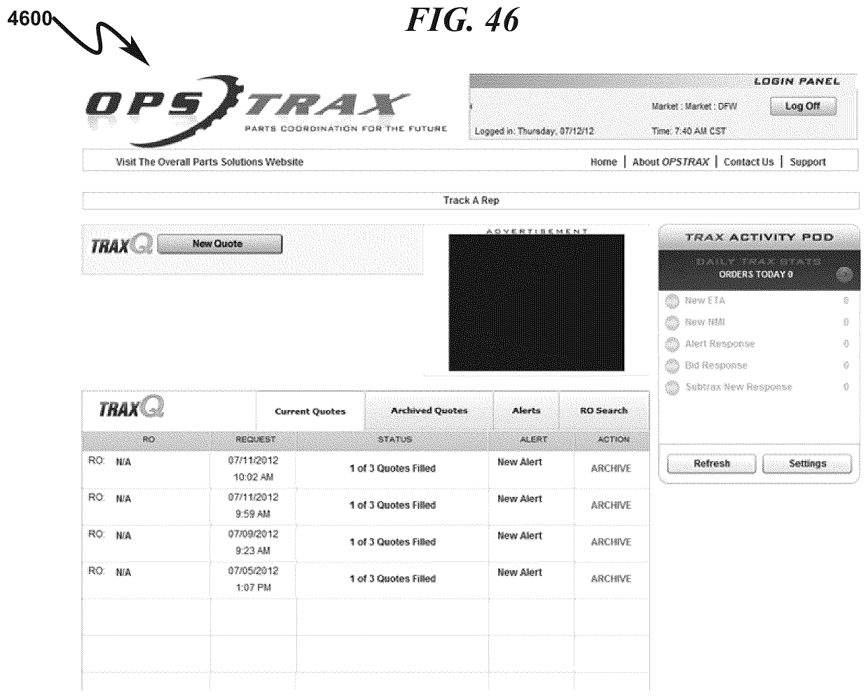

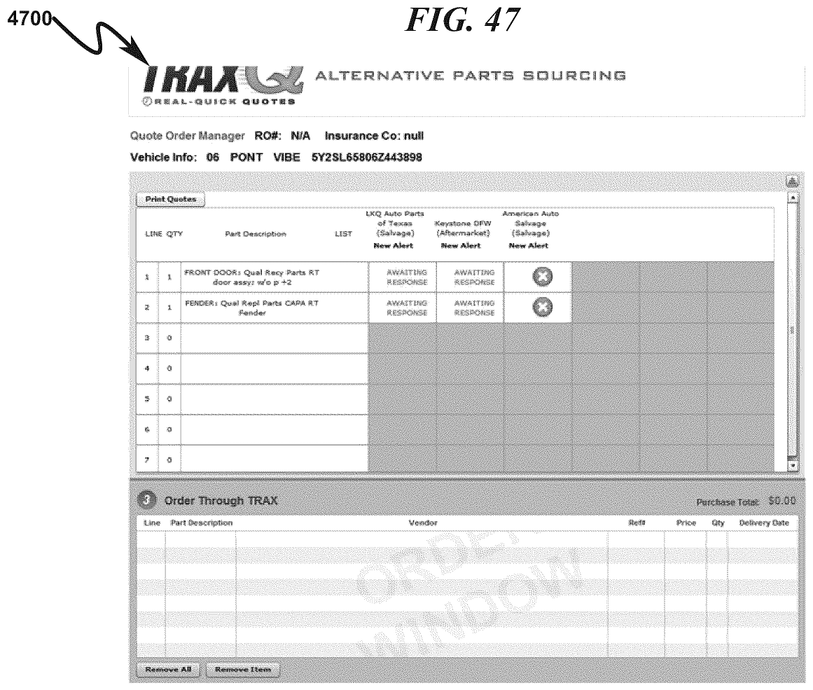

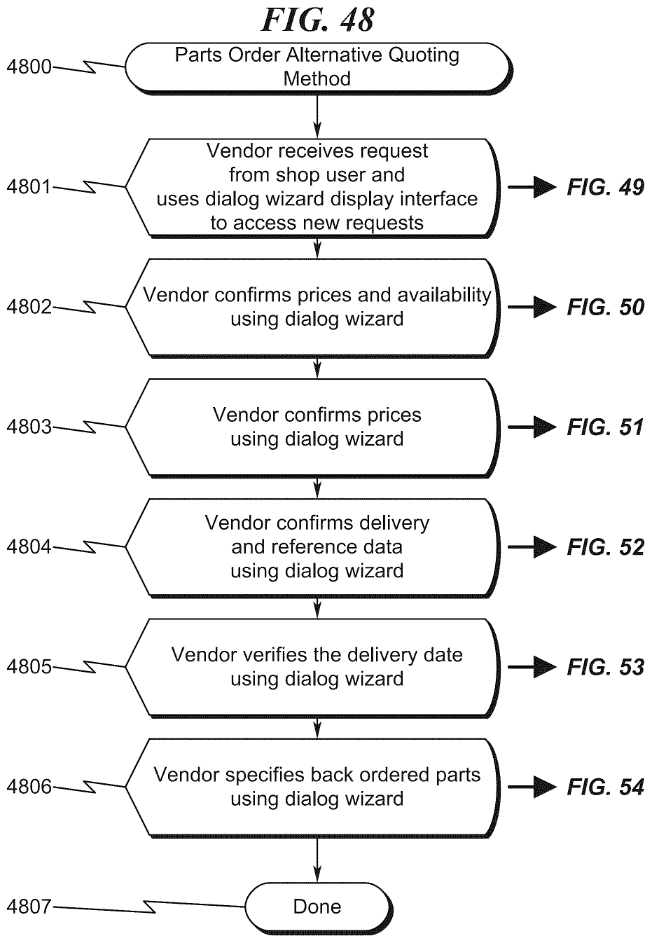

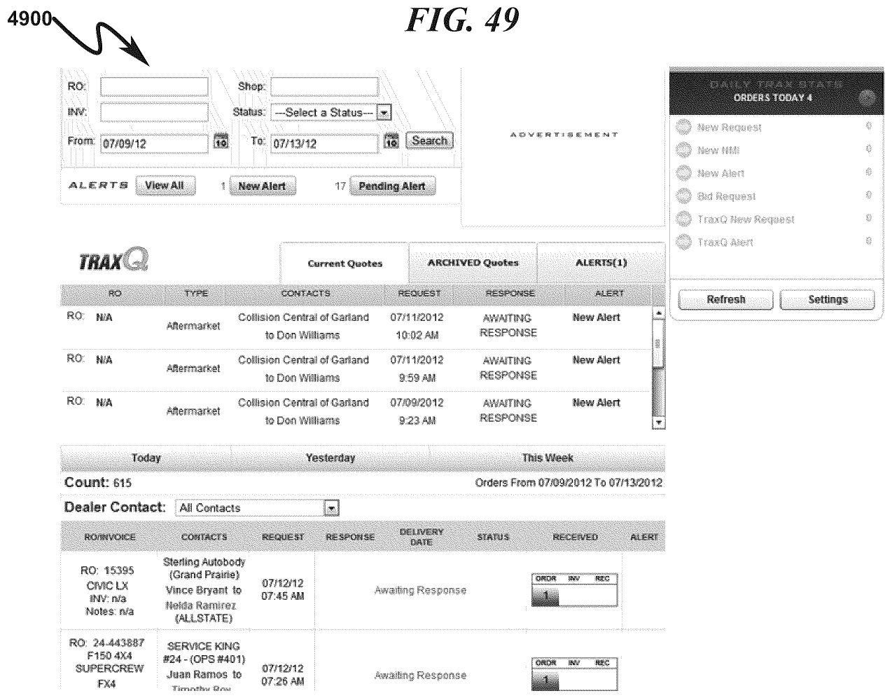

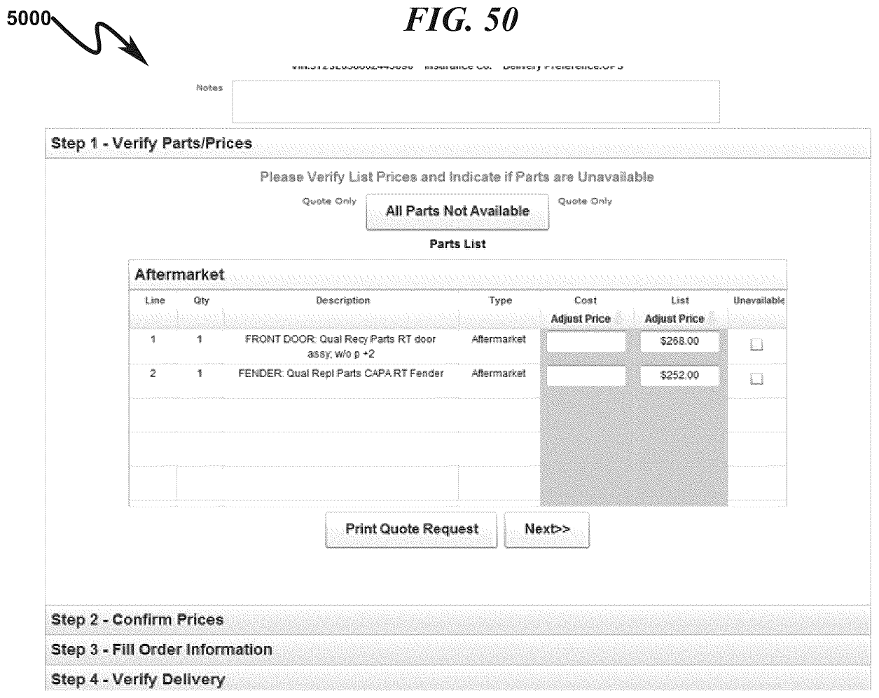

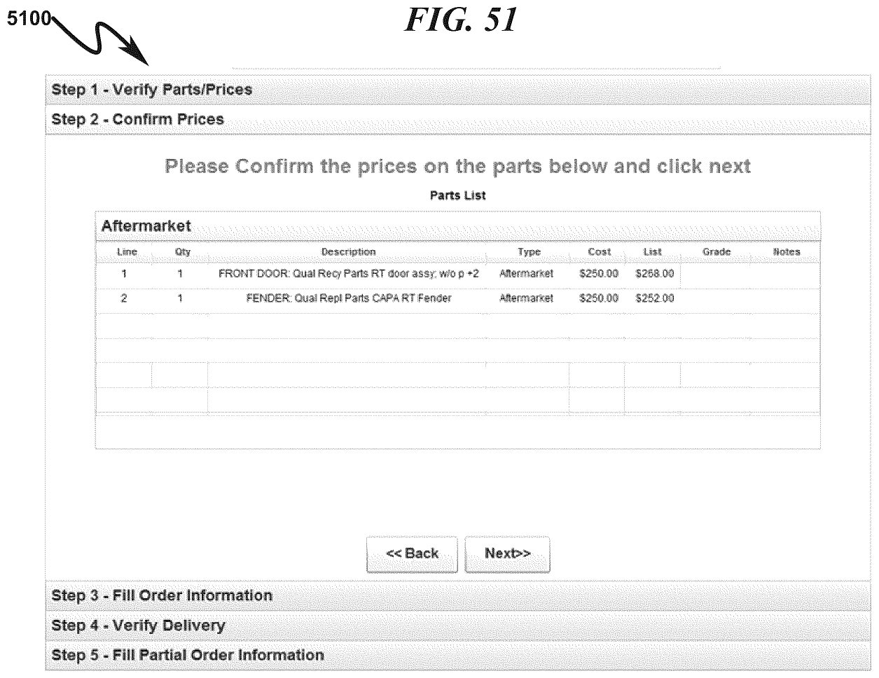

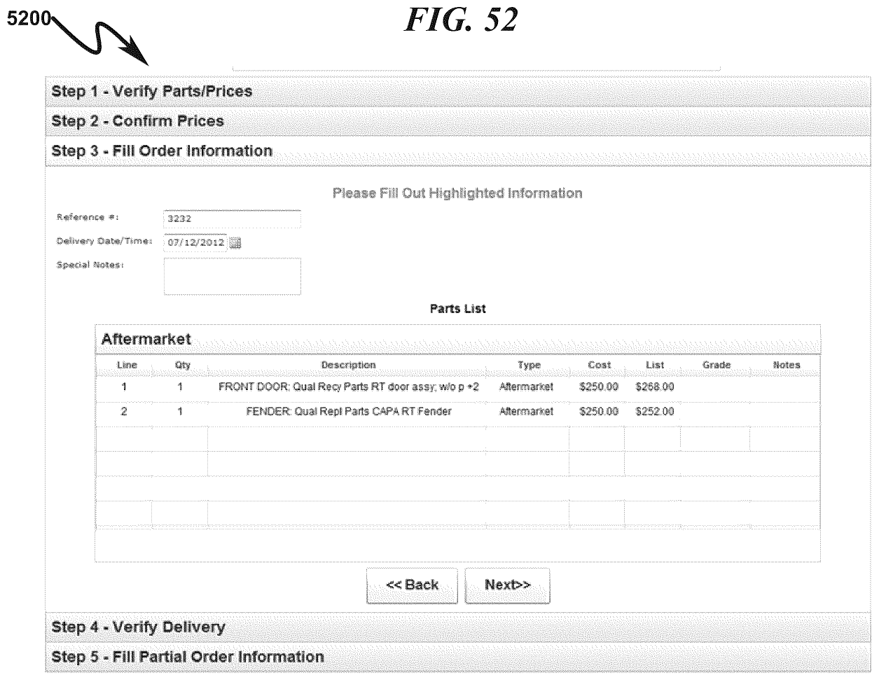

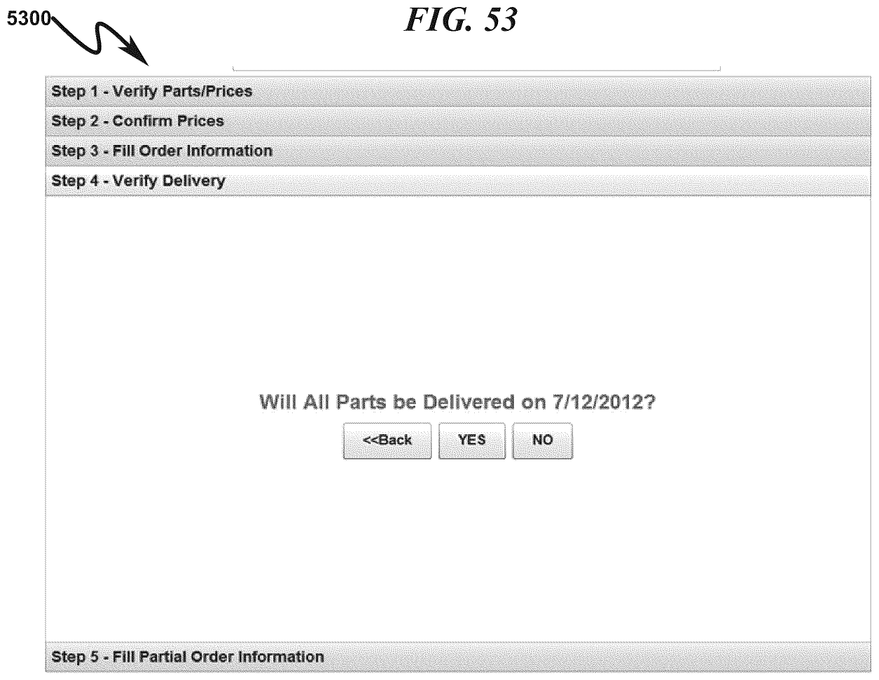

As generally illustrated in FIG. 41 (4100), the quote management method may be described in terms of a workflow (4110) (FIG. 43 (4300)), shop interface (4120) (FIG. 44 (4400)-FIG. 47 (4700)), and dealer interface (4130) (FIG. 48 (4800)-FIG. 54 (5400)).

### Alternative Parts Quoting Method (4200)

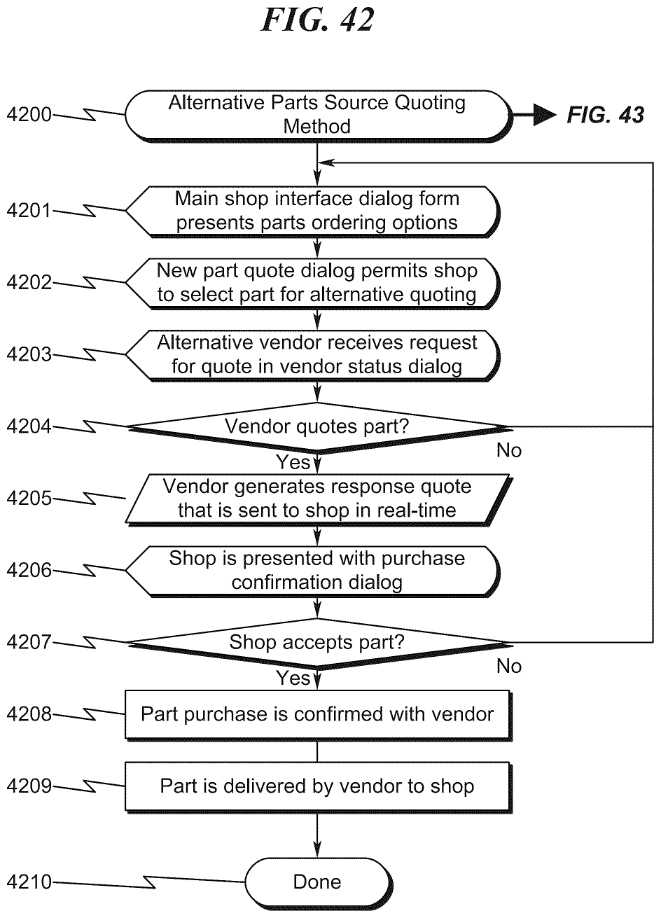

Generally speaking a shop/customer will place a request for quote for a part/product from one or more vendors and if this part/product request for quote cannot be satisfied from a particular vendor, then an alternative methodology may be implemented as generally illustrated in FIG. 42 (4200) to select an alternate vendor for part/product sourcing.

### Workflow (4300)

As generally illustrated in FIG. 43 (4300), data flows from a new quote request dialog through the shop user interface to the vendor/dealer interface in which a quote response dialog confirms a part/product order which then triggers a purchase confirmation dialog that eventually results in a part/product delivery dialog triggering a part/product shipment notice to the shop user interface. All of these transmissions may utilize web services in conjunction with a parts quoting database to accomplish this functionality in a distributed computer network environment.

### Shop Interface (4400)-(4700)

The shop interface associated with a manual price quote request system is generally illustrated in FIG. 44 (4400)-FIG. 47 (4700).

### Dealer Interface (4700)-(5400)

The corresponding dealer interface associated with the shop manual price quote request system is generally illustrated in FIG. 47 (4700)-FIG. 54 (5400).

### Advertising/Claims Management Method (5500)-(8400)

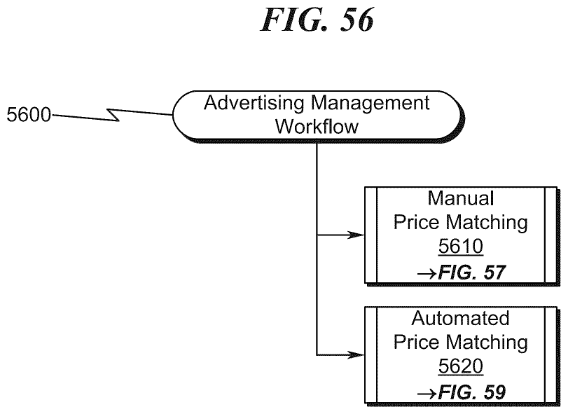

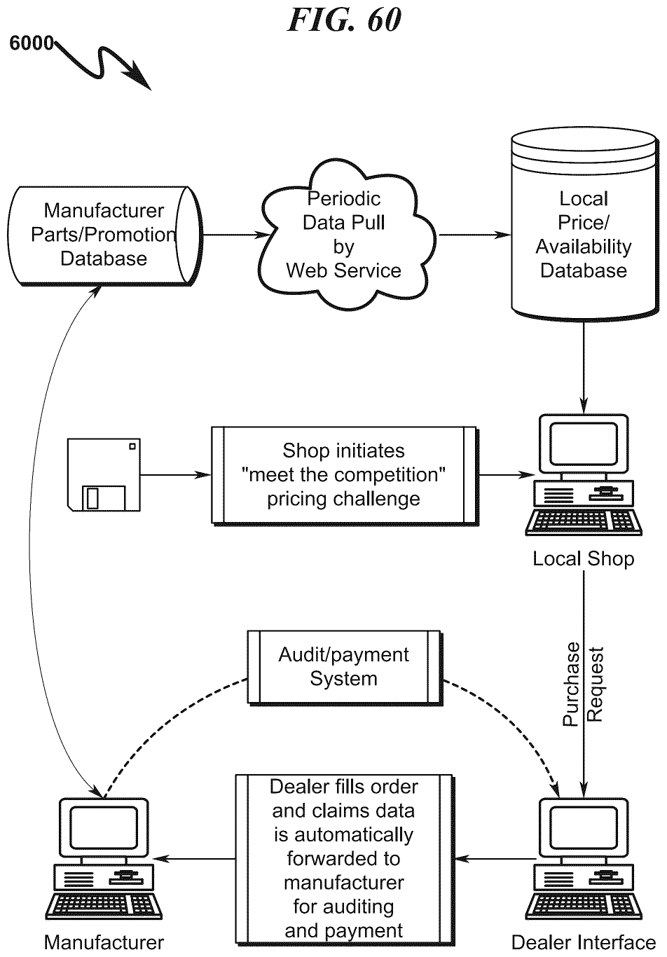

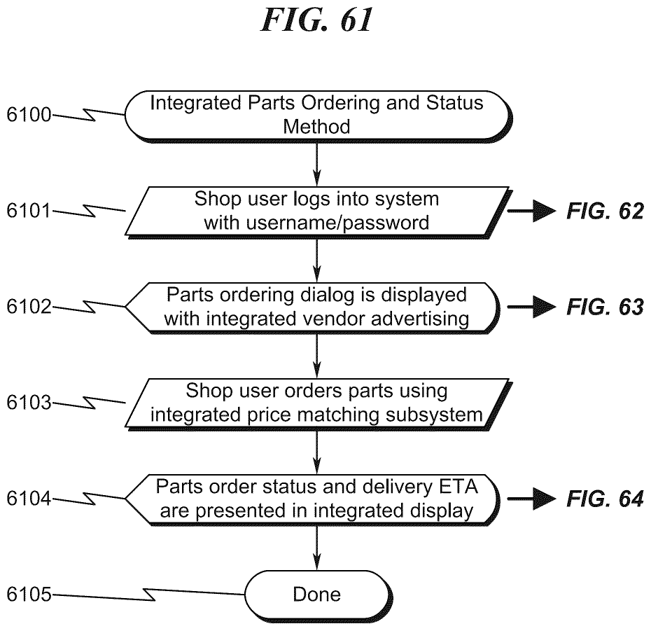

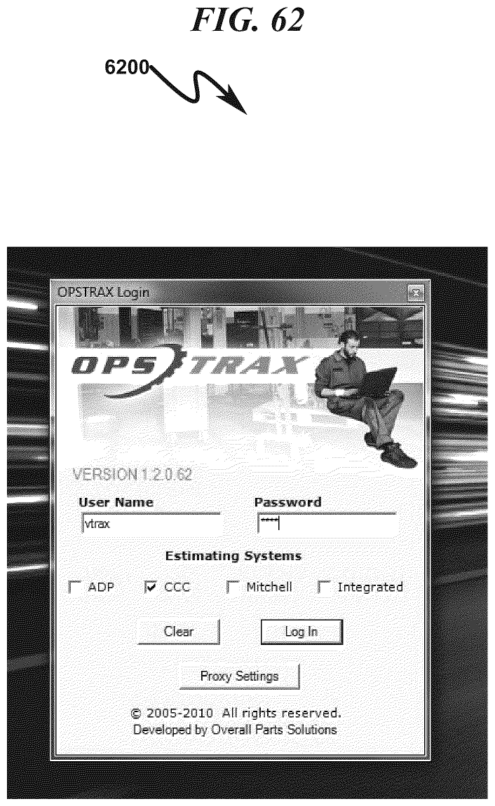

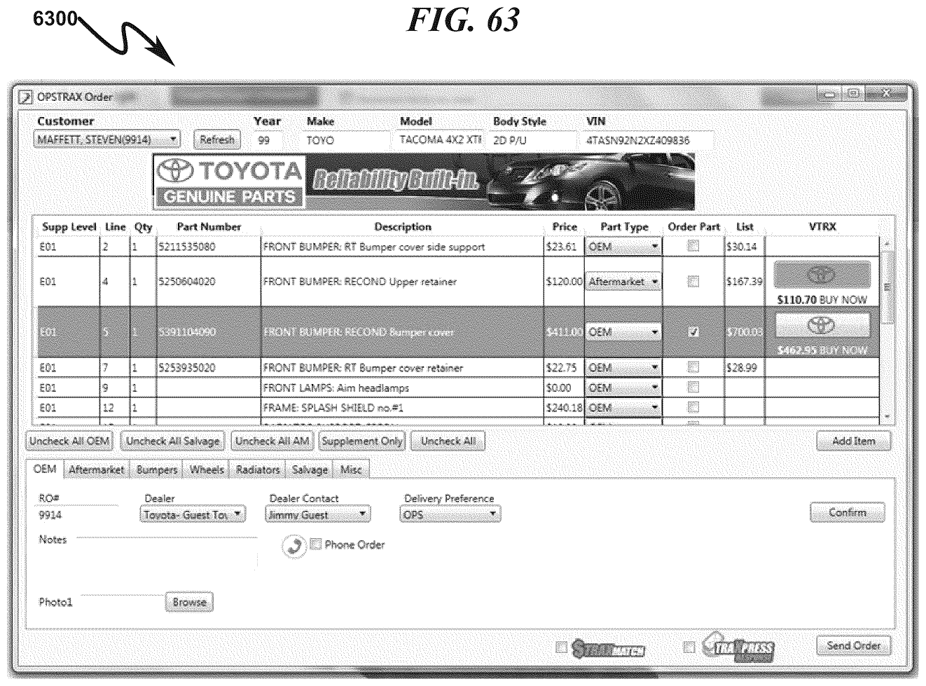

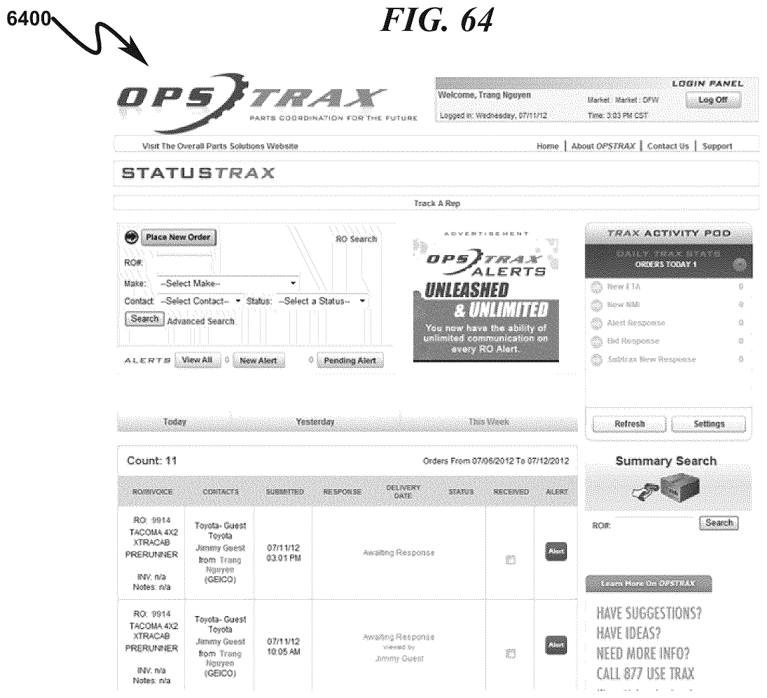

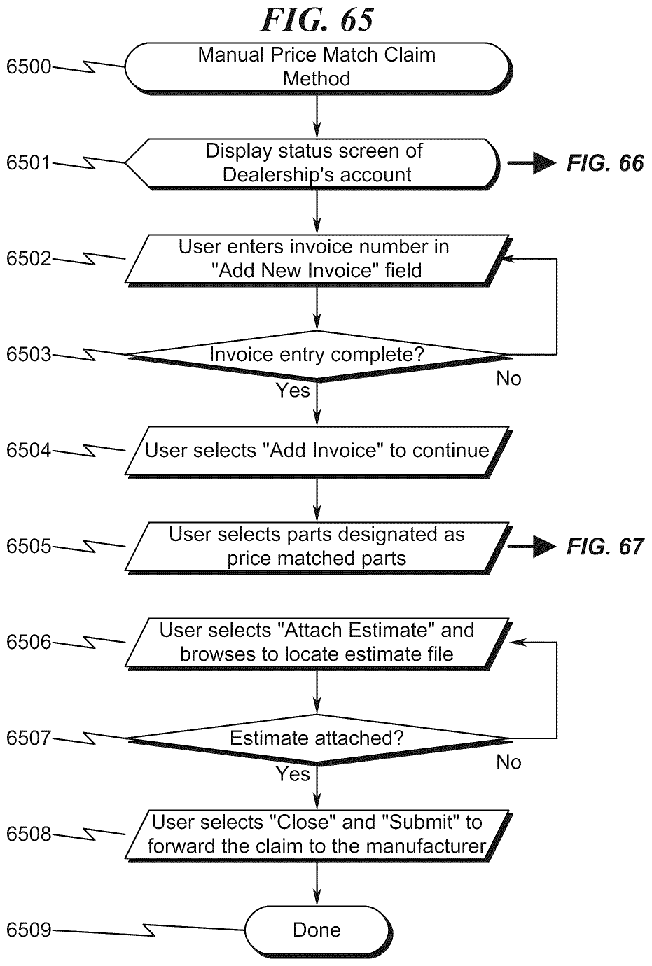

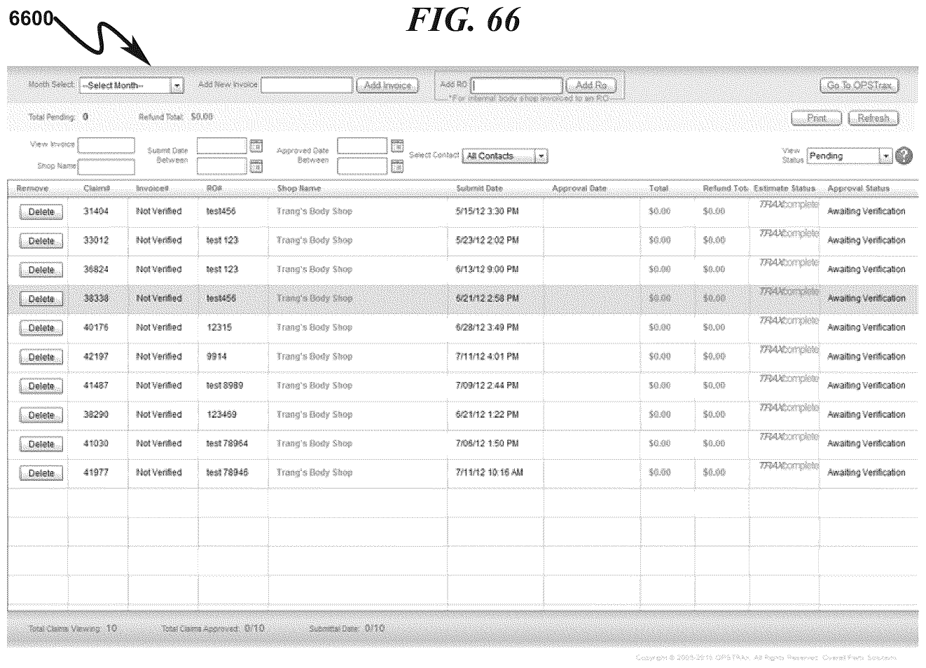

As generally illustrated in FIG. 55 (5500), the advertising/claims management method may be described in terms of a workflow (5510) (FIG. 56 (5600)-FIG. 60 (6000)), shop interface (5520) (FIG. 61 (6100)-FIG. 64 (6400)), and dealer interface (5530) (FIG. 65 (6500)-FIG. 84 (8400)).

### Workflow (5600)-(6000)

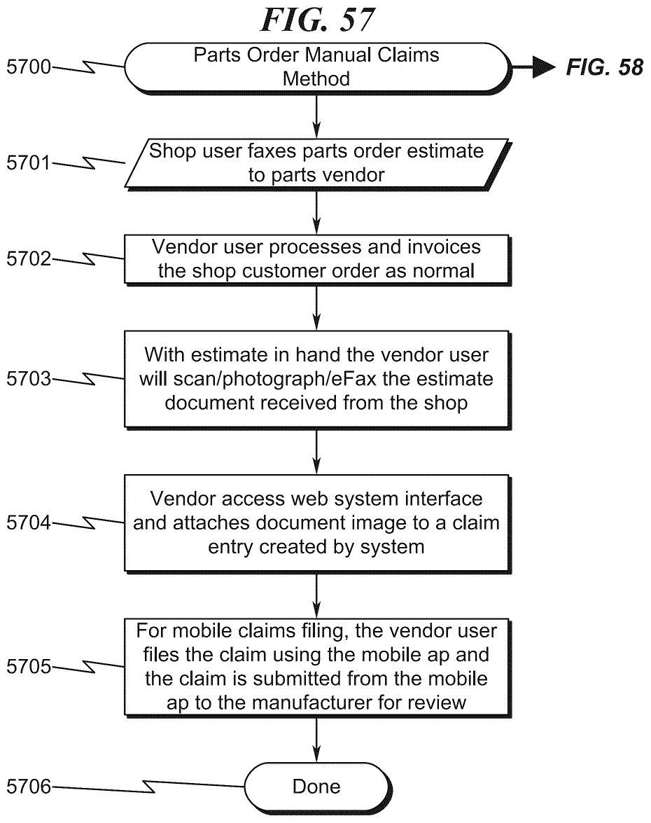

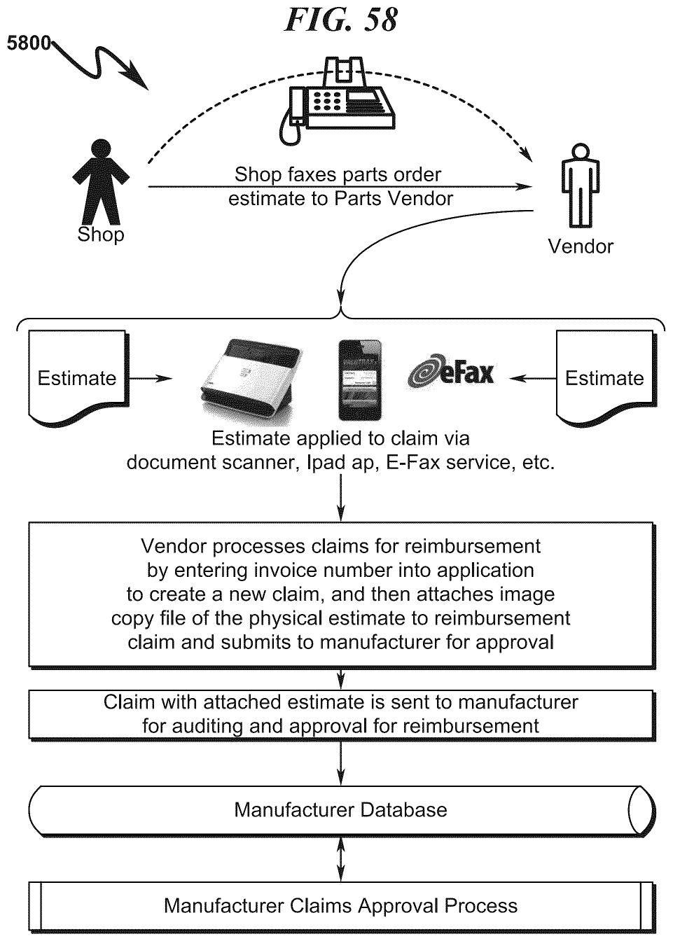

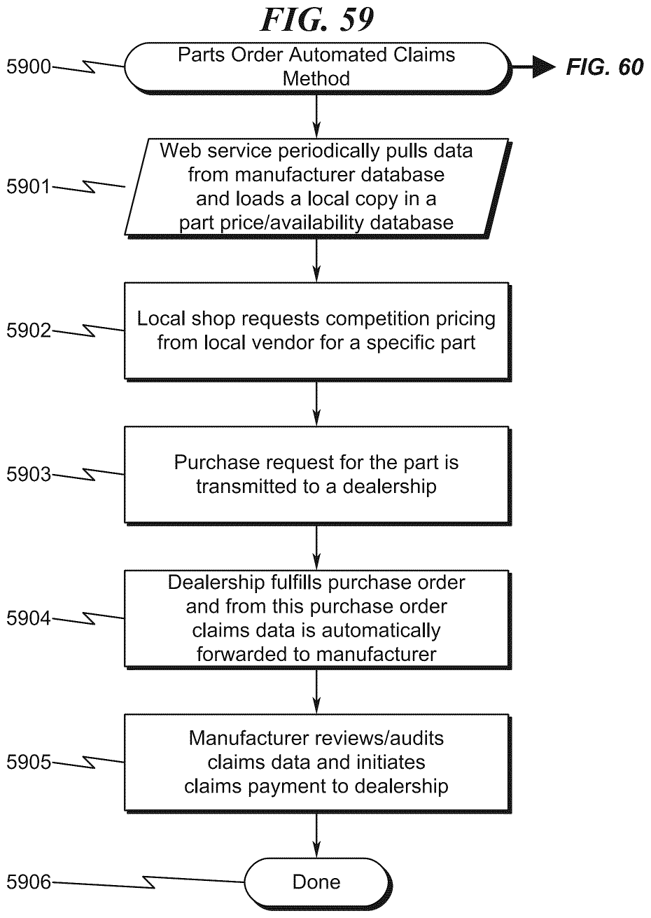

As generally illustrated in FIG. 56 (5600) the workflow for advertising/claims management can be bifurcated into manual price matching (5610) (FIG. 57 (5700)-FIG. 58 (5800)) and automated price matching (5620) (FIG. 59 (5900)-FIG. 60 (6000)).

The manual price matching (5610) methodology digitizes the customer estimate and uses this as the basis for claims processing by the vendor as generally explained in FIG. 57 (5700) and depicted in FIG. 58 (5800). The automated price matching (5620) methodology periodically queries the manufacturer for incentives/promotions and pushes this information down to the customer/shop level at which point a competitive parts price order can be requested. As generally detailed in FIG. 59 (5900) and depicted in FIG. 60 (6000), acceptance of the price by the customer automatically forwards necessary information to the manufacturer to support a vendor claim for the particular part/product incentive/promotion once customer chooses to purchase parts.

### Shop Interface (6100)-(6400)

The shop interface associated with the advertising/claims management system is generally illustrated in FIG. 61 (6100)-FIG. 64 (6400).

### Dealer Interface (6500)-(8400)

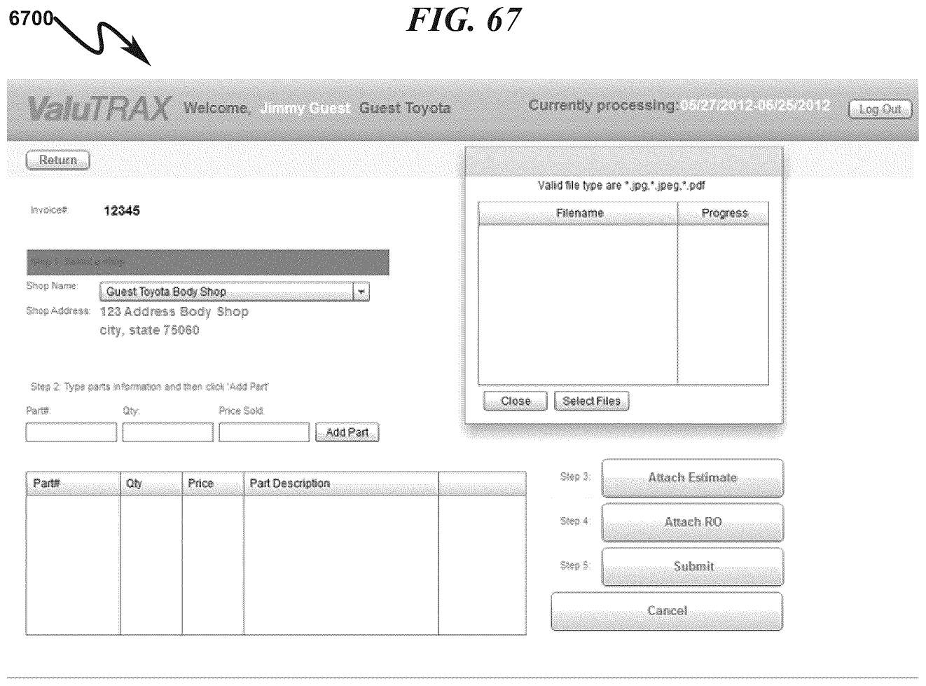

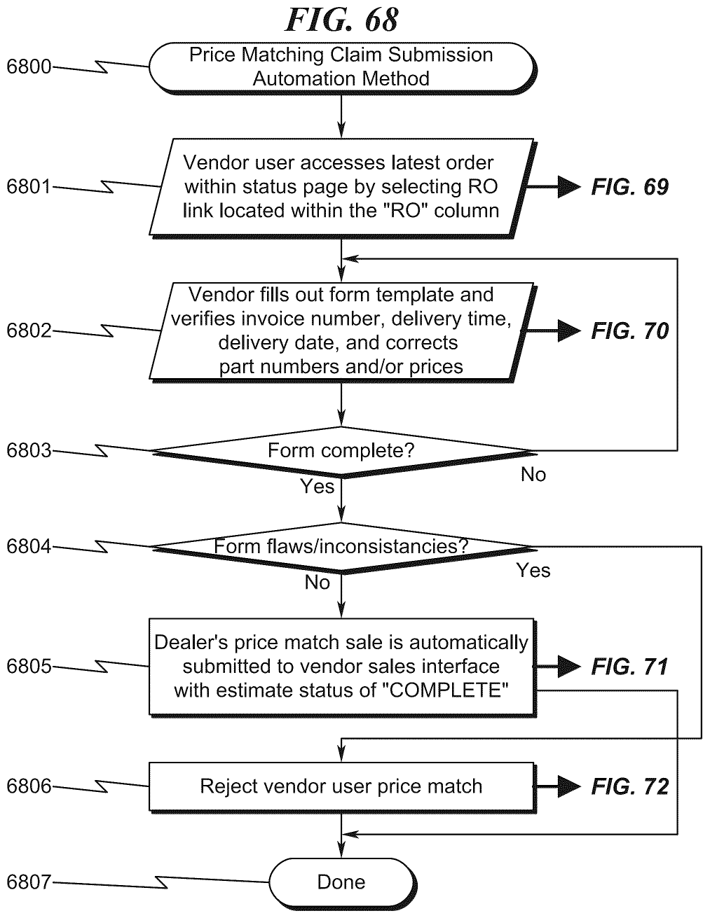

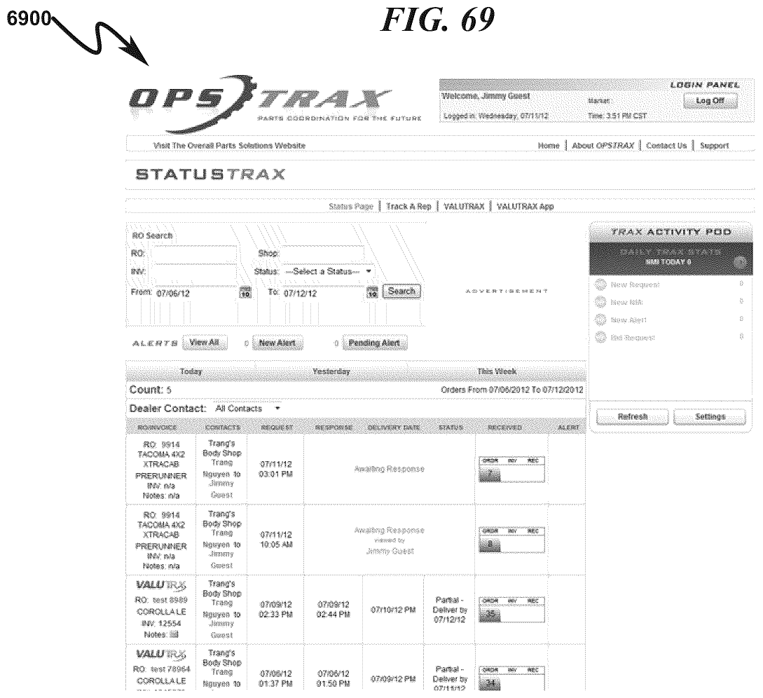

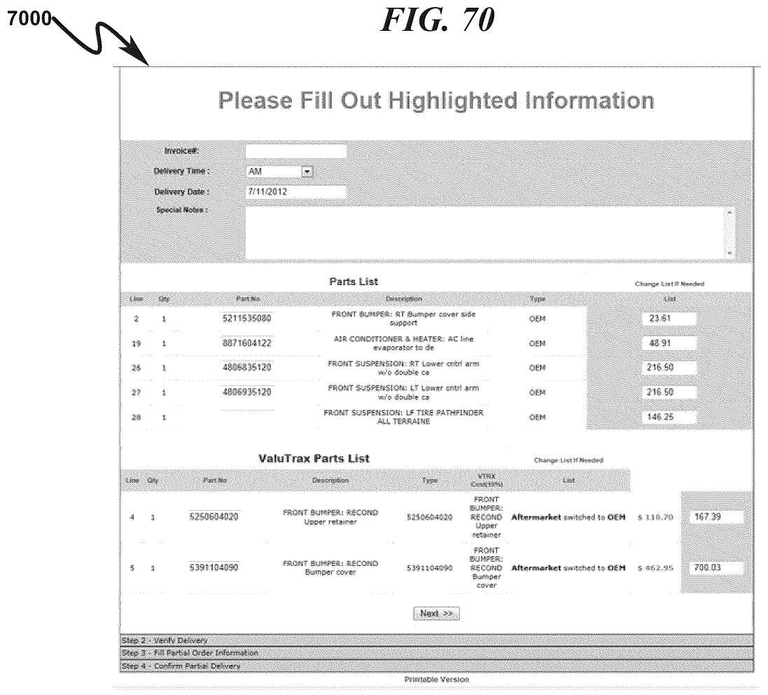

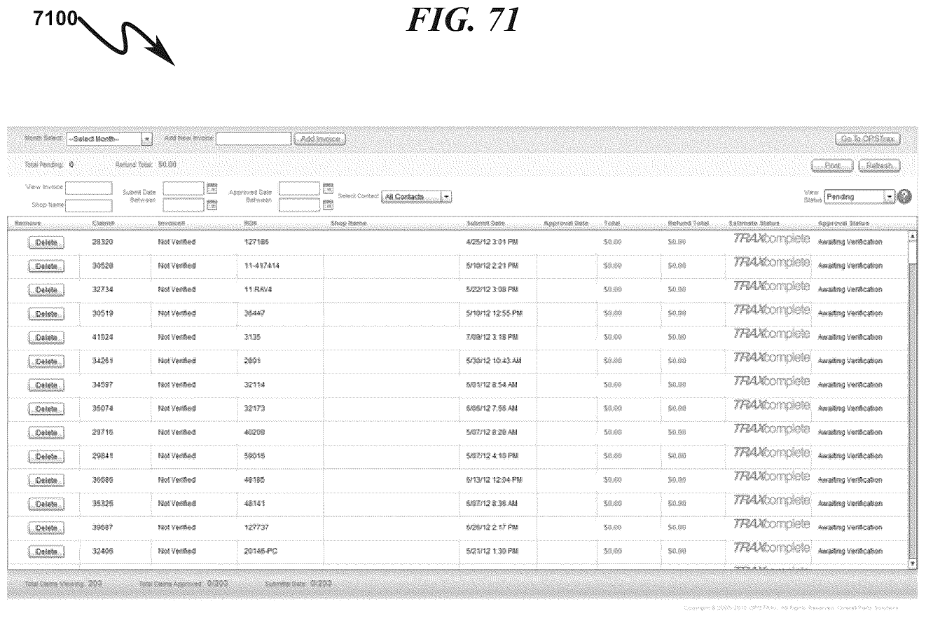

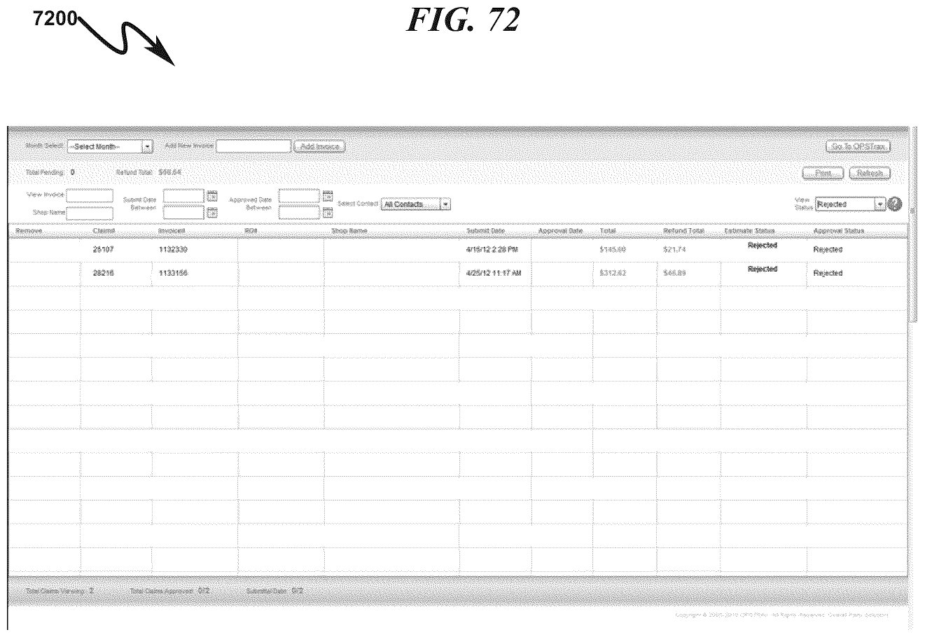

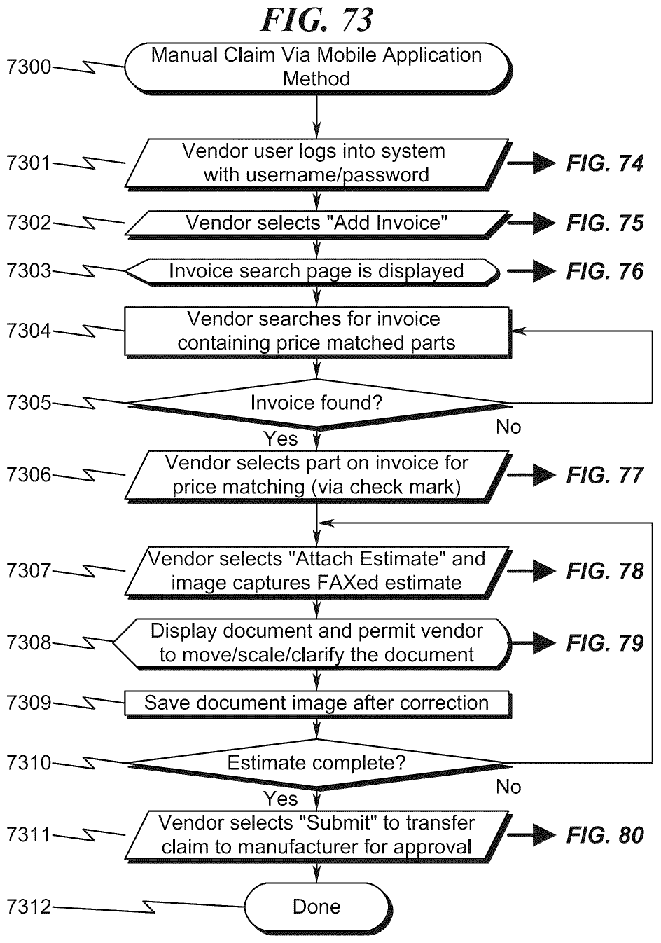

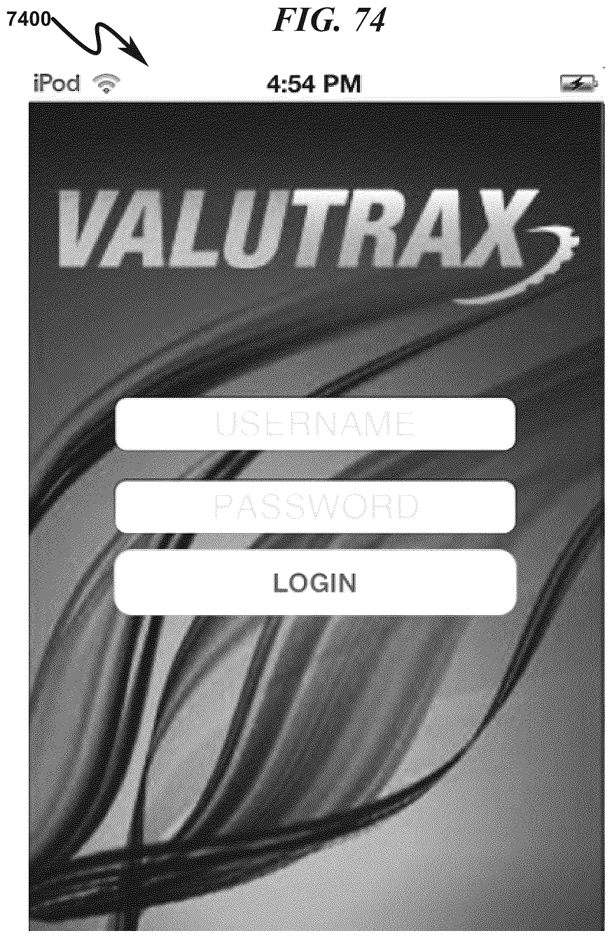

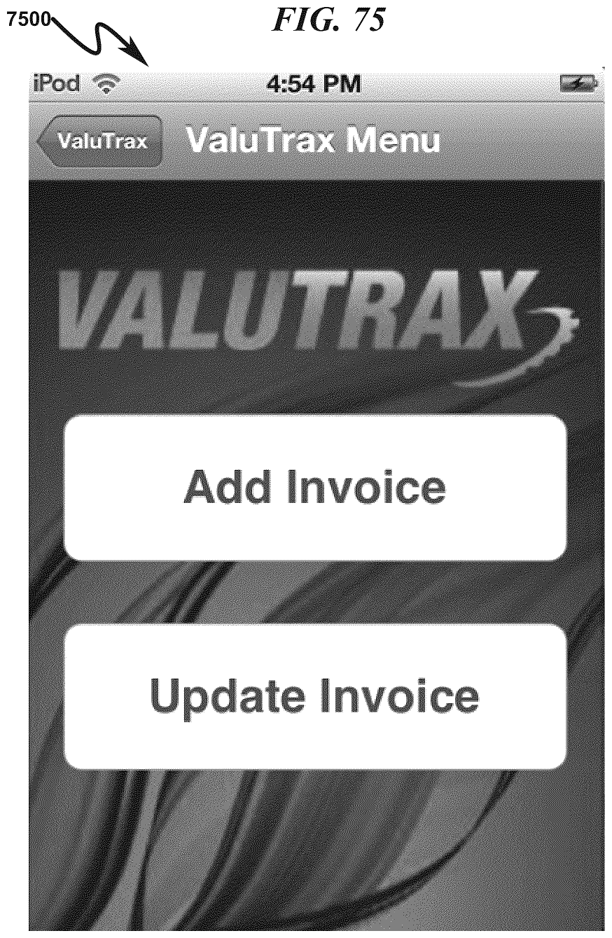

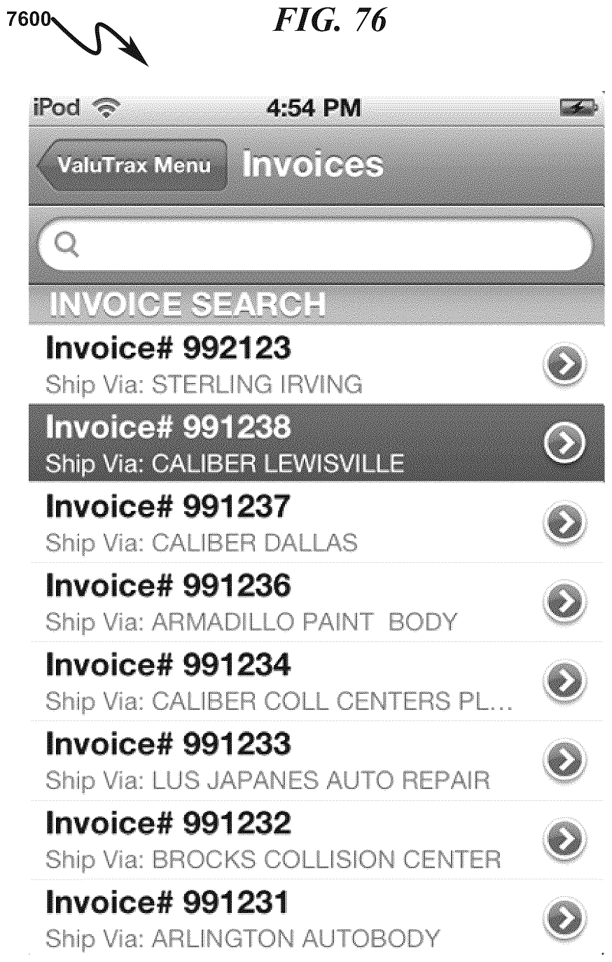

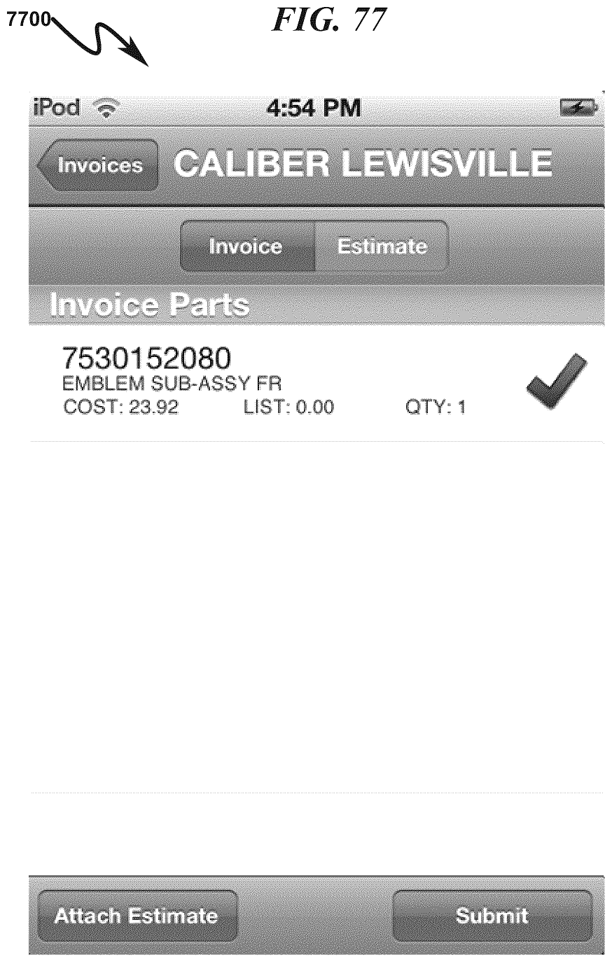

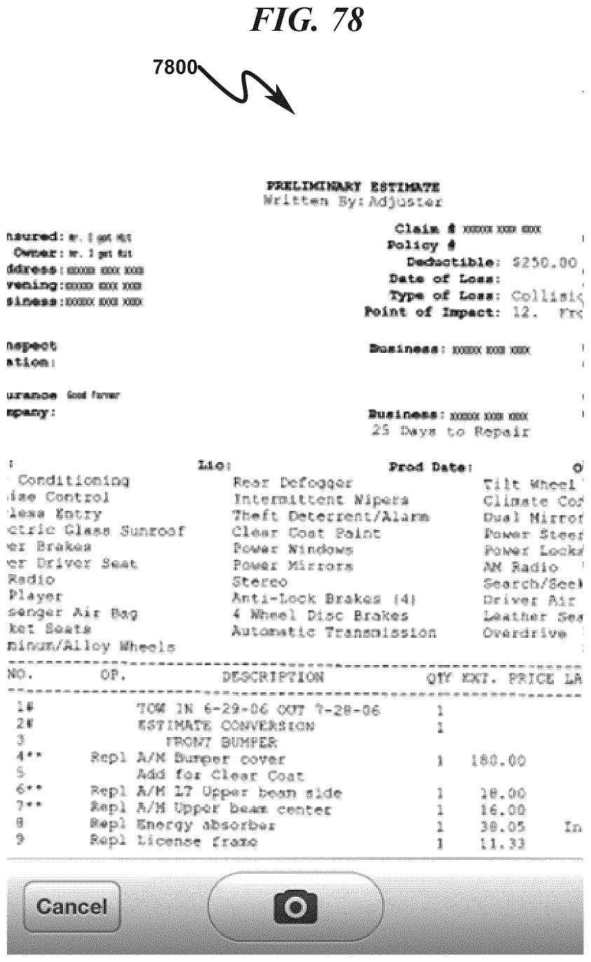

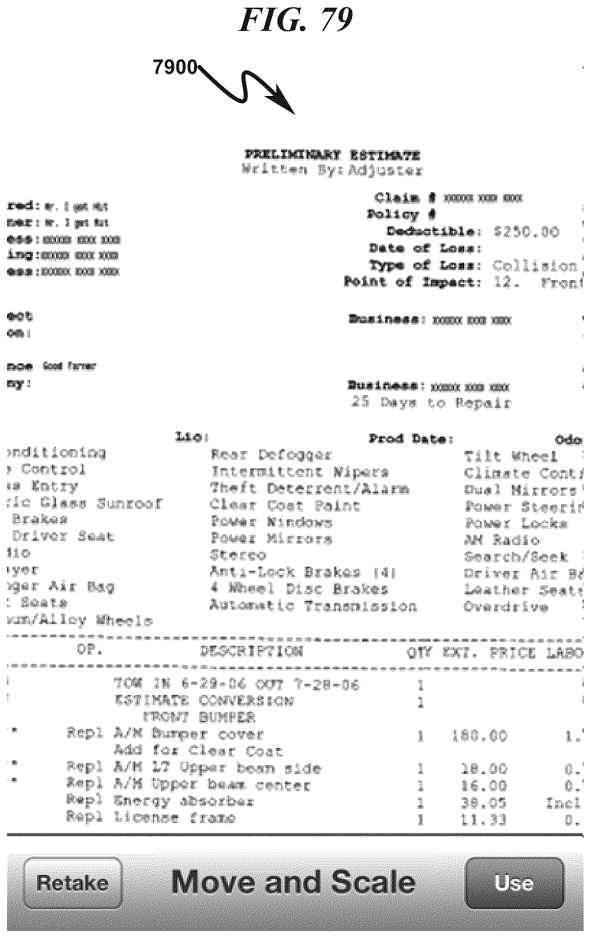

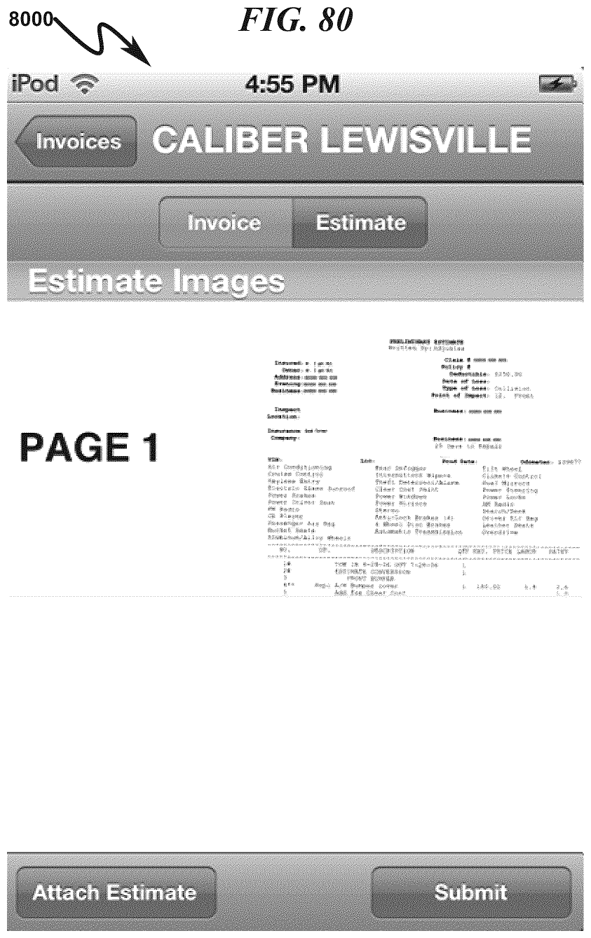

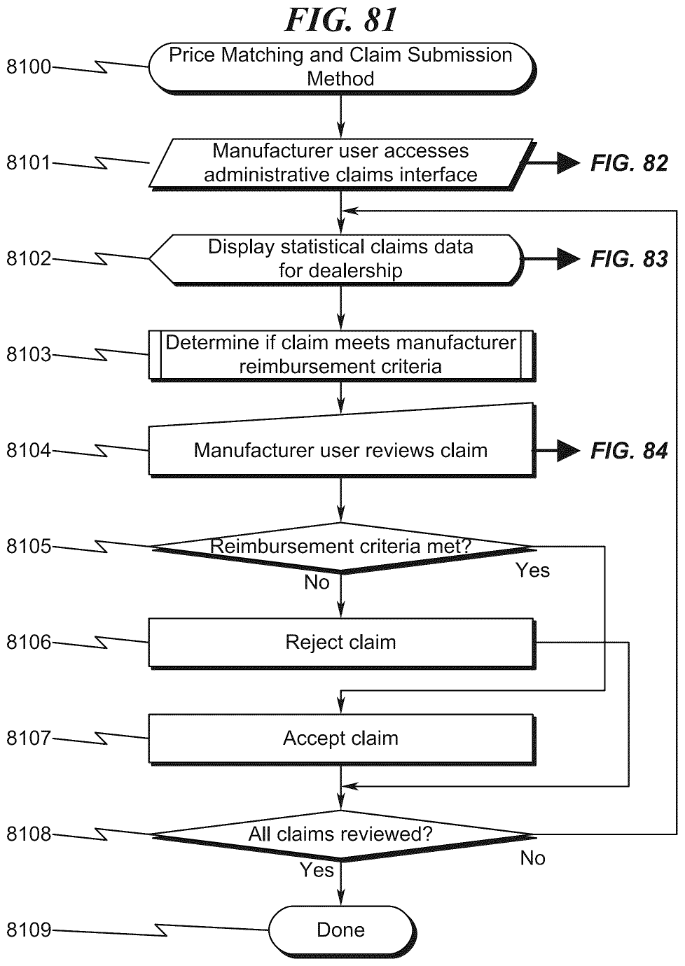

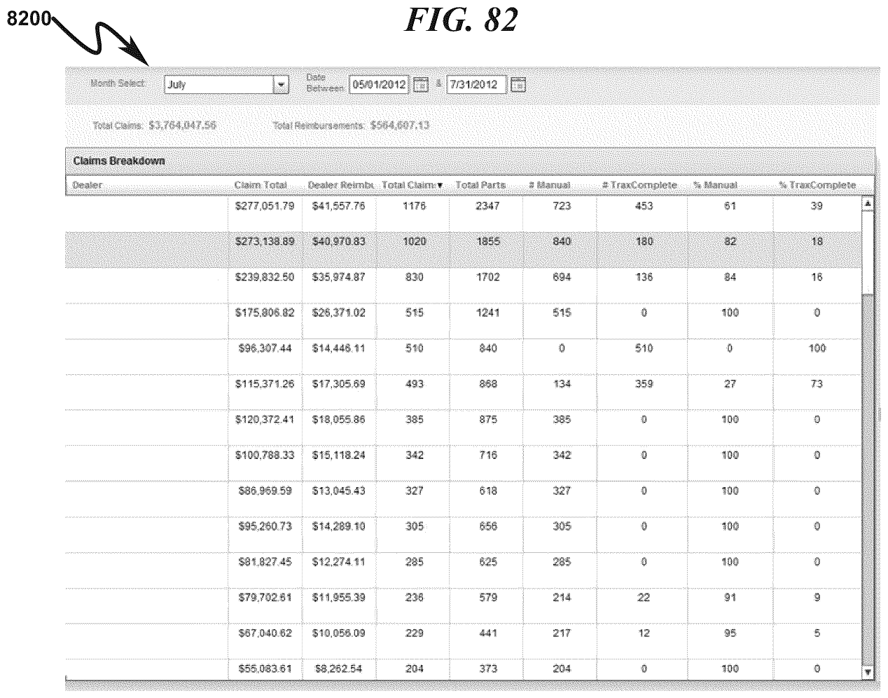

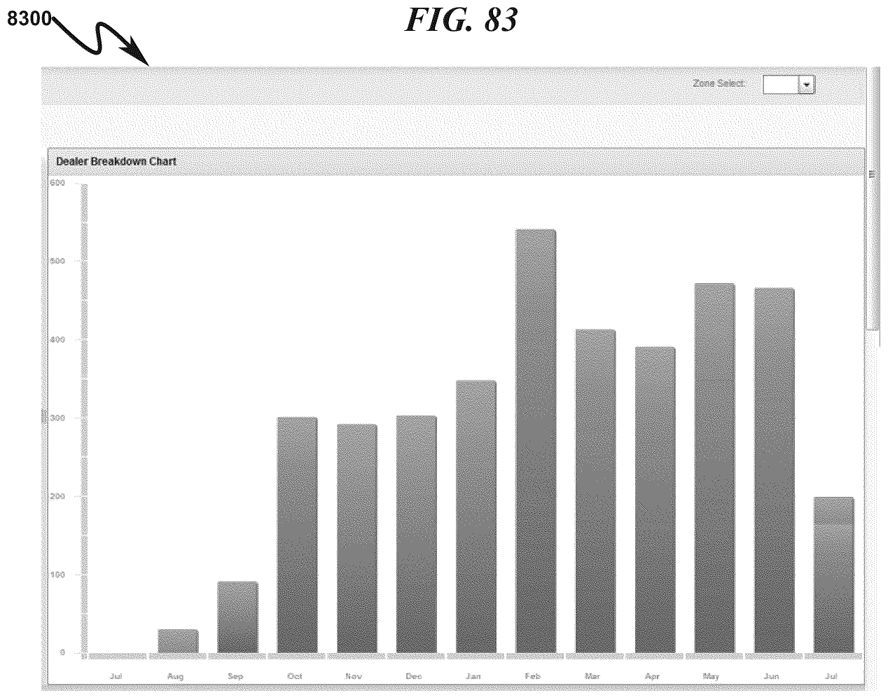

The corresponding dealer interface associated with the advertising/claims management system is generally illustrated in FIG. 65 (6500)-FIG. 84 (8400). This general dealer interface may be subdivided in some embodiments to include the following subsystems:
Manual price match (FIG. 65 (6500)-FIG. 67 (6700)) depicts a scenario where the dealership manually processes manufacturer incentive/promotion claims using individual customer invoices.
Automated price match (FIG. 68 (6800)-FIG. 72 (7200)) depicts a scenario where the dealership automatically processes manufacturer incentive/promotion claims using forms associated with customer RO links.
Mobile price match (FIG. 73 (7300)-FIG. 80 (8000)) depicts a scenario where the dealership processes manufacturer incentive/promotion claims using a mobile phone/smartphone/computer tablet user interface.
Price match administration (FIG. 81 (8100)-FIG. 84 (8400)) depicts a manufacturer claims interface that permits manufacturers to accept/reject/audit/trend claims submitted by vendors and generally provide claims administration capabilities for a wide variety of manufacturer part/product incentives/promotions.
   As can be seen from this example, the price match advertising and manufacturer claims management functions have been integrated within a singular dealer interface in this example.

### Delivery Management Method (8500)-(11200)

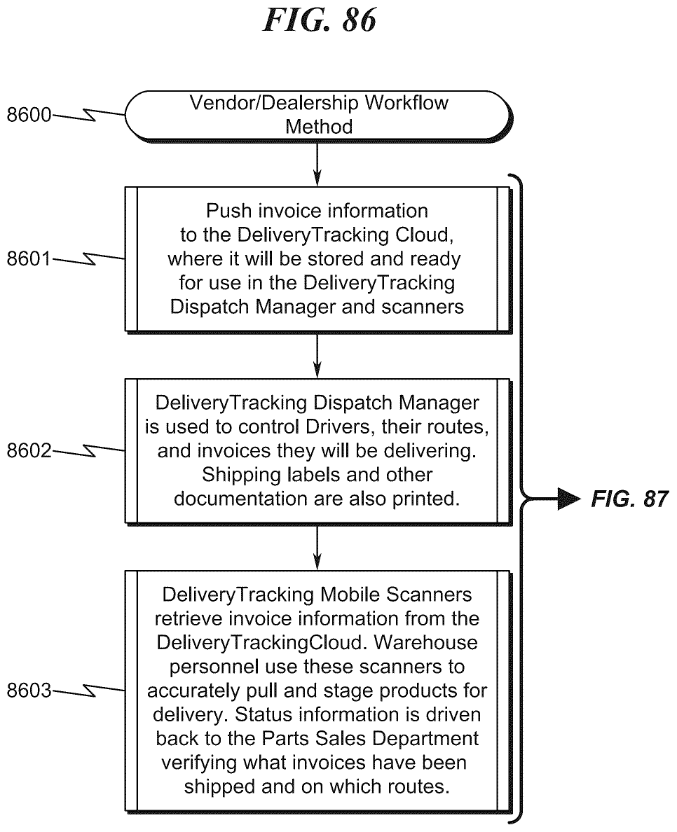

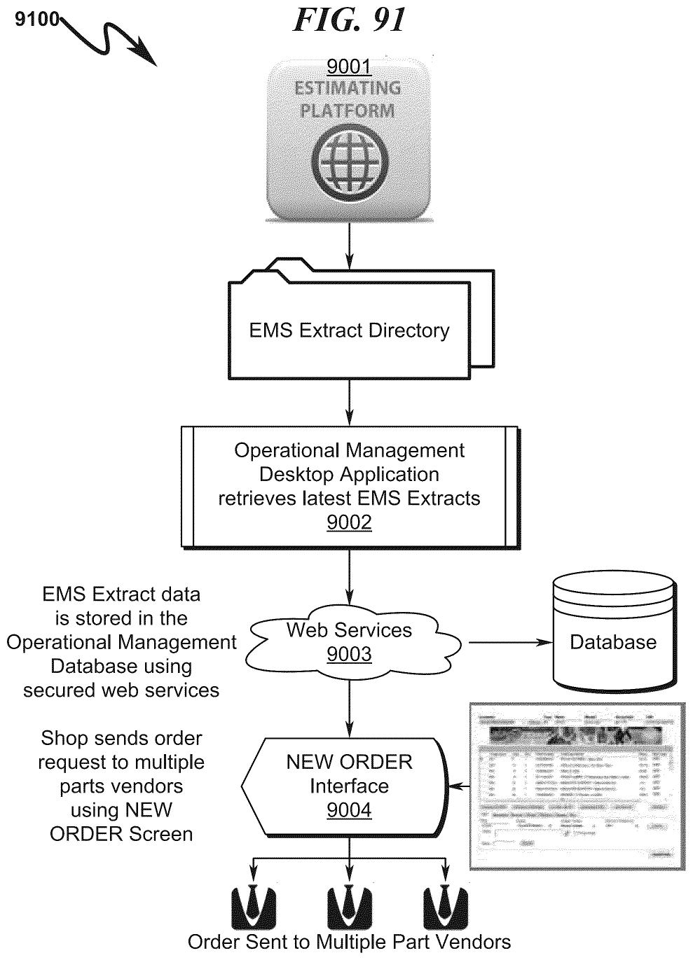

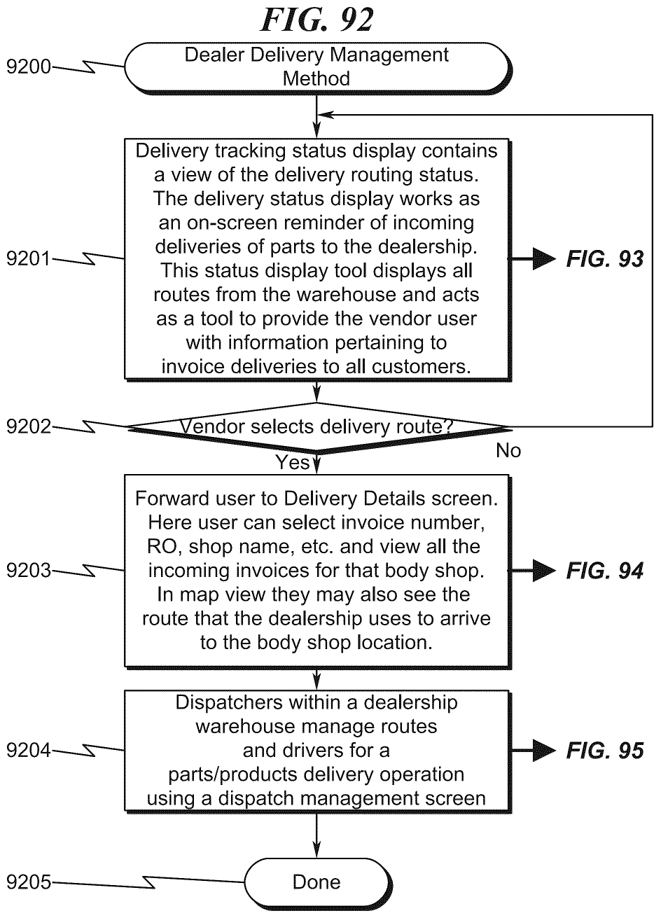

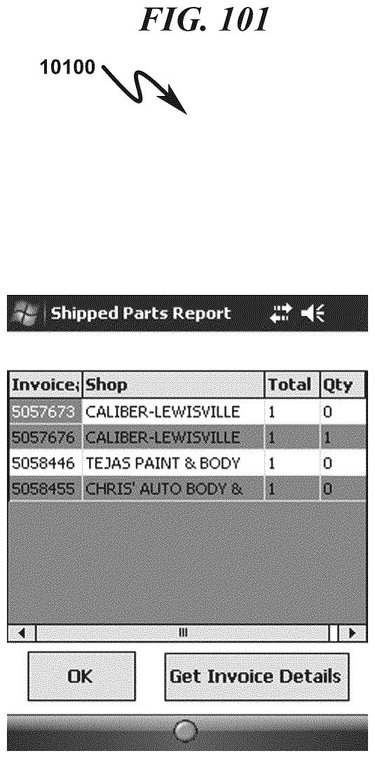

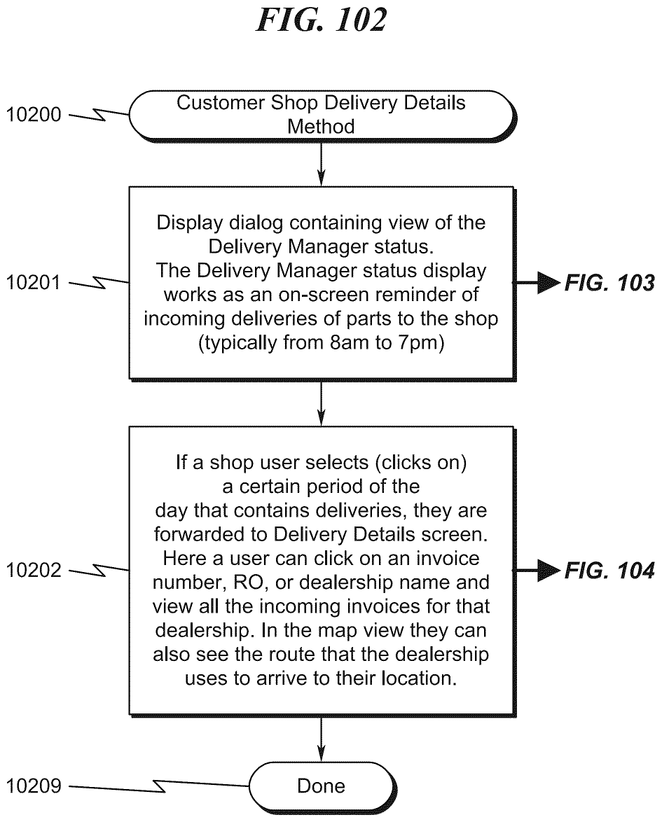

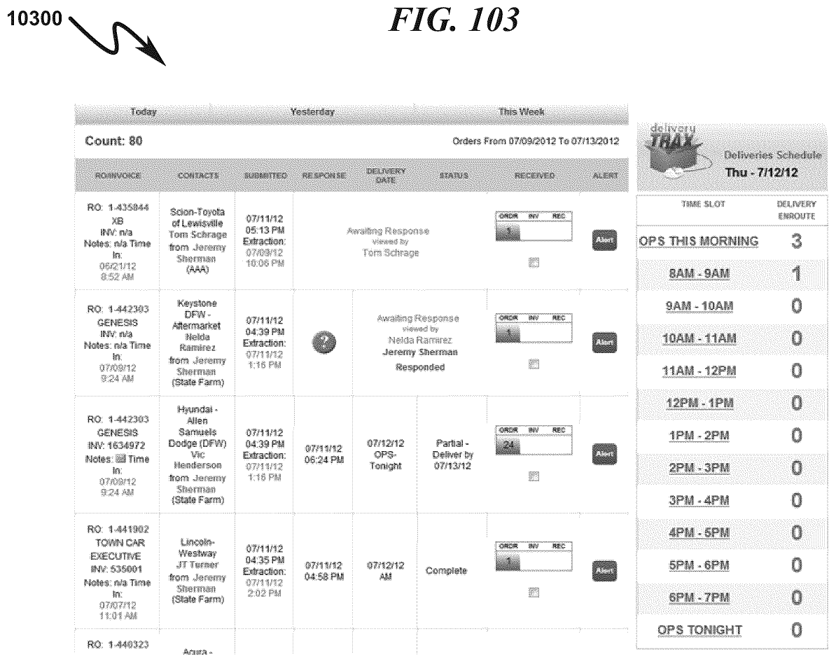

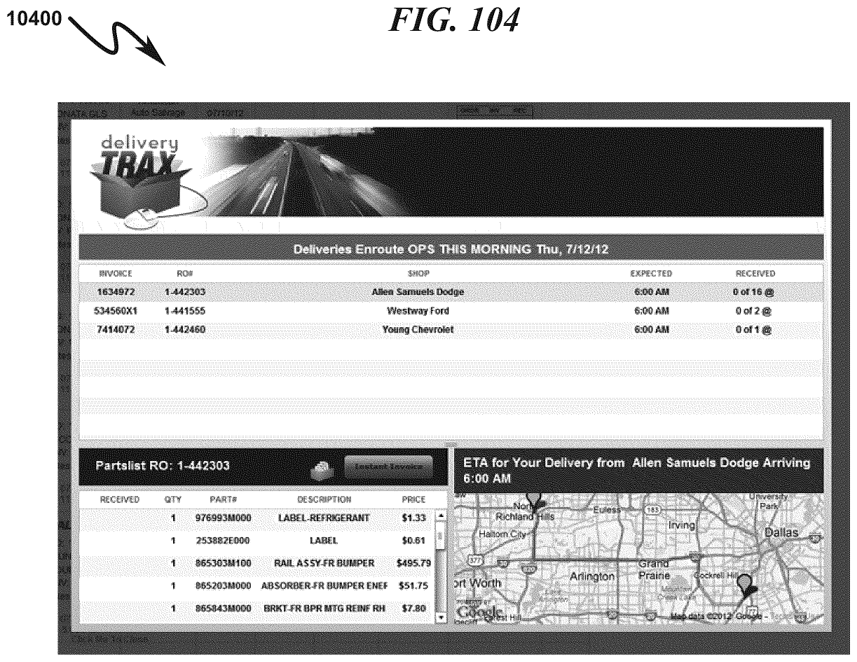

As generally illustrated in FIG. 85 (8500), the delivery management method may be described in terms of a workflow (8510) (FIG. 86 (8600)-FIG. 91 (9100)), dealer interface (8520) (FIG. 92 (9200)-FIG. 101 (10100)), and shop interface (8540) (FIG. 102 (10200)-FIG. 112 (11200)).

### Workflow (8500)

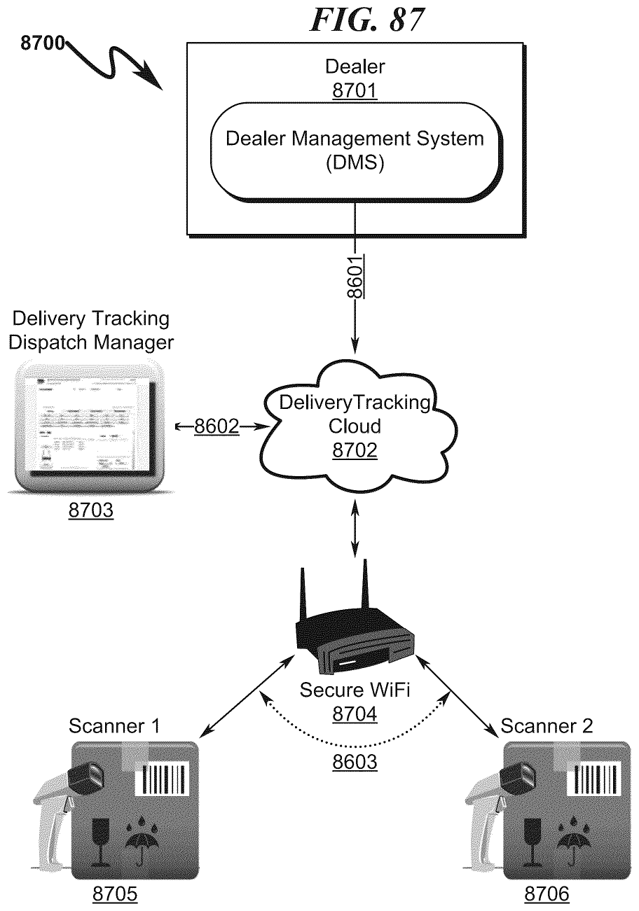

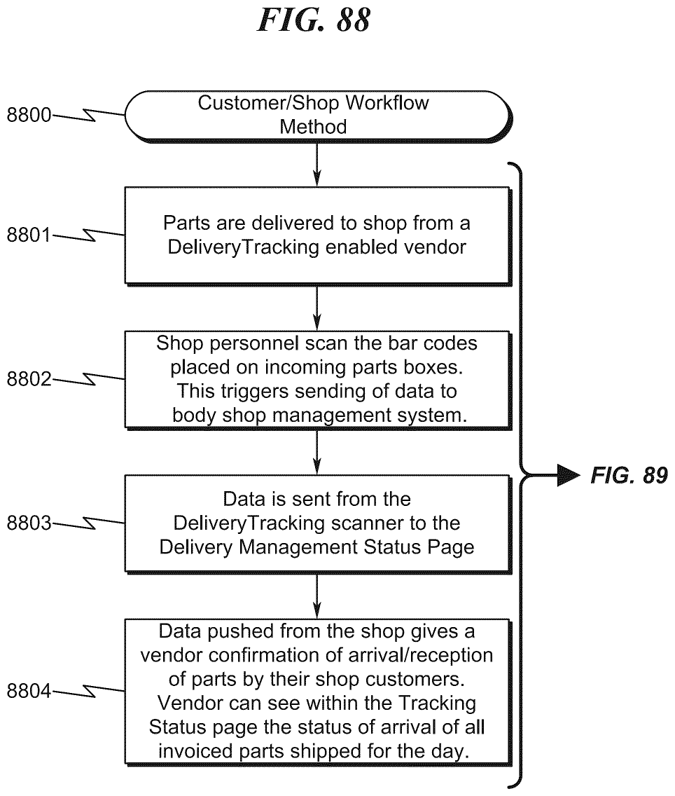

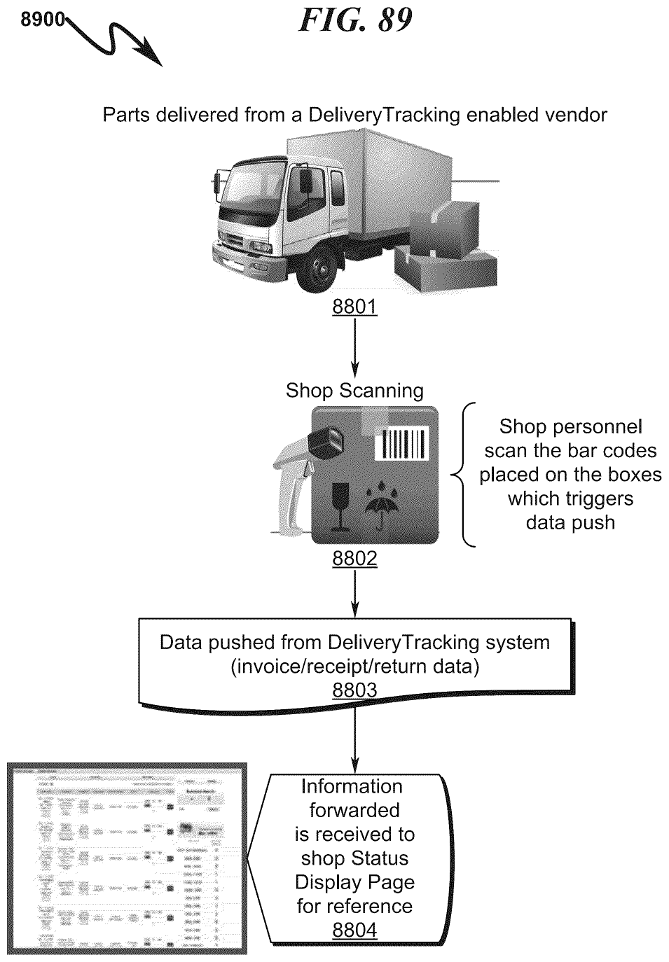

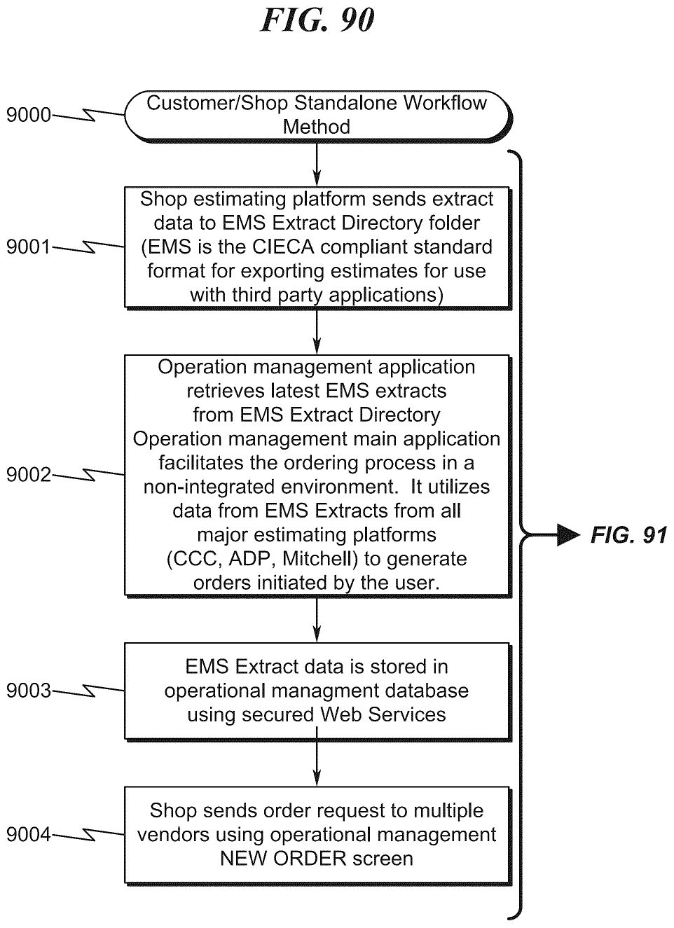

As generally illustrated in FIG. 85 (8500) the workflow for delivery management can be trifurcated into dealership workflow (8511) (FIG. 86 (8600)-FIG. 87 (8700)), shop workflow (8512) (FIG. 88 (8800)-FIG. 89 (8900)), and standalone workflow (8513) (FIG. 90 (9000)-FIG. 91 (9100)).

### Dealer Interface (9200)-(10100)

The dealer interface associated with the delivery management system is generally illustrated in FIG. 92 (9200)-FIG. 101 (10100). Within this context, a mobile version of the dealer delivery management system is generally illustrated in FIG. 96 (9600)-FIG. 101 (10100). The mobile version of this application permits dealer/vendors to automatically track deliveries of individual parts/products while the part/product is on the delivery route. The mobile version also verifies accurate delivery of all parts to the shop.

### Shop Interface (10200)-(11200)

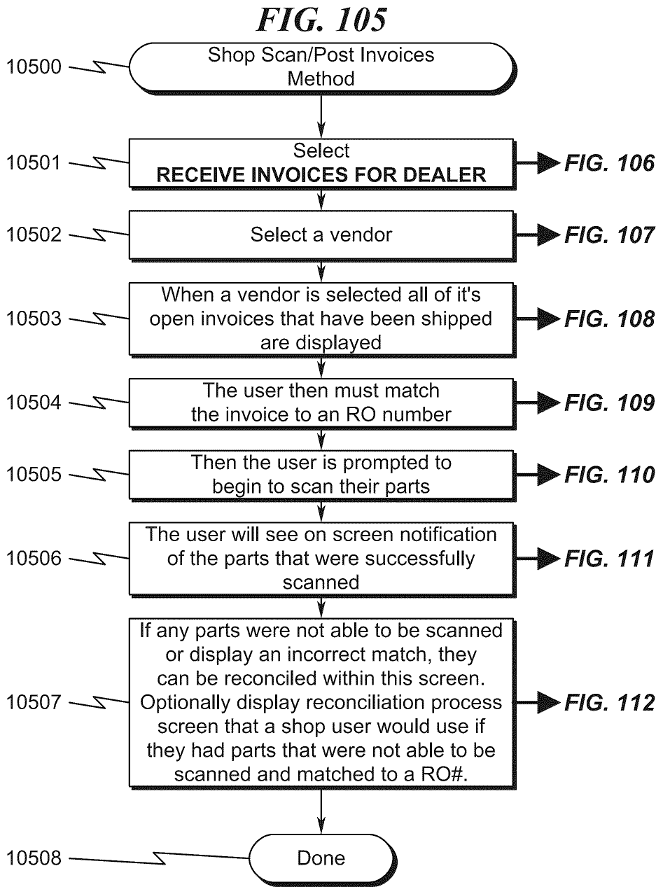

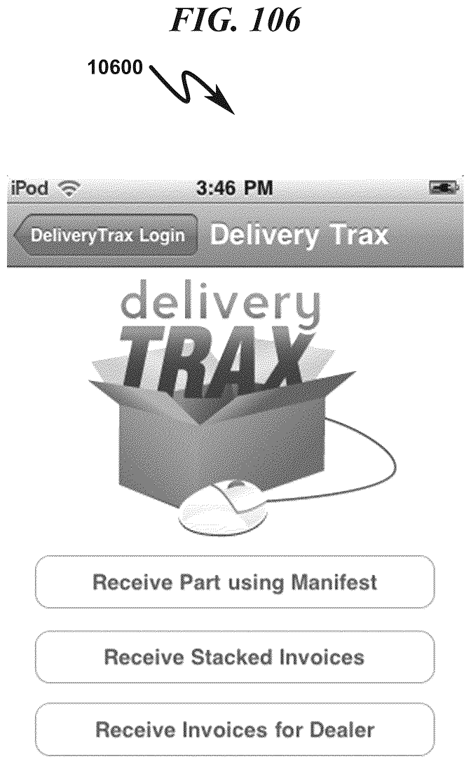

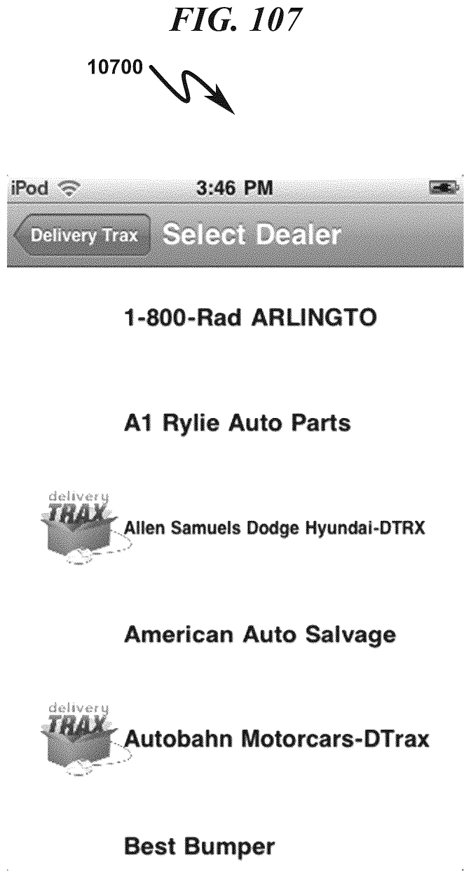

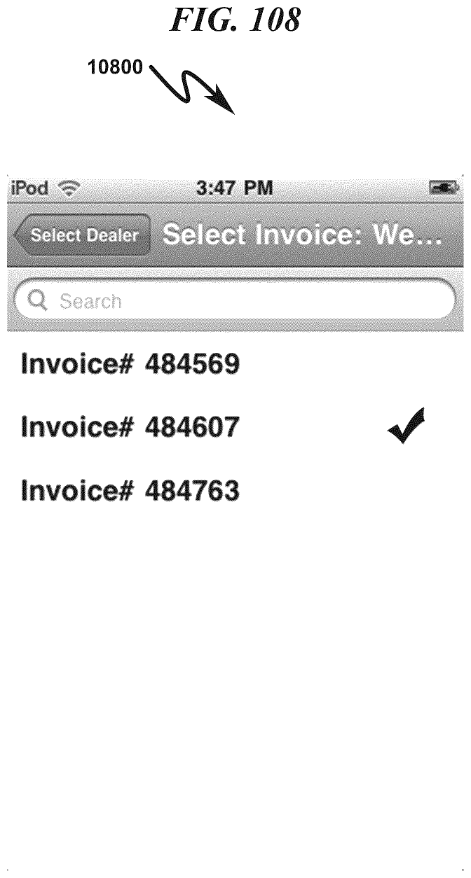

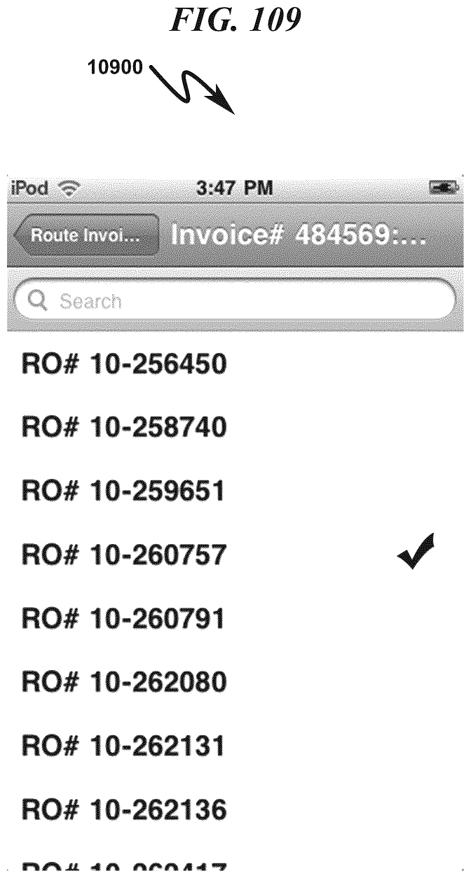

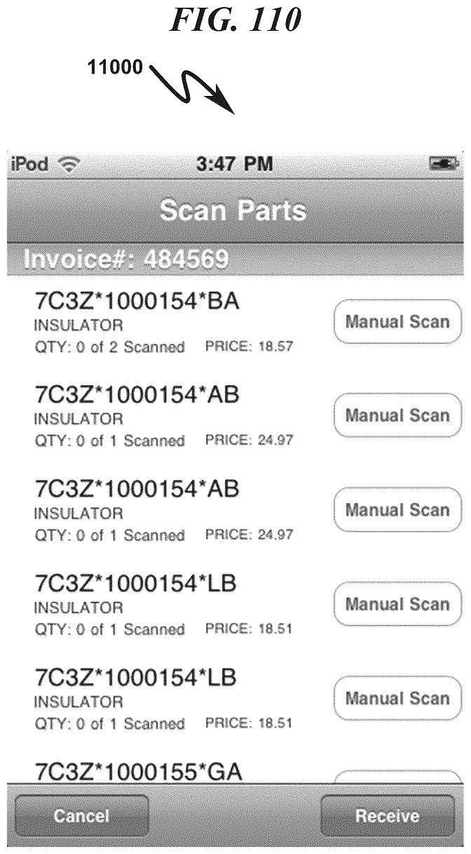

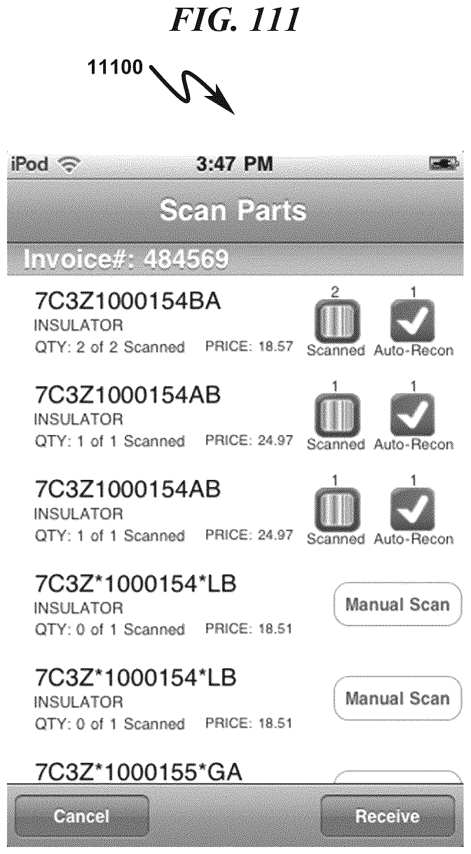

The corresponding shop interface associated with the delivery management system is generally illustrated in FIG. 102 (10200)-FIG. 112 (11200). Within this context, a mobile version of the shop delivery management system is generally illustrated in FIG. 105 (10500)-FIG. 112 (11200). The mobile version of this application permits shop customers to validate incoming part/product deliveries, process incorrect deliveries, reconcile deliveries to outstanding part/product orders/invoices, and process part/product returns.

### Delivery Tracking Status (9300)-(9500)

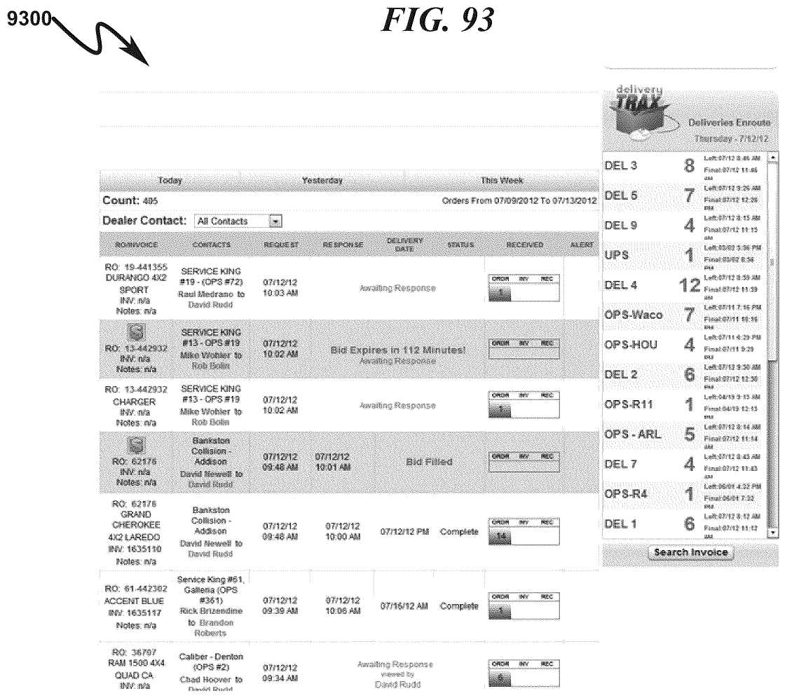

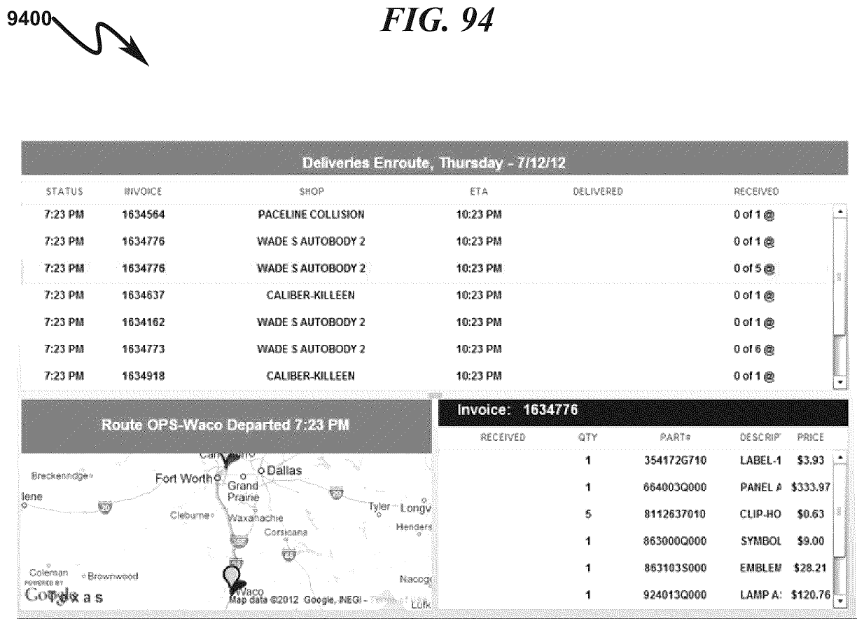

As mentioned previously, the present invention permits accurate delivery tracking status to be maintained for both customers and vendors. As generally illustrated by the dealer detail screen in FIG. 93 (9300), the dealer summary status screen in FIG. 94 (9400), and the dispatch queue display in FIG. 95 (9500), the delivery tracking status displays can encompass both the customer and vendor ends of the logistics equation. Both sides of this logistics equation are kept updated as to the status of part/product deliveries to enable efficient operation of inventories as well as production/repair facilities.

### Mobile Delivery Tracking (9600)-(10100): (10500)-(11200)

The delivery tracking methodology may be implemented within the context of a mobile device as generally illustrated in FIG. 96 (9600)-FIG. 101 (10100) and FIG. 105 (10500)-FIG. 112 (11200). exemplary These user interface screens/dialogs illustrate how the part/product tracking may be implemented in a mobile context such that the exact status of a given part/product order is updated for both the vendor and customer as the delivery route is traversed by the vehicle containing the particular combination of parts/products queued for delivery to a variety of customers.

### Transportation Inventory Optimization

The present invention specifically anticipates a number of transportation inventory optimizations to be incorporated in many preferred embodiments of the present invention. Current prior art logistics systems may utilize bar code scanning at some points within the delivery process, but fail to integrate total transportation inventory management within the entire part/product procurement life cycle.

The present invention anticipates that based on the customer invoice for a given ordered part/product, the vendor will generate (using a parts picking subsystem incorporated within the overall invention system/method) a part/product “pick list” that is optimized for warehouse individuals to gather parts/products for and delivery map these parts/products to a given delivery truck for transportation to a given customer or customers. Once logged/scanned as being associated with a given delivery truck, the truck driver will be given a real-time delivery schedule from which to make stops at various way-points associated with given customers. Delivery of parts/products at each customer way-point will include scanning of the parts/products as “delivered” to the customer with simultaneous indication on the customer status display that the requested part/product has been delivered to the customer site.

Routing of the part/product from this point to the final tasking station (repair bay, technician, etc.) may result in an additional bar code scan of the part to indicate it has reached its final destination and is/is not suitable for the tasked application. If the part/product is accepted as satisfactory, information supporting payment of the vendor's invoice can be generated. Otherwise, return of the part/product to the vendor (possibly with notations on what part/product should be substituted in its place) with associated vendor invoice cancellation information can be generated. This methodology may also be applied to situations in which core charges are applied by the vendor to certain products that require return of the original part/product to receive an associated core charge refund. Tracking of this information in a bi-directional nature is possible using the teachings of the present invention, as all information about a given part/product is associated with a given centralized vendor invoice that tracks the entire life cycle of the part/product delivered to/from the customer from any number of vendors.

While individual part/product tracking at each stage in the procurement/delivery cycle may not appear as a significant advantage to the present invention as compared to the prior art, this first blush assumption is contraindicated by transportation statistics accumulated using the present invention that indicate 15-30 minutes are cut from a typical delivery route using the present invention methodology. These time savings are generally associated with positive and uniform inventory tracking along the delivery path way-points, resulting in less time verifying customer delivery contents and higher accuracies associated with the parts/products actually delivered to a given customer. Route delivery improvements in this range result in higher manpower utilization, more customers serviced on a given delivery route, and earlier customer delivery times than are possible using techniques of the prior art.

It should be noted that even if the prior art were augmented with bar code scanning at each way-point, without integration of this information into both the customer and vendor information infrastructures this additional information would not provide the necessary benefit needed to improve both customer and vendor efficiencies. Only by integrating all of this information with central management and control can these additional efficiencies be achieved.

### Transportation Optimization Methodologies

The present invention anticipates a wide variety of transportation optimization methodologies that may be incorporated into the vendor portion of the system/method. These include but are not limited to the following methodologies:
Dynamic routing of delivery trucks based on current traffic conditions.
Dynamic routing of delivery trucks based on real-time customer delivery demands for a given part/product.
Dynamic routing of delivery trucks based on prioritized customer part/product delivery schedules.
Route optimization between individual route way-points to minimize travel time and/or fuel costs.

One skilled in the art will recognize that this list is non-exhaustive and may be augmented with a wide variety of other considerations and parameters to achieve optimal transportation efficiencies within an overall supply chain management system/method.

### Positive Status Feedback

One aspect of the present invention that greatly aids in the efficient flow of parts/products within a conventional repair shop management system is the real-time feedback of parts status within the vendor transportation infrastructure. The present invention anticipates that at each point in the vendor transportation process, the customer status display will be updated with the current status of the part/product order. These status updates may include but are not limited to the following events:
Acknowledgement of the part/product order received by the vendor.
Status of part/product availability within the vendor's inventory.
Acknowledgement of the part/product order picked from inventory by the vendor.
Loading of the part/product order onto the vendor delivery truck.
Estimated delivery time of the part/product order by the vendor delivery truck.
Delivery route of the vendor delivery truck.
Traffic or other delays associated with the vendor delivery truck on transport to the customer facility.
Actual arrival of vendor delivery truck at the customer facility.
Actual delivery of the part/product order by the vendor delivery truck to the customer facility.

All of this information may be integrated within or provided to a shop management software system operating within the context of the customer's facility to permit scheduling of resources (technicians, repair bays, equipment, etc.) to maximize resource utilization within the context of the customer's business operation. All of this can occur automatically without the need for human intervention and/or human-to-human communication as is required by the prior art.

### Auto/Truck Parts/Products Application Context

While the present invention can be applied in a wide variety of contexts, it is especially advantageous in the context of auto/truck repair shops and the like. In these environments, the body shop as customer must acquire parts/products from a number of sources, including but not limited to original equipment manufacturers (OEMs), car dealerships, aftermarket parts suppliers, salvage yards, and the like.

The present invention permits the body shop customer in this context to place orders for a given part/product with a variety of potential suppliers and then receive invoice information pertaining to the order, real-time status updates as to the availability, price, and delivery lead times for a given part/product. Once this information is received by the body shop customer, a decision can be made (often in consultation with the auto/truck owner and/or insurance company) as to the appropriate part/product selection. This information can then be used by the body shop customer to trigger delivery of the selected part/product by a selected vendor based on their price/delivery profile. This price/delivery information then permits the body shop customer to accurately update the auto/truck repair cost, completion date, and materials/labor costs. Additionally, the delivery information when fed into the body shop management system (BSMS) can permit the body shop customer to accurately schedule resources (technicians, repair bays, equipment, etc.) to utilize the full production maintenance capability of the repair facility, thus lowering overall operating costs and increasing business efficiencies.

### System Summary

The present invention system anticipates a wide variety of variations in the basic theme of construction, but can be generalized as a supply chain management system comprising:
(a) customer order entry subsystem;
(b) part/product quoting subsystem;
(c) part/product advertising subsystem;
(d) vendor order fulfillment subsystem; and
(e) transportation tracking subsystem;
wherein
the customer order entry subsystem is configured to accept a part/product order from a customer;
the customer order entry subsystem comprises a status screen configured to display the real-time order status of the part/product;
the part/product quoting subsystem is configured to query vendors using the part/product order to obtain a vendor quote for the part/product order;
the vendor quote comprises a quote status further comprising the availability of the part/product and the price of the part/product;
the vendor quote is displayed in the status screen;
the part/product advertising subsystem is configured to display a context-sensitive vendor advertising quote associated with the part/product order in the status screen;
the customer order entry subsystem is configured to permit the customer to select the vendor quote or the advertising quote to define a selected part/product order;
the vendor order fulfillment subsystem is configured to receive the selected part/product order over a communications network and allow a vendor to accept/reject the selected part/product order and provides order status feedback to the customer on the status screen;
the vendor order fulfillment subsystem is configured to execute shipment of the selected part/product associated with the selected part/product order to the customer using optimized delivery routing;
the transportation tracking subsystem is configured to track the physical location of the selected part/product from the vendor to the customer; and
the status screen is configured to display in real-time the status of the shipment at various way-points within the optimized delivery routing.

This general system summary may be augmented by the various elements described herein to produce a wide variety of invention embodiments consistent with this overall design description.

### Method Summary

The present invention method anticipates a wide variety of variations in the basic theme of implementation, but can be generalized as a supply chain management method, the method operating in conjunction with a supply chain management system comprising:
(a) customer order entry subsystem;
(b) part/product quoting subsystem;
(c) part/product advertising subsystem;
(d) vendor order fulfillment subsystem; and
(e) transportation tracking subsystem;
wherein
the customer order entry subsystem is configured to accept a part/product order from a customer;
the customer order entry subsystem comprises a status screen configured to display the real-time order status of the part/product;
the part/product quoting subsystem is configured to query vendors using the part/product order to obtain a vendor quote for the part/product order;
the vendor quote comprises a quote status further comprising the availability of the part/product and the price of the part/product;
the vendor quote is displayed in the status screen;
the part/product advertising subsystem is configured to display a context-sensitive vendor advertising quote associated with the part/product order in the status screen;
the customer order entry subsystem is configured to permit the customer to select the vendor quote or quote to define a selected the advertising part/product order;
the vendor order fulfillment subsystem is configured to receive the selected part/product order over a communications network and allow a vendor to accept/reject the selected part/product order and provides order status feedback to the customer on the status screen;
the vendor order fulfillment subsystem is configured to execute shipment of the selected part/product associated with the selected part/product order to the customer using optimized delivery routing;
the transportation tracking subsystem is configured to track the physical location of the selected part/product from the vendor to the customer; and
the status screen is configured to display in real-time the status of the shipment at various way-points within the optimized delivery routing;
wherein the method comprises the steps of:
(1) accepting a customer part/product order or request for vendor quote via a user interface in the customer order entry subsystem;
(2) displaying context-sensitive vendor advertising linked to a part/product on the customer order entry subsystem and allowing the customer to select the advertised vendor for delivery of the part/product;
(3) selecting a vendor for part/product quotation/availability;
(4) ordering the part/product from the selected vendor;
(5) if the selected vendor accepts the part/product order, proceeding to step (10);
(6) if the customer has not selected customer order request, forwarding of the part/product proceeding to step (8);
(7) activating customer forwarding of the part/product order request to another vendor and proceeding to step (10);
(8) if the customer has not selected vendor forwarding of the part/product order request, proceeding to step (11);
(9) activating vendor forwarding of the part/product order request to another vendor;
(10) shipping the part/product to the customer with real-time delivery tracking; and
(11) updating the customer order status screen.

This general method may be modified heavily depending on a number of factors, with rearrangement and/or addition/deletion of steps anticipated by the scope of the present invention. Integration of this and other preferred exemplary embodiment methods in conjunction with a variety of preferred exemplary embodiment systems described herein is anticipated by the overall scope of the present invention.

### System/Method Variations

The present invention anticipates a wide variety of variations in the basic theme of construction. The examples presented previously do not represent the entire scope of possible usages. They are meant to cite a few of the almost limitless possibilities.

This basic system and method may be augmented with a variety of ancillary embodiments, including but not limited to:
An embodiment wherein the customer order entry subsystem further comprises an application programming interface (API) to a body shop management system, the body shop management system utilizing part/product status information retrieved from the customer order entry subsystem to coordinate and schedule resources within the body shop to optimize: resource utilization and productivity.
An embodiment wherein the customer order entry subsystem further comprises a body shop management subsystem, the body shop management subsystem utilizing part/product status information retrieved from the customer order entry subsystem to coordinate and schedule resources within the body shop to optimize resource utilization and productivity.
An embodiment wherein the status screen displays the identification of the part/product, the vendor supplying the part/product, the price of the part/product, the date/time the part/product order was placed, the date/time the vendor responded to the part/product order, the expected delivery time of the part/product, the current delivery way-point location of the part/product, and the date/time the part/product order was received.
An embodiment wherein the status screen displays the status of a plethora of parts/products orders, with the plethora of parts/products orders being displayed one part/product per line in a status detail area within the status screen.
An embodiment wherein the columns of the status screen display may be individually filtered via the use of dialog buttons present at the top and/or bottom of the columns.
An embodiment wherein the status screen displays the status of a plethora of parts/products orders, with the plethora of parts/products orders being displayed chronologically based on expected delivery of the part/product.
An embodiment wherein the customer order entry subsystem further comprises options to order the part/product from an original equipment manufacturer (OEM) parts supplier, aftermarket parts supplier, or salvage yard parts supplier.
An embodiment wherein the customer order entry subsystem permits the part/product order to be simultaneously placed with multiple vendors.
An embodiment wherein the customer order entry subsystem permits the part/product order to be simultaneously placed with a vendor group, the vendor group comprising multiple vendors associated with a vendor group identifier.
An embodiment wherein the vendor order fulfillment subsystem permits the customer to forward the part/product order to another vendor for fulfillment.
An embodiment wherein the vendor order fulfillment subsystem permits the vendor to forward the part/product order to another vendor for fulfillment.
An embodiment wherein the customer order entry subsystem further comprises an instant messaging dialog to permit instant visual and/or audible messages to be transmitted to or received from the vendor.
An embodiment wherein the customer order entry subsystem further comprises vendor advertising located in the status screen that is context-dependent on the part/product.
An embodiment wherein the customer order entry subsystem further comprises manufacturer incentive/promotion advertising located in the status screen that is context-dependent on the part/product.
An embodiment wherein the transportation tracking system is configured to coordinate the return of the selected part/product from the customer to the vendor if the customer declines acceptance of the part/product from the vendor.
An embodiment wherein the transportation tracking system is configured to coordinate the invoicing of the customer for the selected part/product if the customer accepts delivery of the part/product from the vendor.
An embodiment wherein the transportation tracking system is embodied in a computing device selected from a group consisting of a mobile phone, smartphone, tablet computer, laptop computer, and personal computer.
An embodiment further comprising a claims processing subsystem, wherein the claims processing subsystem coordinates reimbursement of the vendor by a manufacturer based on any applicable incentive/promotion by the manufacturer on the selected part/product.
An embodiment wherein the claims processing subsystem is embodied in a computing device selected from a group consisting of a mobile phone, smartphone, tablet computer, laptop computer, and personal computer.

One skilled in the art will recognize that other embodiments are possible based on combinations of elements taught within the above invention description.

### Generalized Computer Usable Medium

In various alternate embodiments, the present invention may be implemented as a computer program product for use with a computerized computing system. Those skilled in the art will readily appreciate that programs defining the functions defined by the present invention can be written in any appropriate programming language and delivered to a computer in many forms, including but not limited to: (a) information permanently stored on non-writeable storage media (e.g., read-only memory devices such as ROMs or CD-ROM disks); (b) information alterably stored on writeable storage media (e.g., floppy disks and hard drives); and/or (c) information conveyed to a computer through communication media, such as a local area network, a telephone network, or a public network such as the Internet. When carrying computer readable instructions that implement the present invention methods, such computer readable media represent alternate embodiments of the present invention.

As generally illustrated herein, the present invention system embodiments can incorporate a variety of computer readable media that comprise computer usable medium having computer readable code means embodied therein. One skilled in the art will recognize that the software associated with the various processes described herein can be embodied in a wide variety of computer accessible media from which the software is loaded and activated. Pursuant to In re Beauregard, 35 USPQ2d 1383 (U.S. Pat. No. 5,710,578), the present invention anticipates and includes this type of computer readable media within the scope of the invention. Pursuant to In re Nuijten, 500 F.3d 1346 (Fed. Cir. 2007) (U.S. patent application Ser. No. 09/211,928), the present invention scope is limited to computer readable media wherein the media is both tangible and non-transitory.

### CONCLUSION

A supply chain management system/method that incorporates a Customer Order Entry/Status Console (COESC), part/product quoting, vendor order fulfillment, manufacturer claims processing, transportation tracking, and integrated product advertising has been disclosed. The disclosed system/method uses a COESC permits decentralized deployment of customer orders to a plethora of potential vendors for potential fulfillment. Participating vendors may provide feedback pertaining to product pricing, availability, manufacturer incentives, and delivery timing to the COESC. Vendor product shipments to the customer may be tracked on the COESC utilizing a transportation tracking subsystem incorporating vendor delivery optimizations and mobile tracking of parts/products deliveries. A context-sensitive advertising subsystem integrating manufacturer claims processing may be implemented to permit promotion of vendor/manufacturer products and/or services to customers via the COESC. The system/method may incorporate/interface to customer scheduling/process flow software such as body shop management systems and the like.

Although a preferred embodiment of the present invention has been illustrated in the accompanying drawings and described in the foregoing Detailed Description, it will be understood that the invention is not limited to the embodiments disclosed, but is capable of numerous rearrangements, modifications, and substitutions without departing from the spirit of the invention as set forth and defined by the following claims.

What is claimed is:

1.-74. (canceled)

75. A supply chain management system comprising:
(a) a memory that stores user data and information;
(b) a customer order entry subsystem;
(c) a part/product quoting subsystem;
(d) a part/product advertising subsystem;
(e) a vendor order fulfillment subsystem; and
(f) a transportation tracking subsystem;
wherein
the memory and plurality of subsystems are configured to communicate with and between each other through a computer or internet network;
said memory is configured to;
store user information on a database;
store, on a vendor advertising database, part/product incentive/promotion information;
receive part/product data requests and inputs from at least one of a plurality of subsystems;
transmit user group information and/or part/product incentive/promotion information to at least one of a plurality of subsystems;
said customer order entry subsystem is configured to accept a part/product order from a customer via a first graphical user interface;
said customer order entry subsystem graphical user interface comprising a status screen configured to display the real-time order status of said part/product;
said part/product quoting subsystem is configured to query vendors via a second graphical user interface, using said part/product order;
said part/product quoting subsystem graphical user interface is configured to accept vendor part/product data and vendor quote input for said part/product order;
said vendor quote input comprises a quote status further comprising the availability of said part/product and the price of said part/product;
said part/product quoting subsystem is configured to communicate said vendor part/product data and vendor quote input with said consumer order entry subsystem via a communications network;
said vendor quote is displayed in said status screen;
said memory configured to receive said customer part/product order and vendor quote over a communications network and communicate a context-sensitive vendor advertising quote to said part/product advertising subsystem; said part/product advertising subsystem is configured to display said context-sensitive vendor advertising quote associated with said part/product order in said status screen;
said customer order entry subsystem is configured to permit said customer to select said vendor quote or said context-sensitive vendor advertising quote to define a selected part/product order;
said vendor order fulfillment subsystem is configured to receive said selected part/product order over a communications network and allow a vendor to accept/reject said selected part/product order and provides order status feedback to said customer on said status screen;
said vendor order fulfillment subsystem is configured to execute shipment of the selected part/product associated with said selected part/product order to said customer using optimized delivery routing;
said transportation tracking subsystem is configured to track the physical location of said selected part/product from said vendor to said customer; and
said status screen is configured to display in real-time the status of said shipment at various way-points within said optimized delivery routing.

76. The supply chain management system of claim 75 wherein said customer order entry subsystem further comprises an application programming interface (API) to a body shop management system, said body shop management system configured to receive part/product order and status information from at least one of said plurality of subsystems and further configured to automatically utilize said part/product order and status information to coordinate and schedule resources within the individual body shop to optimize resource utilization and productivity.

77. The supply chain management system of claim 75 wherein said customer order entry subsystem further comprises a body shop management subsystem, said body shop management subsystem utilizing part/product status information retrieved from at least one of said plurality of subsystems to coordinate and schedule resources within said body shop to optimize resource utilization and productivity.

78. The supply chain management system of claim 75 wherein said status screen displays the identification of said part/product, the vendor supplying said part/product, the price of said part/product, the date/time said part/product order was placed, the date/time said vendor responded to said part/product order, the expected delivery time of said part/product, the current delivery way-point location of said part/product, and the date/time said part/product order was received.

79. The supply chain management system of claim 75 wherein said status screen displays the status of a plethora of parts/products orders, with said plethora of parts/products orders being displayed individually in a visually organized structure in a status detail area within said status screen.

80. The supply chain management system of claim 79 wherein said plethora of parts/product orders are organized and displayed one part/product per line in status detail area within said status screen.

81. The supply chain management system of claim 75 wherein the graphical user interface contains columns organized on said status screen display, said columns may be individually filtered via the use of dialog buttons present at the top and/or bottom of said columns.

82. The supply chain management system of claim 75 wherein said status screen displays the status of a plethora of parts/products orders, with said plethora of parts/products orders being displayed chronologically based on expected delivery of said part/product.

83. The supply chain management system of claim 75 wherein said customer order entry subsystem further comprises options to order said part/product from an original equipment manufacturer (OEM) parts supplier, aftermarket parts supplier, or salvage yard parts supplier.

84. The supply chain management system of claim 75 wherein said customer order entry subsystem permits said part/product order to be simultaneously placed with multiple vendors.

85. The supply chain management system of claim 75 wherein said customer order entry subsystem permits said part/product order to be simultaneously placed with a vendor group, said vendor group comprising multiple vendors associated with a vendor group identifier.

86. The supply chain management system of claim 85 wherein said customer order entry subsystem comprises options displayed on said status screen to define a vendor group using a plethora of vendor group identifier information.

87. The supply chain management system of claim 86 wherein said customer order entry subsystem is configured to refine part/product search results based on said vendor group identifier information and display said search results on said status screen.

88. The supply chain management system of claim 75 wherein said vendor order fulfillment subsystem permits said customer to forward said part/product order to another vendor for fulfillment.

89. The supply chain management system of claim 75 wherein said vendor order fulfillment subsystem permits said vendor to forward said part/product order to another vendor for fulfillment.

90. The supply chain management system of claim 75 wherein said customer order entry subsystem further comprises an instant messaging dialog to permit instant visual and/or audible messages to be transmitted to or received from said vendor.

91. The supply chain management system of claim 75 wherein said customer order entry subsystem further comprises vendor advertising located in said status screen that is context-dependent on said part/product.

92. The supply chain management system of claim 75 wherein said memory is further configured to determine if said vendor advertising database contains a context-dependent database match; if a matching context-dependent vendor advertisement is found, said matching context-dependent vendor advertisement is displayed on said status screen; if no match exists, alternate advertising of same or alternate vendor is displayed on status screen.

93. The supply chain management system of claim 75 wherein said customer order entry subsystem further comprises manufacturer incentive/promotion advertising located in said status screen that is context-dependent on said part/product.

94. The supply chain management system of claim 75 wherein said transportation tracking system is configured to coordinate the return of said selected part/product from said customer to said vendor if said customer declines acceptance of said part/product from said vendor.

95. The supply chain management system of claim 75 wherein said transportation tracking system is configured to coordinate the invoicing of said customer for said selected part/product if said customer accepts delivery of said part/product from said vendor.

96. The supply chain management system of claim 75 wherein said transportation tracking system is embodied in a computing device selected from a group consisting of a mobile phone, smartphone, tablet computer, laptop computer, and personal computer.

97. The supply chain management system of claim 75 further comprising a claims processing subsystem, wherein said claims processing subsystem coordinates reimbursement of said vendor by a manufacturer based on any applicable incentive/promotion by said manufacturer on said selected part/product.

98. The supply chain management system of claim 97 wherein said claims processing subsystem is embodied in a computing device selected from a group consisting of a mobile phone, smartphone, tablet computer, laptop computer, and personal computer.
